(19) United States
(12) Patent Application Publication
(10) Pub. No.: US 2026/0043373 A1
(43) Pub. Date: Feb. 12, 2026

(54) INTERNAL COMBUSTION ENGINE

(71) Applicant: Philip Franklin Gaziano, Wilbraham, MA (US)

(72) Inventor: Philip Franklin Gaziano, Wilbraham, MA (US)

(21) Appl. No.: 19/343,365

(22) Filed: Sep. 29, 2025

Related U.S. Application Data
(63) Continuation of application No. PCT/US2025/041540, filed on Aug. 11, 2025.
(60) Provisional application No. 63/682,155, filed on Aug. 12, 2024.

(51) Int. Cl. F02F 3/28; F02F 3/00

(52) U.S. Cl. CPC F02F 3/28; F02F 3/0015

(57) ABSTRACT

A piston can include a piston body formed of a first portion and a second portion. The second portion can include a crown and an outer wall having a perimeter defined by a first circle overlapping with a second circle. The piston can be included in an internal combustion engine and configured as a primary piston, an added piston, or both.

### INCORPORATION BY REFERENCE TO ANY PRIORITY APPLICATIONS

The present application is a continuation of PCT Application No. US2025/041540, filed Aug. 11, 2025, entitled “INTERNAL COMBUSTION ENGINE” which claims priority benefit to U.S. Provisional Application No. 63/682,155, filed Aug. 12, 2024, entitled “INTERNAL COMBUSTION ENGINE.” All of the abovementioned applications are hereby incorporated by reference herein in their entireties. Any and all applications for which a foreign or domestic priority claim is identified in the Application Data Sheet as filed with the present application are hereby incorporated by reference under 37 CFR 1.57 and made a part of this specification.

### BACKGROUND

### Field

The present disclosure generally relates to internal combustion engines. More particularly, the present disclosure relates to layouts, components, construction techniques, and materials for internal combustion engines.

### Description of the Related Art

In reciprocating internal combustion engines, a cylinder block is a main structural component. The cylinder block contains one or more cylinder bores. A cylinder head typically connects to the upper end of the cylinder block. Together, the cylinder block and the cylinder head house the cylinder bores, the pistons, and combustion chambers. Each piston moves up and down inside a respective cylinder bore. Connecting rods connect the pistons to a crankshaft. The crankshaft can be positioned within a crankcase that is attached to the bottom end of the cylinder block or can be positioned within the cylinder block itself. The connecting rods convert the translational movement of the pistons to rotational movement of the crankshaft.

### SUMMARY

The systems, methods and devices described herein have innovative aspects, no single one of which is indispensable or solely responsible for their desirable attributes. Without limiting the scope of the claims, some of the advantageous features will now be summarized.

In one embodiment, a piston is provided. The piston includes a piston body formed of a first portion and a second portion. The second portion includes a crown and an outer wall. The outer wall has a perimeter defined by a first circle overlapping with a second circle.

In another embodiment, a piston is provided. The piston includes a piston body. The piston body includes a first portion and a second portion. The first portion has a partial cylinder shape and includes a first rounded surface. The second portion has a partial cylinder shape and includes a second rounded surface. The first rounded surface and the second rounded surface define a perimeter of a wall of the piston body.

In another embodiment, a piston assembly is provided. The piston assembly includes a crosshead, a first piston, and a second piston. The first piston is directly or indirectly coupled to the crosshead and positioned on a first side of the crosshead. The second piston is directly or indirectly coupled to the crosshead and positioned on a second side of the crosshead.

In another embodiment, a piston subassembly for an internal combustion engine is provided. The piston subassembly includes a first piston, a second piston, a crosshead, a first crankshaft and a first connecting rod, and a second crankshaft and a second connecting rod. The first piston is configured to reciprocate within a first bore along a first axis. The second piston is configured to reciprocate within a second bore along a second axis. The crosshead extends between the first piston and the second piston. The crosshead couples the first piston to the second piston such that the first piston and the second piston reciprocate together. The first crankshaft and the first connecting rod couple a first portion of the crosshead to the first crankshaft. The second crankshaft and the second connecting rod couple a second portion of the crosshead to the second crankshaft. As the first piston and the second piston reciprocate, the connecting rods cause rotation of the first crankshaft and the second crankshaft.

In another embodiment, a connecting rod assembly is provided. The connecting rod assembly includes a first connecting rod and a second connecting rod. The first connecting rod extends between a first end and a second end. The second connecting rod extends between a first end and a second end. The second connecting rod is rotatably coupled at its first end to the second end of the first connecting rod.

In another embodiment, an internal combustion engine is provided. The internal combustion engine includes a block and a piston. The block defines a bore. The bore includes a first partial cylinder bore portion and a second partial cylinder bore portion. The piston is capable of reciprocating within the bore between top dead and bottom dead center. The piston includes a piston body. The piston body includes a piston head and a piston wall. The piston head has a perimeter defined by a first circle overlapping with a second circle. The piston wall extends from the perimeter of the piston head.

In another embodiment, an internal combustion engine is provided. The internal combustion engine includes a block, an additional housing, a crankshaft, a crosshead, a primary piston, and an added piston. The blocked defines a primary bore. The additional housing defines an added bore. The additional housing is coupled to the block. The crankshaft is configured to rotate within a passage at least partially defined within the block. The crosshead is connected to the crankshaft by a first connecting rod. The primary piston is capable of reciprocating within the primary bore between top dead and bottom dead center. The primary piston is coupled to the crosshead and positioned on a first side of the crosshead. The added piston is capable of reciprocating within the added bore between top dead and bottom dead center. The added piston includes an added piston body and an added piston head. The added piston is coupled to the crosshead and positioned on a second opposite side of the crosshead.

In another embodiment, an internal combustion engine is provided. The internal combustion engine includes a block, a lower housing, a first crankshaft, a second crankshaft, a crosshead, an upper piston. The blocked includes an upper bore, a first crankshaft containing passage, a second crankshaft containing passage, and a central recess. The first crankshaft containing passage and second crankshaft containing passage are in fluid communication with the central recess. The lower housing is coupled to the block below the central recess. The first crankshaft is configured to rotate within the first crankshaft containing passage. The second crankshaft is configured to rotate within the second crankshaft containing passage. The crosshead is connected to the first crankshaft by a first connecting rod. The crosshead is connected to the second crankshaft by a second connecting rod. At least a portion of the crosshead is positioned within the central recess. The upper piston is capable of reciprocating within the upper bore between top dead and bottom dead center. The upper piston is coupled to the crosshead and positioned above the crosshead.

In another embodiment, an internal combustion engine is provided. The internal combustion engine includes a first block, a second block a first crankshaft, a second crankshaft a first crosshead, a second crosshead, a first primary piston, a second primary piston, and a central housing. The first block includes a first primary bore, a first passage, and a first central recess. The first passage is in fluid communication with the first central recess. The second block includes a second primary bore, a second passage, and a second central recess. The second passage is in fluid communication with the second central recess. The first crankshaft is configured to rotate within the first passage. The second crankshaft is configured to rotate within the second passage. The first crosshead is connected to the first crankshaft by a first connecting rod. At least a portion of the first crosshead is positioned within the first central recess. The second crosshead is connected to the second crankshaft by a second connecting rod. At least a portion of the second crosshead is positioned within the second central recess. The first primary piston is capable of reciprocating within the first primary bore between top dead and bottom dead center. The first primary piston is coupled to the first crosshead. The second primary piston is capable of reciprocating within the second primary bore between top dead and bottom dead center. The second primary piston is coupled to the second crosshead. The central housing is positioned between the first block and the second block.

Although several configurations, examples, and illustrations are disclosed below, the disclosure extends beyond the specifically disclosed configurations, examples, and illustrations and includes other uses of the disclosure. The terminology used in the description presented herein is not intended to be interpreted in any limited or restrictive manner simply because it is being used in conjunction with a detailed description of some specific configurations of the disclosure.

### BRIEF DESCRIPTION OF THE DRAWINGS

Throughout the drawings, reference numbers may be reused to indicate general correspondence between referenced elements. The drawings are provided to illustrate example configurations described herein and are not intended to limit the scope of the disclosure.

FIGS. 1A and 1B illustrate schematic view of a portion of an internal combustion engine employing at least one added piston.

FIG. 2 illustrates a schematic cross-section view of a crank portion of the internal combustion engine of FIG. 1A.

FIG. 3A illustrates a schematic top view of a primary cylinder bore and an added cylinder bore of the internal combustion engine of FIG. 1A, in accordance with some configurations.

FIG. 3B illustrates a schematic top view of a primary cylinder bore and an added cylinder bore of the internal combustion engine of FIG. 1A, in accordance with some configurations.

FIG. 3C illustrates a schematic top view of a primary cylinder bore and an added cylinder bore of the internal combustion engine of FIG. 1A, in accordance with some configurations.

FIG. 4A illustrates a schematic cross-section view of a crank portion of the internal combustion engine.

FIG. 4B illustrates a schematic top view of a primary cylinder bore and an added cylinder bore of the internal combustion engine of FIG. 4A, in accordance with some configurations.

FIG. 5A illustrates a schematic cross-section view of a crank portion of the internal combustion engine.

FIG. 5B illustrates a schematic top view of a primary cylinder bore and an added cylinder bore of the internal combustion engine of FIG. 4A, in accordance with some configurations.

FIG. 6A illustrates a schematic cross-section view of a portion of an internal combustion engine without an added piston.

FIG. 6B illustrates a schematic cross-section view of a crank portion of the internal combustion engine of FIG. 6A employing example stabilizing components.

FIG. 6C illustrates a schematic top view of the example stabilizing components and a crosshead of the internal combustion engine of FIG. 6A.

FIG. 7 illustrates a schematic view of a portion of another example of an internal combustion engine employing at least one added piston.

FIG. 8 illustrates a schematic view of a portion of an internal combustion engine employing at least two added pistons.

FIG. 9 illustrates a schematic view of a portion of another example of an internal combustion engine employing at least two added pistons.

FIGS. 10A and 10B illustrate schematic views of portions of another example of an internal combustion engine employing at least two added pistons.

FIG. 11 illustrates an example crankshaft that can be used with an internal combustion engine.

FIG. 12A illustrates a schematic section view of an example piston that can be used as a primary piston or an added piston in an internal combustion engine.

FIG. 12B illustrates a schematic partial top view of the example piston of FIG. 12A.

FIG. 12C illustrates a schematic top view of example piston rings that can be used in the example piston of FIG. 12A.

FIG. 13A illustrates a schematic section view of an example piston and a crosshead of an internal combustion engine.

FIG. 13B illustrates a schematic partial top view of the example piston and crosshead of FIG. 13A.

FIGS. 14A and 14B illustrate a perspective view and an exploded view respectively an example piston subassembly including a piston, a crosshead, and an added piston.

FIG. 15A illustrates a side view of components of the crosshead of the piston subassembly of FIGS. 14A and 14B.

FIG. 15B illustrates a side view of the piston of the piston subassembly of FIGS. 14A and 14B.

FIGS. 15C-15E illustrate a perspective view, a side view, and a top view respectively of the added piston of the piston subassembly of FIGS. 14A and 14B.

FIG. 15F illustrates a bottom view of a configuration of the added piston of the piston subassembly of FIGS. 14A and 14B.

FIGS. 15G and 15H illustrate a perspective view and a top view respectively of an example housing that can be used with the piston subassembly of FIGS. 14A and 14B.

FIG. 16 illustrates a schematic view of a portion of an internal combustion engine employing a piston subassembly including an added piston.

FIG. 17 illustrates a schematic view of a portion of an internal combustion engine employing a piston subassembly including an added piston.

FIGS. 18A and 18B illustrate a perspective view and an exploded view respectively another example piston subassembly including a piston, a crosshead, and an added piston.

FIG. 19 illustrates a perspective view of another example piston subassembly including a piston, a connector, and an added piston.

FIG. 20 illustrates a perspective view of a piston and a connector of another example piston subassembly.

FIG. 21 illustrates a perspective view of another example piston subassembly including a piston, a connector, and an added piston.

FIG. 22 illustrates a schematic partial view of an internal combustion engine employing a variable intake passage.

FIGS. 23A-23C illustrate various schematic views of a first plug for the internal combustion engine employing a variable intake passage.

FIGS. 24A-24C illustrate various schematic views of a second plug for the internal combustion engine employing a variable intake passage.

FIG. 25 illustrates a schematic partial view of the internal combustion engine of FIG. 22 employing the second plug of FIGS. 24A-24C.

FIGS. 26-32 illustrate schematic partial views and partial exploded views of an internal combustion engine employing various constructions.

### DETAILED DESCRIPTION

Various features and advantages of this disclosure will now be described with reference to the accompanying figures. The following description is merely illustrative in nature and is in no way intended to limit the disclosure, its application, or uses. This disclosure extends beyond the specifically disclosed implementations and/or uses and obvious modifications and equivalents thereof. Thus, it is intended that the scope of this disclosure should not be limited by any particular implementations described below. The features of the illustrated implementations can be modified, combined, removed, and/or substituted as will be apparent to those of ordinary skill in the art upon consideration of the principles disclosed herein. Furthermore, implementations disclosed herein can include several novel features, no single one of which is solely responsible for its desirable attributes or which is essential to practicing the systems, devices, and/or methods disclosed herein.

Parts, components, features, and/or elements of the internal combustion engines described herein that can function the same or similarly across various implementations are identified using the same reference numerals with a different letter added after the reference numerals. Differences between the various implementations are discussed herein.

Various drawings shown and described herein include partial section views with various lines and components shown as overlapping or transparent for illustrative purposes.

As used herein, directional terms such as “upper,” “lower,” “top,” “bottom,” “left,” “right,” “front,” “rear,” and similar terms are used solely for ease of description with reference to the orientation of the elements as illustrated in the drawings. Such terms are not intended to be limiting and should be understood to encompass different orientations of the device or components in use or manufacture.

### Example of Internal Combustion Engine Overview

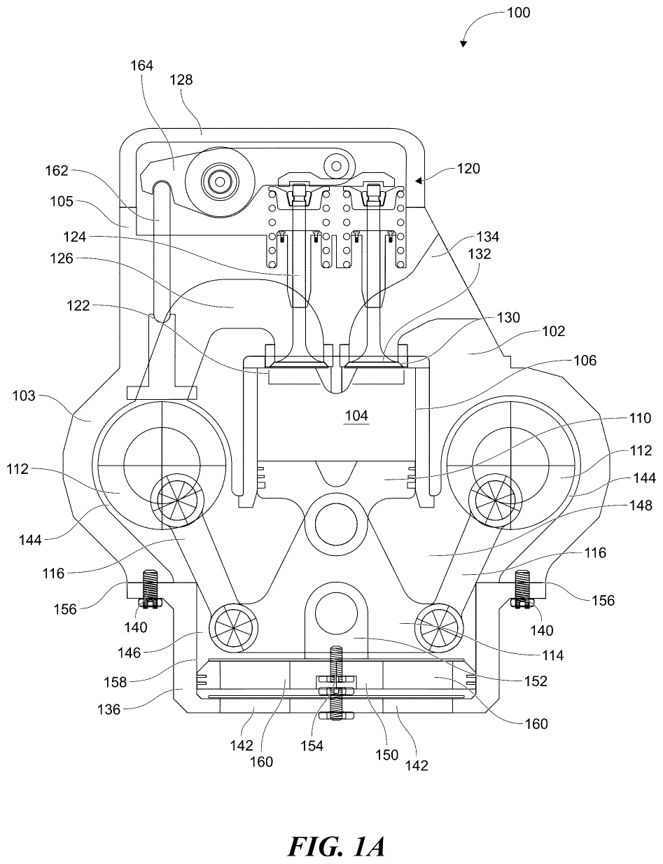

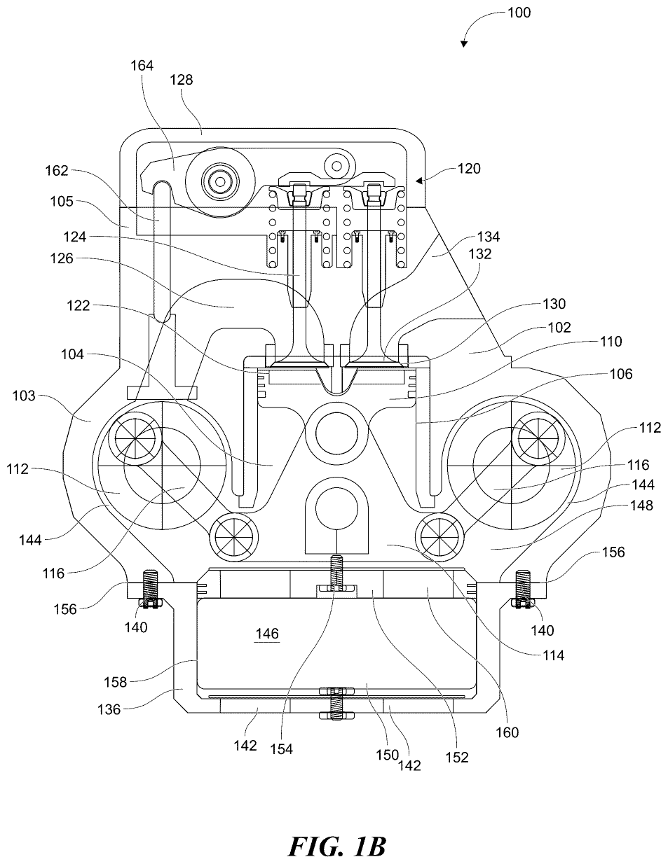

FIGS. 1A and 1B illustrate an embodiment of an internal combustion engine 100 that includes an added piston 150. The added piston 150 may also be referred to herein as the “secondary piston,” “auxiliary piston,” “second piston,” and/or “lower piston.” The added piston 150 can be used as a scavenging pump and/or supercharger for the internal combustion engine 100. In other examples, the added piston(s) 150, may not be auxiliary and may be the primary/combustion piston(s) of the internal combustion engine 100. For example, the added piston 150 can be used for compression, expansion, and/or scavenging, depending on the configuration.

The added piston 150 can cause a flow of gases (e.g., air) to travel through the internal combustion engine 100 for use as intake air in the combustion chamber 104. Accordingly, the added piston 150 can function as an air intake system for the internal combustion engine 100. FIG. 1A shows the added piston 150 in a bottom dead center position and FIG. 1B shows the 150 in a top dead center position. In some configurations, the added piston 150 can compress the intake air before it enters the combustion chamber 104 to create charge air, which can enhance engine performance, increase power output, improve fuel efficiency, and/or compensate for altitude effects. The internal combustion engine 100 can be a two-stroke engine. In other configurations, the internal combustion engine 100 can be a four-stroke engine.

The internal combustion engine 100 may include any and/or all of the implementations and/or features of the internal combustion engine systems described and/or illustrated in PCT Application No. US2024/054996, filed Nov. 7, 2024, titled “INTERNAL COMBUSTION ENGINE,” PCT Application No. US2024/015639, filed Feb. 13, 2024, titled “INTERNAL COMBUSTION ENGINE,” and in U.S. Provisional Patent Application No. 63/597,654, filed Nov. 9, 2023, titled “INTERNAL COMBUSTION ENGINE,” the entire contents of each of which are hereby incorporated by reference in their entireties.

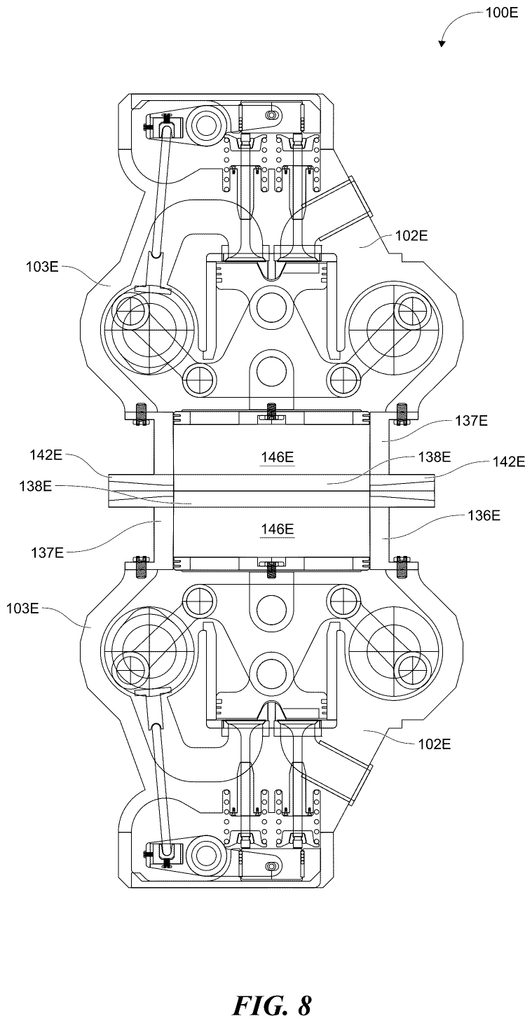

The internal combustion engine 100 that is illustrated in at least FIGS. 1A and 1B comprises a uniblock 102. Other implementations of the internal combustion engine 100 can include at least two uniblocks (see, e.g., engine 100E in FIG. 8). The construction of the uniblock 102 is distinct from separable cylinder block and cylinder head assemblies commonly employed in conventional reciprocating internal combustion engines. In those conventional reciprocating internal combustion engines, the cylinder head assemblies are bolted to the cylinder block with a gasket positioned between the two. Together, the cylinder head assembly and the cylinder block define the combustion chambers while the cylinder block defines the cylinder bores. In some implementations, the internal combustion engine 100 can comprise a conventional reciprocating internal combustion engine design with one or more added piston(s) 150.

In the illustrated construction, however, what would be considered the cylinder head and the cylinder block in conventional reciprocating internal combustion engines are integrated into a single component to define at least a portion of the uniblock 102. The uniblock 102 illustrated in FIGS. 1A and 1B can be formed as a single component that defines a combustion chamber 104 and a cylinder bore 106. In some configurations, the uniblock 102 can be a monolithic component that defines the combustion chamber 104 and the cylinder bore 106. In some configurations, the uniblock 102 can define more than one combustion chamber and/or more than one cylinder bore.

The uniblock 102 that is illustrated encloses, envelopes, and/or surrounds both of the combustion chamber 104 and at least a portion of the cylinder bore 106 that is associated with the combustion chamber 104. In some configurations, the uniblock 102 encloses, envelopes, and/or surrounds the combustion chamber 104 and at least a majority of the cylinder bore 106. In some configurations, the uniblock 102 encloses, envelopes, and/or surrounds the combustion chamber 104 and all of the cylinder bore 106. In other words, the combustion chamber 104 and the cylinder bore 106 can be defined within the uniblock 102.

A piston 110 is positioned within the cylinder bore 106. The piston 110 may be referred to herein as the “combustion piston” or the “primary piston.” The piston 110 is configured to reciprocate within the cylinder bore 106. In some configurations, the piston 110 is inserted into the uniblock 102 from the bottom of the uniblock 102. In other words, because the combustion chamber 104 and the cylinder bore 106 are formed inwardly from the bottom of the uniblock 102 (e.g., similar to a blind hole), the piston 110 is inserted into the cylinder bore 106 from the bottom of the uniblock 102. Several constructions for the piston 110 are described in PCT Application No. US2024/015639.

While FIG. 1 illustrates one cylinder bore 106 for the internal combustion engine 100, it is recognized that the internal combustion engine 100 can include more than one cylinder bore 106, in some configurations. For example, the internal combustion engine 100, and any of the internal combustion engines described herein, can include additional cylinder bores in the direction into or out of the page. When multiple cylinder bores are included, each cylinder bore can house a primary piston (e.g., the piston 110). Further, each primary piston can be associated with one or more added piston 150.

The piston 110 is connected to two crankshafts 112 in the illustrated configuration. The two crankshafts 112 in the internal combustion engine 100 are on opposing sides of the cylinder bore 106. That is, in the internal combustion engine 100, the cylinder bore 106 is positioned between or at least partially between the two crankshafts 112. Depending upon the configuration of the internal combustion engine 100 using the uniblock 102, the number of crankshafts 112 and/or their rotation relative to one another can vary. In some configurations, each uniblock 102 carries two or more counter-rotating crankshafts 112. In some configurations, there can be an even number of crankshafts 112.

The two crankshafts 112 can be disposed on either side of the or piston 110 (e.g., the piston is positioned between the two crankshafts 112). The center axes (i.e., the axes of rotation) of the crankshafts 112 can be disposed below the top of the cylinder bore 106 and/or the piston 110 when the piston is in top dead center but above the lower end of the cylinder bore and/or the piston 110 when the piston is in bottom dead center. In some configurations, the center axes of the crankshafts 112 can be above a connection point between a crosshead 114 and any connecting rods 116 that connect to the crosshead 114. In some configurations, the internal combustion engine 100 may only include one crankshaft 112.

In the illustrated configuration, the two crankshafts 112 are fully or substantially housed within the uniblock 102. For example, each crankshaft 112 can be located within a crankshaft containing passage 144 (also referred to herein at the “crankshaft containing portion 144”) of a crank portion 103 of the uniblock 102. The crankshaft containing passages 144 can be machined into the crank portion 103 of the uniblock 102. In other configurations, the two crankshafts 112 can be accessible from outside of the uniblock 102. In such a configuration, the two crankshafts 112 could inserted from a top side (e.g., a side generally opposing the side with the opening in the uniblock 102 defined by the cylinder bore 106) or a lateral side of the uniblock 102. In such a configuration, the two crankshafts 112 could be accessible to the outside of the uniblock 102 through a side that is different from the side of the uniblock 102 through which the piston 110 is accessible.

In the illustrated configuration, the two crankshafts 112 are connected to the crosshead 114. The crosshead 114 can be separate of and connected to the piston 110, for example, as shown in the illustrated configuration. In other embodiments, the crosshead can be integrally formed and or/permanently coupled to one or both of the primary piston 110 or additional piston 150.

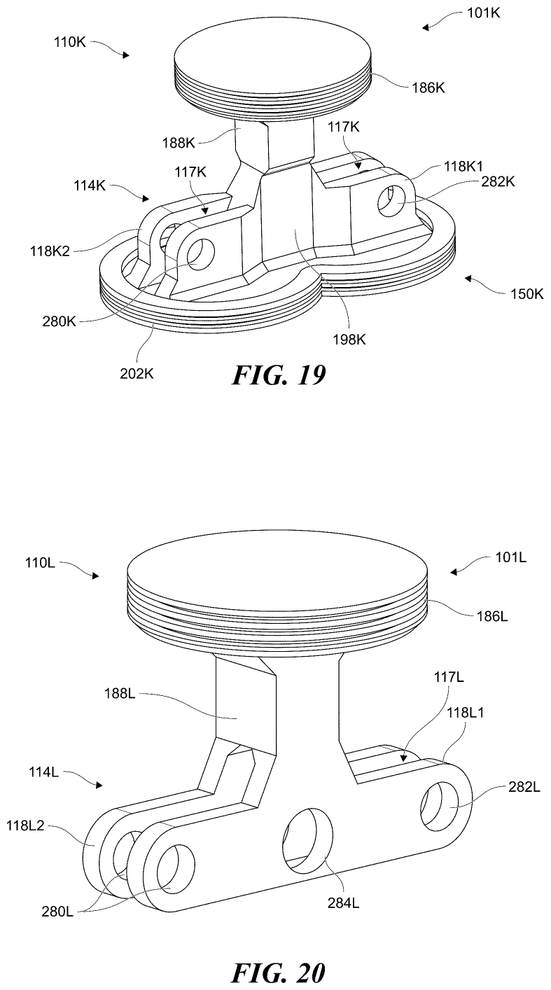

In some configurations, the crosshead 114 can be integrally formed (or separately formed and then permanently joined) as a monolith with at least one piston 110 (see, e.g., the piston subassemblies 101K, 101L, and 101M of FIGS. 19-21). As discussed below, in some configurations, the crosshead 114 can be integrally formed (or separately formed and then permanently joined) as a monolith with at least one added piston 150. In some configurations, the crosshead 114 can be generally triangular or Eiffel Tower shaped. In other configurations, the crosshead 114 can be configured as one or more linearly shaped rods. The crosshead 114 can be subject to tensile and compressive forces. Accordingly, in some configurations, the crosshead 114 can be formed of a material with a high degree of mechanical strength, such as iron or steel. In other configurations, the crosshead 114 can be formed of ferrous alloys, high strength alloys of aluminum, titanium, Inconel, or other metal alloys. In some configurations, the crosshead 114 can be formed of metal and ceramic alloys, or carbon fiber containing and/or technical ceramic materials. Several constructions for the crosshead 114 are described in PCT Application No. US2024/015639.

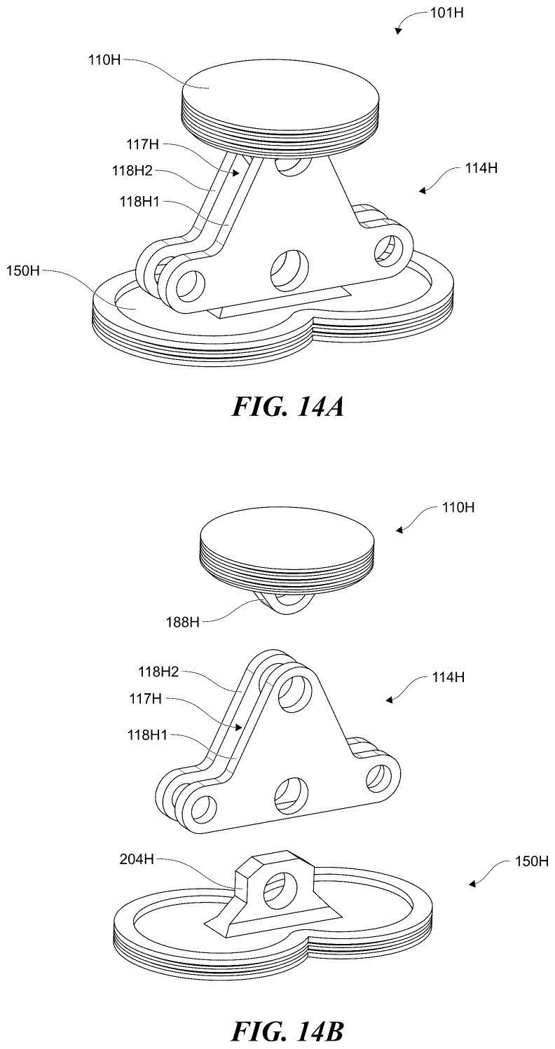

As discussed below, in some configurations, the crosshead 114 can be formed of one or more components. For example, as shown in FIGS. 14A and 14B, the crosshead 114H can include a first crosshead portion 118H1 and a second crosshead portion 118H2. When configured as multiple components, the two crosshead portions 118H1, 118H2 can be similar or identical to each other. For example, the two crosshead portions 118H1, 118H1 can be similar plates that are aligned with each other. In other configurations, the crosshead 114 can be a single component.

Each of the two crankshafts 112 is connected to the crosshead 114 using one or more connecting rod 116. Because of the positioning of, and use of, the two crankshafts 112, the connecting rods 116 can operate primarily or almost entirely under tension during movement of the piston 110. In some embodiments, the connecting rods 116 are under tension at least during the combustion stroke of the cycle of the internal combustion engine 100. Several constructions for the connecting rods 116 are described in PCT Application No. US2024/015639.

The crosshead 114 in combination with the connecting rods 116 and the pair of crankshafts 112 define an assembly that, in some embodiments, constrains movement of the piston 110 to be only linear (allowing for slight variation as a result of tolerance deviations). The movement of the piston 110 is along the cylinder axis (e.g., the central axis of the cylinder bore 106). According to some configurations, the piston 110 can move only parallel (e.g., substantially only parallel) to the center line of the cylinder bore 106 with little or no side to side, rocking, or slapping forces. Constraining the motion of the piston 110 reduces side forces and stress loading on the piston 110 and on walls that define the cylinder bore 106. Such a configuration can provide significant advantages, including reduced wear of piston side walls, piston rings, and/or the cylinder/cylinder liner walls. In some cases, the arrangement can provide the advantage of reduced frictional heat and work energy losses. In some cases, the arrangement can provide the advantages of reduced weight, reduced vibration, and/or reduced noise.

Combustion materials (e.g., fuel and air) are delivered to the internal combustion engine 100 for combustion in the combustion chamber 104. The internal combustion engine 100 comprises at least one intake valve opening 122 and/or at least one fuel injector (not shown). Flow into the combustion chamber 104 through the intake valve opening 122 can be controlled by one or more intake valves 124. Air for the internal combustion engine 100 can be received from the crank portion 103 via an intake passage 126. The intake passage 126 can be connected to a crankshaft containing passage 144 that receives air from an added cylinder 146 of the internal combustion engine 100, as discussed further below. The intake passage 126 can be partially formed in the crank portion 103 and partially formed in a valve portion 105 of the uniblock 102.

The internal combustion engine 100 can expel exhaust products through at least one exhaust valve opening 130. Flow out of the combustion chamber 104 through the exhaust valve opening 130 can be controlled by one or more exhaust valves 132. The exhaust gases that pass through the exhaust valve opening 130 enter into an exhaust passage 134. The exhaust passage 134 originates at the exhaust valve opening 130 and extends upward and outward in the illustrated configuration. The exhaust passage 134 can be formed within the uniblock 102 in any suitable manner. One or more than one exhaust valve openings 130 can be provided. In configurations featuring multiple exhaust valve openings 130, the exhaust passage 134 can comprise multiple runners with each runner terminating at the respective exhaust valve opening 130. Other configurations also are possible.

In the illustrated construction, a valve train 120 is positioned above the combustion chamber 104. The valve train 120 in the illustrated construction is a mechanical system that controls the opening and closing of the intake valves 124 and the exhaust valves 132. The valve train 120 is mainly positioned within a chamber defined by a valve train cover 128 and recess(es) defined within the upper surface of the head or valve portion 105 of the uniblock 102. Fasteners (not shown) can be used to secure the valve train cover 128 to the uniblock 102. A sealing gasket (not shown) can be positioned between the valve train cover 128 and the unblock 102.

In the illustrated configuration, the valve train 120 includes at least one pushrod 162 and at least one rocker arm 164. The pushrod 162 can transmit motion from the crankshaft 112 to the rocker arm 164 to control the opening and/or closing of the intake valve(s) 124 and exhaust valve(s) 132. In other implementations, different configurations for the valve train 120 are possible. For example, the internal combustion engine 100 may include cams on the crankshaft 112 for actuating the pushrod 162, may include one or more camshafts as part of an overhead cam system, and/or the like. Several implementations of valve trains and valve configurations are described in PCT Application No. US2024/054996.

In some configurations, the number and location of the crankshafts 112, being multiple and being closer to the intake and exhaust valves 124, 130 (e.g., compared to conventional engines), can provide certain advantages, including the locations of, orientation of, and the reduction of length, weight, and reciprocating mass of valve train pushrods 162. In some cases, the arrangement can provide the advantages of reduced parts, reduced bearings that would be needed for dedicated cam shafts, and reduced frictional heat, and work energy losses.

### Added Piston

The uniblock 102, or any engine part containing support for any crankshaft or crankshafts (e.g., the crankshafts 112), can be mounted to an additional housing 136. In some cases, the additional housing 136 can be mounted to a bottom or lower portion of the uniblock 102. As explained herein, the additional housing 136 can include one or more cylinder bores (e.g., added cylinder bore 158) to house the added piston 150, in some configurations. Accordingly, the additional housing 136 may be referred to herein as the “additional cylinder housing,” or the “additional cylinder block.” In other configurations, the additional housing 136 may not include any bores (cylindrically shaped or otherwise) and may form a portion of the uniblock 102. In other configurations, particularly where the crank portion 103 and the valve portion 105 form one component (e.g., the uniblock 102), the additional housing 136 may be an “added uniblock” or a “lower housing.” In some configurations, the additional housing 136 may not be attached to the uniblock 102. For example, where the additional housing 136 houses a piston configured as the primary piston, the additional housing 136 can be attached to other components of the internal combustion engine 100 that support a single standard crankshaft.

A mounting region 156 of the uniblock 102 can be positioned on the bottom of the uniblock 102. The mounting region 156 in the illustrated configuration comprises a central recess 148. The central recess 148 is recessed from the bottom of the uniblock 102 towards the combustion chamber 104. In some configurations, the central recess comprises upwardly angled sidewalls that terminate at the edge of the unlined cylinder bore 106. Such a configuration can reduce the overall size of the internal combustion engine 100 while providing adequate strength.

The additional housing 136 can be mounted to the uniblock 102 using any conventional means. In some cases, the uniblock 102 may be referred to the “primary block” or “primary uniblock,” depending on the configuration of the additional housing 136. In the illustrated configuration, the additional housing 136 is mounted to the uniblock 102 using fasteners 140. For example, the mounting region 156 of the uniblock 102 can include one or more mount holes (not shown) and the additional housing 136 can include one or more mount holes (not shown) that receive the fasteners 140 to secure the uniblock 102 to the additional housing 136.

The additional housing 136 can be shaped to define one or more added cylinder(s) 146. In the illustrated configuration of FIGS. 1A and 1B, the additional housing 136 defines a single added cylinder 146. The added piston 150 can reciprocate within the added cylinder 146 to generate intake air for the internal combustion engine 100. The added cylinder 146 and the added piston 150 can be cylindrical in some configurations and may be shaped differently in other configurations, as described further below.

The added cylinder 146 can be aligned with the centerline of the internal combustion engine 100 and/or the combustion chamber 104 in some configurations. For example, a central axis of the added cylinder 146 can be aligned with a central axis of the combustion chamber 104. Having a shared central axis can provide a benefit of preventing or reducing the bending loads, torsional and other vibrations, and/or secondary forces on the crankshafts 112. As a result, in some configurations, the crankshafts 112 can be smaller and lighter, resulting in a more efficient, smaller, and/or lighter internal combustion engine 100. In other configurations, the added cylinder 146 may be off-set some distance from the centerline of the internal combustion engine 100.

The added cylinder bore 158 can be aligned with the sidewalls of the mounting region 156 to define a continuous internal volume within the crank portion 103, although this need not be the case in all embodiments. The added cylinder 146 may also be referred to herein as the “secondary cylinder,” “auxiliary cylinder,” “second cylinder,” and/or “lower cylinder.” Similarly, the added cylinder bore 158 may also be referred to herein as the “secondary cylinder bore,” “auxiliary cylinder bore,” “second cylinder bore,” and/or “lower cylinder bore.”

The central recess 148 can be connected to and in communication (e.g., fluid communication) with at least one crankshaft containing passage 144. At least one crankshaft containing passage 144 can be connected to the intake passage 126 of the uniblock 102.

The intake passage 126 can be positioned in an upper portion of the crank portion 103 and can extend into a lower portion of a valve portion 105 of the uniblock 102. The intake passage 126 can extend horizontally and downwardly to open into the combustion chamber 104. The lower end of the intake passage 126 terminates at the intake valve opening 122. As such, the added cylinder 146 can be in fluid communication with the combustion chamber 104 when the intake valve 124 is open. One or more than one intake valve opening(s) 122 can be provided. In configurations featuring multiple intake valve openings 122, the intake passage 126 can comprise multiple runners with each runner terminating at the respective intake valve opening 122. Other configurations also are possible.

As described above, the added piston 150 has several possible uses. For example, the added piston 150 can provide added compression, provide added expansion, and/or generate added intake air pressure for scavenging the internal combustion engine 100 or any engine that incorporates the added piston 150.

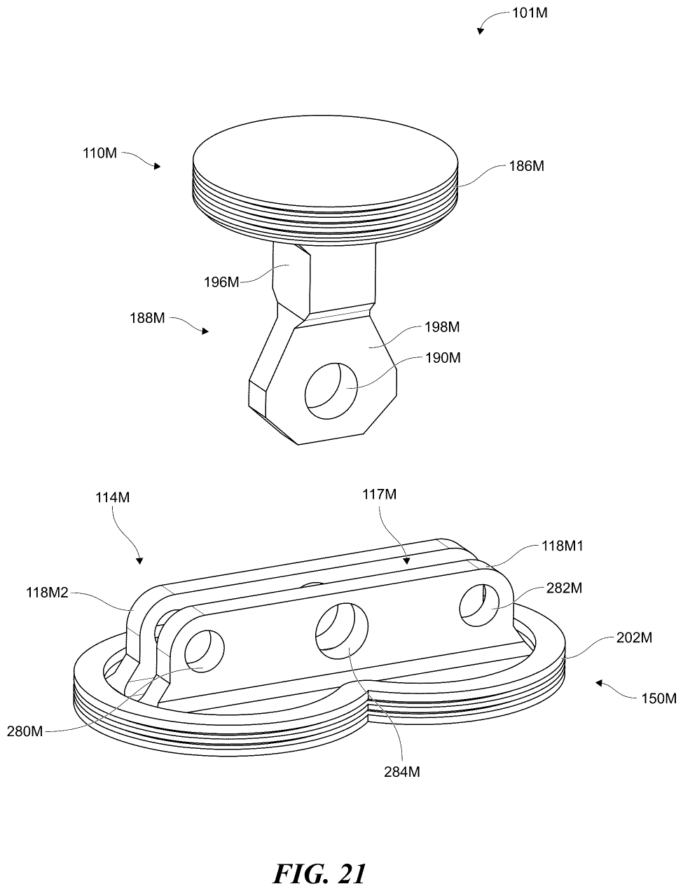

The added piston 150 can be coupled or fixed to any crosshead (e.g., the crosshead 114). The coupling and/or fixation can allow for articulation between the added piston(s) 150 and the crosshead 114 in some configurations, while in other configurations, the coupling and/or fixation may not allowing articulation between the added piston(s) 150 and the crosshead 114. In some configurations, the added piston 150 may be integrally formed with a crosshead, such as the crosshead 114 (see e.g., the piston subassembly 101M of FIG. 21). In such a configuration, no articulation would be possible.

The added piston 150 can be connected to the crosshead 114 on a different side of the crosshead than the primary piston 110. In the illustrated configuration, the added piston 150 is coupled to the crosshead 114 via a connecting rod 152. The connecting rod 152 can provide a space between a lower surface of the crosshead 114 and an upper surface of the added piston 150. In other configurations, the added piston 150 may abut the crosshead 114. The added piston 150 can be coupled to the connecting rod 152 via any conventional means. In the illustrated configuration, at least one fastener 154 extends through the added piston 150 to connect the added piston 150 to the crosshead 114. In some configurations, the connecting rod 152 can be configured to allow some articulation between the added piston 150 and the crosshead 114. For example, the added piston 150 may be connected to the connecting rod 152 using one or more wrist pins or other such components that allow for articulation. In some configurations, the internal combustion engine 100 may include one, two, or more than two connecting rods for connecting the added piston 150 to the crosshead 114. In some configurations, the added piston 150 may not articulate relative to the crosshead 114. In some configurations, the connecting rod 152 may be integrally formed with the added piston 150. In such a configuration, the connecting rod 152 can function in a similar manner as a piston pin boss.

In the illustrated configuration, the crosshead 114 in combination with the connecting rods 116 and the pair of crankshafts 112 define an assembly that constrains movement of the added piston 150 to be only linear (allowing for slight variation as a result of tolerance deviations). The movement of the added piston 150 is along the cylinder axis (e.g., the central axis of the added cylinder bore 158). According to some configurations, the added piston 150 can move only parallel (e.g., substantially only parallel) to the center line of the added cylinder bore 158 with little or no side to side, rocking, or slapping forces. As such, the added piston 150 can be axially aligned with one or both the piston 110 and the crosshead 114 and may move in the same central axis of movement as the piston 110 and/or the crosshead 114. Constraining the motion of the added piston 150 reduces side forces and stress loading on the added piston 150 and on walls that define the added cylinder bore 158. Such a configuration can provide significant advantages, including reduced wear of piston side walls, piston rings, and/or the cylinder/cylinder liner walls. In some cases, the arrangement can provide the advantage of reduced frictional heat and work energy losses. In some cases, the arrangement can provide the advantages of reduced weight, reduced vibration, and/or reduced noise.

To allow air to enter the added cylinder 146 from outside the internal combustion engine 100, the additional housing 136 can include one or more intake ports 142. In the illustrated configuration, the additional housing 136 includes two intake ports 142. The intake ports 142 can each include a one-way valve (e.g., a reed valve, a poppet valve, a rotary valve, a one-way ball valve, and/or the like) that allows fluid to flow in one direction into the added cylinder 146, while preventing back flow. In other configurations, each intake port 142 can be an intake port set including a plurality of intake ports (e.g., between 1 and 12, between 2 and 10, between 4 and 8, and/or the like). For example, the added cylinder 146 can include one or more sets of intake ports configured to allow fluid to flow into the added cylinder 146. As the added piston 150 moves from the bottom dead center position of FIG. 1A to the top dead center position of FIG. 1B, the upward movement of the added piston 150 creates a vacuum in the added cylinder 146 that opens the one-way valves in the intake ports 142, drawing air into the added cylinder 146.

The added piston 150 can include one or more ports 160 extending from a bottom surface of the added piston 150 to its top surface. In the illustrated configuration, the added piston 150 includes two ports 160. The ports 160 can be configured to allow fluid in the added cylinder 146 to flow through the added piston 150 and into the combustion chamber 104 via the intake passage 126. The ports 160 can each include a one-way valve (e.g., a reed valve, a poppet valve, a rotary valve, a one-way ball valve, and/or the like) that allows fluid to flow in one direction from the added cylinder 146 and into the central recess 148, while preventing back flow. Accordingly, the ports 160 can allow flow in the same direction as the intake ports 142, in some configurations. As the added piston 150 moves from the top dead center position to the bottom dead center position, the fluid in the added cylinder 146 can be compressed between the added piston 150 and the added cylinder bore 158. Continued movement of the added piston 150 towards the additional housing 136 causes the fluid in the added cylinder 146 to travel through the added piston 150 via the ports 160 and towards the intake valve opening 122 (e.g., through the central recess 148, one of the crankshaft containing passages 144, and the intake passage 126).

In some configurations, each port 160 can be a port set including a plurality of ports (e.g., between 1 and 12, between 2 and 10, between 4 and 8, and/or the like). For example, the added piston 150 can include one or more sets of ports configured to allow fluid to flow in one direction through the added piston 150.

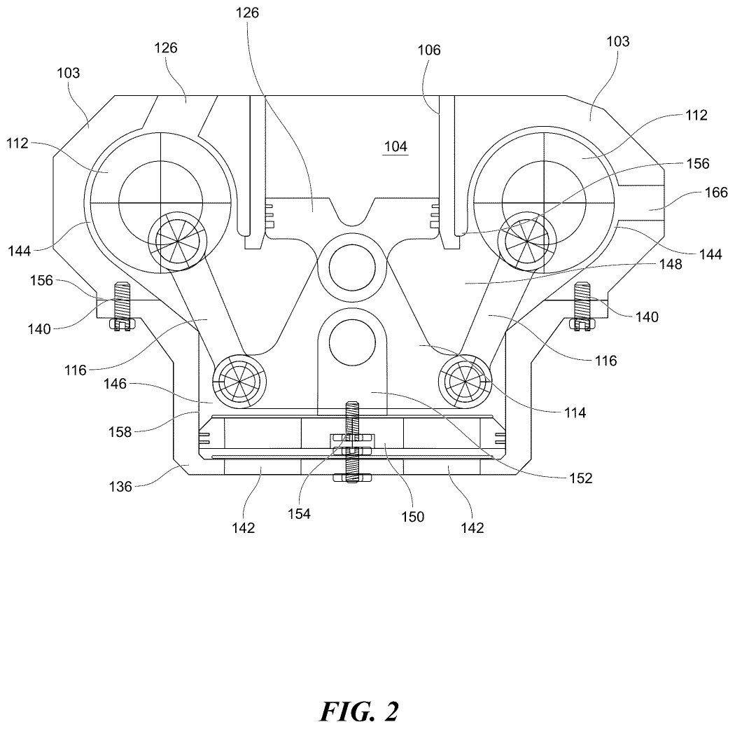

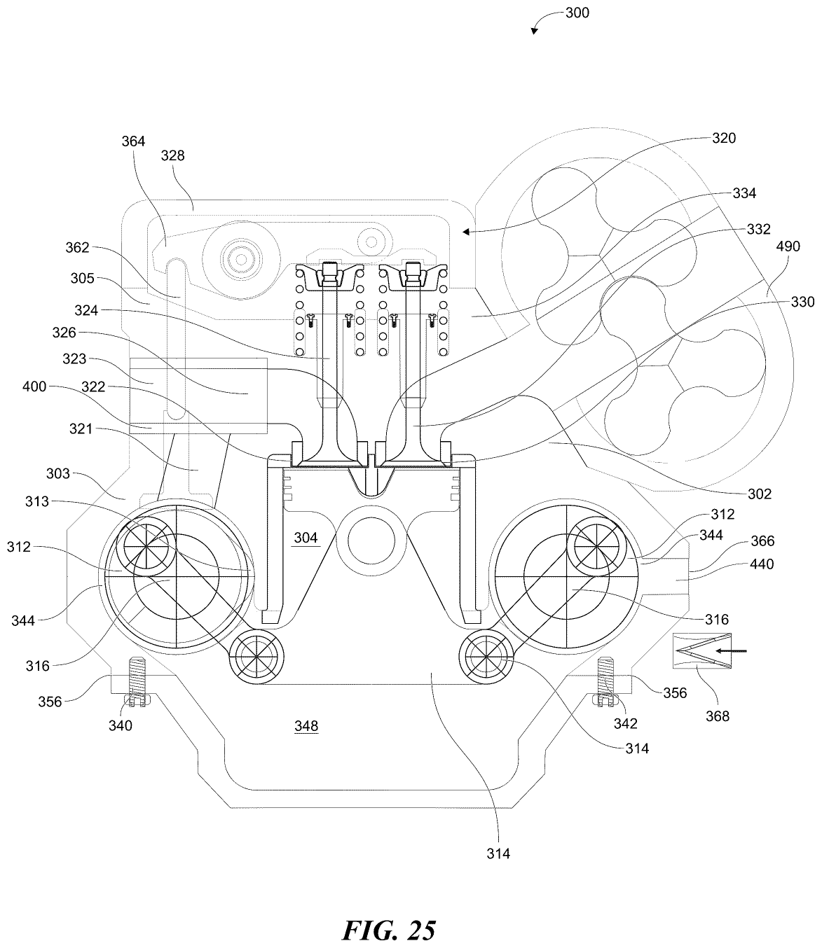

In other configurations, the additional housing 136 may not include intake ports 142 and/or the added piston 150 may not include ports 160. For example, FIG. 2 illustrates another configuration of the internal combustion engine 100 that includes an intake port 166 in the crank portion 103. For ease of illustration, only the crank portion 103 is shown in FIG. 2. In this configuration, the intake port 166 can extend through the crank portion 103 and into one of the crankshaft containing passages 144 (e.g., the crankshaft containing passage 144 below the exhaust passage 134). Air from outside the internal combustion engine 100 can enter the central recess 148 from the intake port 166. The intake port 166 can include a one-way valve (e.g., a reed valve, a poppet valve, a rotary valve, a one-way ball valve, and/or the like) that allows fluid to flow in one direction through the crank portion 103 and to the combustion chamber 104 via the intake passage 126, while preventing back flow. In such a configuration, the internal combustion engine 100 may include a scavenging blower, supercharger, and/or the like device in fluid communication with the exhaust passage 134 to induce fluid flow through the crank portion 103 via the intake port 166 (see e.g., FIG. 25). In some configurations, the internal combustion engine 100 may include one or more intake ports 142 in the additional housing 136 and one or more intake ports 166 extending through the crank portion 103 into one of the crankshaft containing passages 144.

The linear or axial positions of the piston 110 and the added piston 150 can be substantially fixed relative to the crosshead 114. Accordingly, when the piston 110 is in the top dead center position relative to the combustion chamber 104, the added piston 150 is in the top dead center position relative to the added cylinder 146. Similarly, when the piston 110 is in the bottom dead center position, the added piston 150 is in the bottom dead center position. As such, in a two-stroke configuration, the compression stroke of the piston 110 corresponds to an intake stroke of the added piston 150 and the power stroke of the piston 110 corresponds to an exhaust stroke of the added piston 150.

As shown in FIG. 1A, in the illustrated configuration, the additional housing 136 is sized to allow the crosshead 114 to extend at least partially into the added cylinder 146 during the power stroke of the piston 110 (e.g., when the piston 110 is at bottom dead center). The added cylinder 146 can have a greater long axis (e.g., width or diameter) than the long axis of the crosshead 114. Such a configuration can provide a benefit of reducing the overall height and/or the size of the internal combustion engine 100. In some implementations, such a configuration results in the volume of the added cylinder 146 being larger than the volume of the combustion chamber 104, which can be desirable. In some configurations, the added piston 150 can be larger than, smaller than, or the same size in any dimension as the crosshead 114 and/or the piston 110.

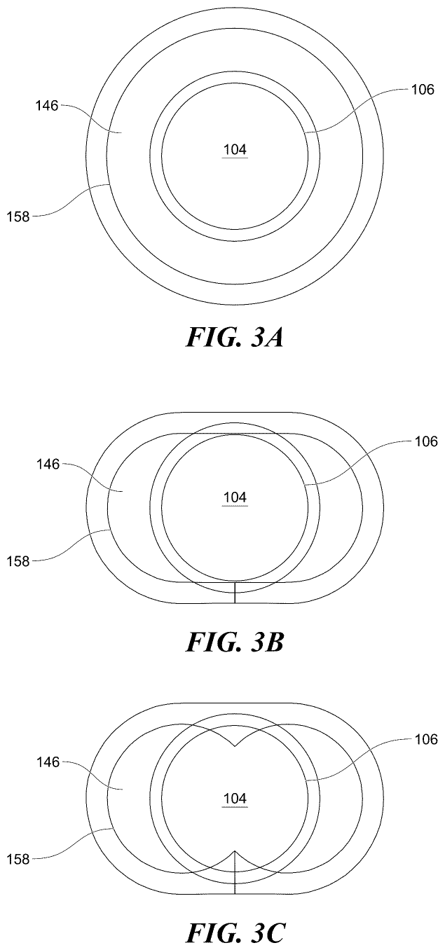

The size and shape of the added cylinder 146 and added piston 150 can vary between different configurations of the internal combustion engine 100. FIGS. 3A-3C illustrate top isolation views of the cylinder bore 106 of the combustion chamber 104 and various implementations of the added cylinder bore 158 of the added cylinder 146. For illustrative purposes, the lines in FIGS. 3A-3C are shown as overlapping. Generally, the shape of the added piston 150 corresponds to the shape of the added cylinder bore 158. While the following description references the added cylinder 146, similar or identical designs can be used for the cylinder bore 106 of the combustion chamber 104 in the internal combustion engine 100. Therefore, the configurations of added cylinder bore 158 in FIGS. 3A-3C are understood to apply to configurations for cylinder bore 106.

As shown in FIG. 3A, in some configurations the added cylinder bore 158 can have a circular shape when viewed from above. For example, the added cylinder bore 158 can be cylindrical. In the illustrated configuration of FIG. 3A, the diameter of the added cylinder bore 158 is larger than the diameter cylinder bore 106. Such a configuration can allow for a greater volume of air (e.g., a higher stroke volume) to be directed from the added cylinder 146 to the combustion chamber 104, which can be desirable for certain applications. In some configurations, the diameter of the added cylinder bore 158 can be between one to two times larger than the diameter cylinder bore 106. In some configurations, the diameters of the added cylinder bore 158 and the cylinder bore 106 can be substantially identical. In some configurations, the diameter of the added cylinder bore 158 can be smaller than the diameter of the cylinder bore 106.

As shown in FIG. 3B, in some configurations the added cylinder bore 158 can have an obround or oblong shape when viewed from above. For example, the added cylinder bore 158 can be an oblong cylinder. When configured in this manner, the added cylinder bore 158 may be referred to as the “added piston housing” as the bore is not cylindrical. However, for case of reference, bores in the internal combustion engine 100 housing pistons are referred to herein as cylinder bores, regardless of their shape. In some cases, the added cylinder bore 158 may have an oval shape when viewed from above and can be an elliptical cylinder. In some configurations, the major axis of the oblong added cylinder bore 158 can be larger than the diameter of the cylinder bore 106. In other configurations, the major axis of the oblong added cylinder bore 158 can be less than the diameter of the cylinder bore 106. In some configurations, the minor axis of the oblong added cylinder bore 158 can be equal to the diameter of the cylinder bore 106, as shown in FIG. 3B. In other configurations, the minor axis of the oblong added cylinder bore 158 can be less than or greater than the diameter of the cylinder bore 106.

Having an oval/oblong shaped added cylinder bore 158 and/or cylinder bore 106 can provide certain benefits compared to conventional circular cylinder bores. For example, the oval/oblong shape can allow for different shaped engine blocks and/or uniblocks 102, with oval pistons which can be stacked together or oriented in different advantageous configurations. For example, these arrangements can allow for blocks that are shorter and stiffer, can allow the blocks to be shaped for improved cooling and/or for improved intake and exhaust porting, which may give reduced pumping friction and or pumping power losses. Additionally, the oval/oblong shape can allow for different and/or bigger arrangements for the valve train 120, which can be desirable in some cases.

The oval/oblong shaped cylinder bores 158, 106 can also introduce additional challenges for the internal combustion engine 100. For example, a greater number of connecting rods 116 and/or at least two crankshafts 112 may be required to prevent the corresponding oval/oblong pistons from rocking. Additionally, oval/oblong shaped cylinder bores and the corresponding pistons can be more difficult to machine/manufacture with a high degree of accuracy to the tight tolerances required between the two components. Finally, it can be difficult to manufacture piston rings that provide the required sealing between the pistons and the cylinder bores when oval/oblong shaped.

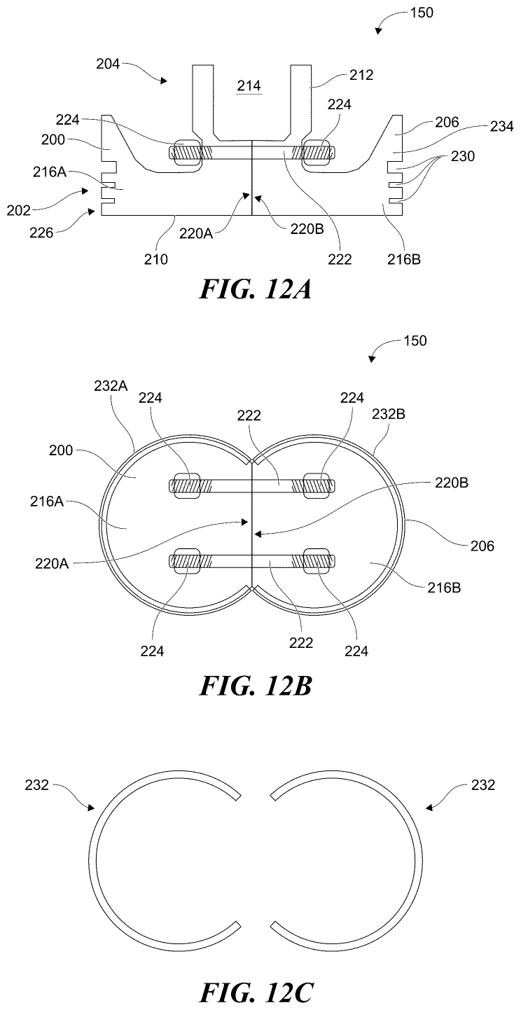

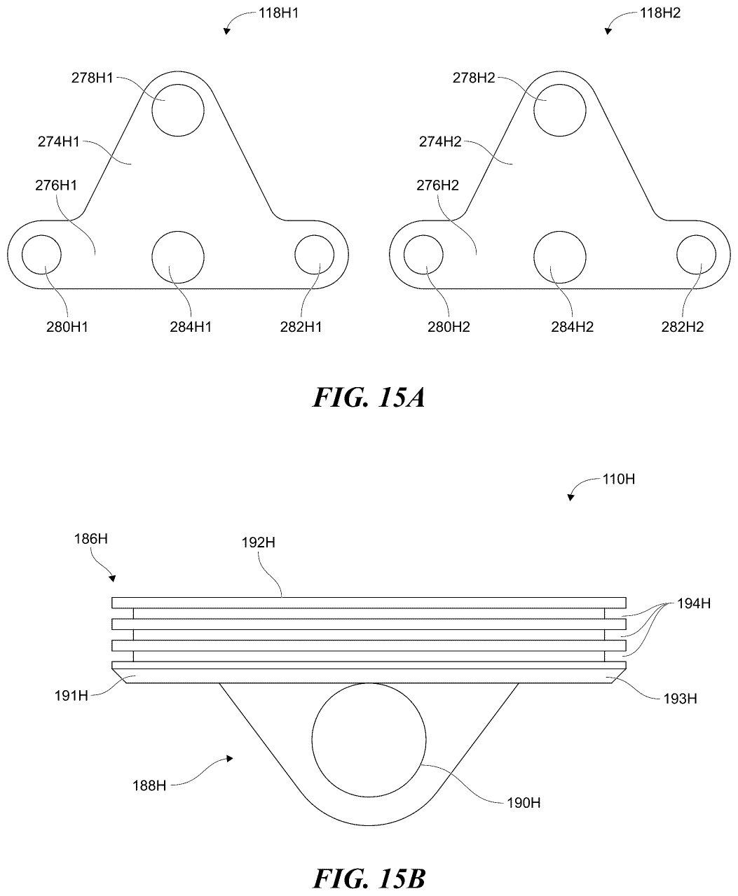

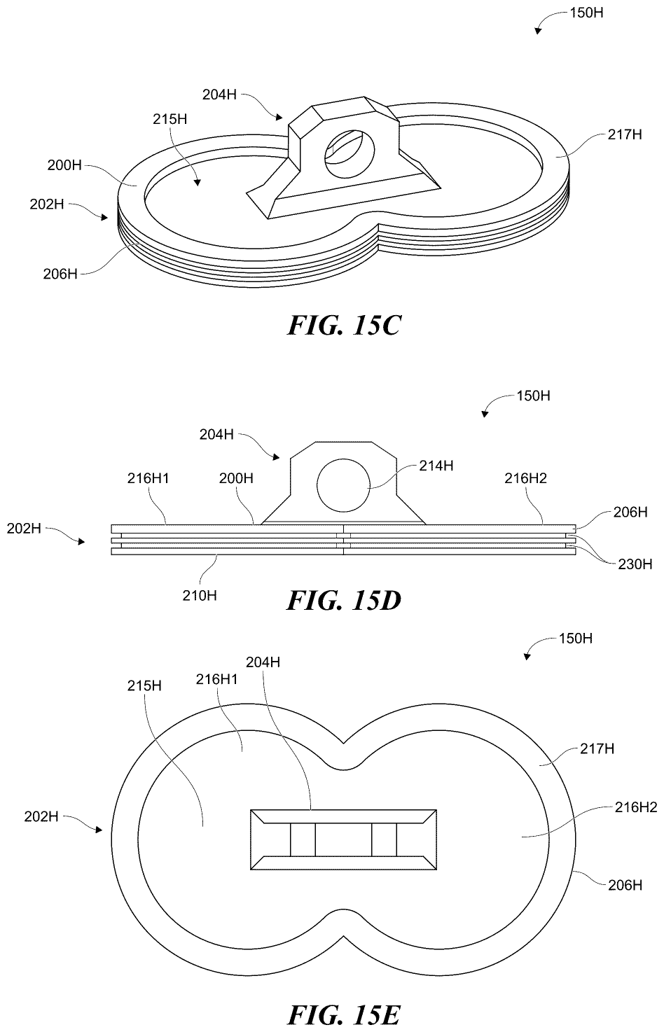

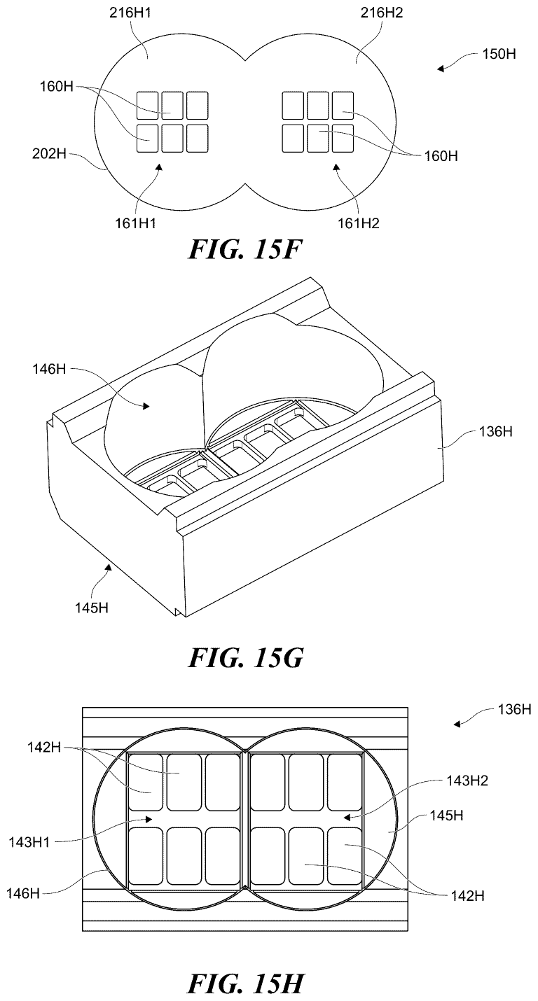

As shown in FIG. 3C, in some configuration the added cylinder bore 158 can have the shape of the perimeter of two overlapping circles when viewed from above. In the configuration illustrated in FIG. 3C, the two overlapping circles are shown to have the same radii. In other configurations, this geometry of two overlapping circles may use two circles having different radii. The added cylinder bore 158 can have the shape of two cylinders that are joined along chord lines that are at some distances from the centers of the two cylinders. In some configurations, the chord lines can be an equal distance from the centers of the two cylinders. This shape may be referred to herein as a “double-c,” “overlapping-circle,” “peanut,” “figure-of-8,” and/or “hourglass”. Depending on where the two cylinders intersect, the added cylinder bore 158 may have the shape of a vesica piscis. However, it is not required that the two cylinders intersect such that the center of each cylinder lies on the perimeter of the other. In some configurations, the diameter of the two cylinders forming the double-c shaped added cylinder bore 158 may be the same, less than, or greater than the diameter of the cylinder bore 106. When the added cylinder bore 158 is configured to be double-c shaped, a corresponding double-c shaped added piston 150 (e.g., with a piston body 200 shown in at least FIGS. 12A and 12B or with a piston body 200H shown in at least FIGS. 15C-15E) can be used, as described further below. Similarly, when the cylinder bore 106 is configured to be the double-c shape, a corresponding double-c shaped piston 110 can be used.

Having double-c shaped cylinder bores and pistons can provide certain benefits. For example, the double-c shape can provide the same benefits as the oval/oblong shape as well as reducing or eliminating one or more of the disadvantages. For example, double-c pistons can be easier to manufacture because cylinders can be used to manufacture the piston. Manufacturing cylinders is well understood and cylinders are usually easier to manufacture than non-cylindrical shapes, such as oval or oblong shapes. In some configurations, two cylinders can be manufactured and modified with parts removed and then used to manufacture the double-c piston. For example, the cylinders can be cut and joined together as described further below, such that the same precise tolerances of the cylinders can be utilized in the double-c piston. In some configurations, two substantially identical cylinders can be used to manufacture the double-c shaped piston.

Additionally, because each of the two cylinder portions of the double-c piston will resist lateral movement from the centerline from each respect cylinder bore portion, the movement of the double-c piston in the double-c cylinder will resist rocking of the piston, and the narrow portion in the middle will keep the double-c piston centered. As such, the side forces and rocking forces generated by the double-c pistons can be reduced relative to the oval/oblong shaped pistons such that two crankshafts 112 and/or two connecting rods 116 may not be required in the internal combustion engine 100. For example, an internal combustion engine can incorporate one or more double-c pistons for use with a single crankshaft. Additionally, double-c shaped pistons can utilize prescribed partial circular piston rings (e.g., with part of the circle missing). Such piston rings may also be described as “circular” or “constant radii arc” piston rings, as described further with reference to at least FIG. 12C.

As noted above, while FIGS. 3B and 3C show only the added cylinder bore 158 as being oblong and double-c shaped respectively, in some configurations, the cylinder bore 106 for the piston 110 can be oblong or double-c shaped. Further, any combination of circular, oblong, and double-c shapes can be used for the added cylinder bore 158 and the cylinder bore 106. Where a double-c-shaped cylinder bore and corresponding double-c-shaped piston is used, for either the piston 110 and or added piston 150, the orientation of the double-c shaped piston and bore can vary. For example, the long axis of the double-c shaped piston can extend in a plane perpendicular to an axis of rotation of the crankshaft(s) or the long axis of the double-c shaped piston can extend in a plane parallel to the axis of rotation of the crankshaft(s).

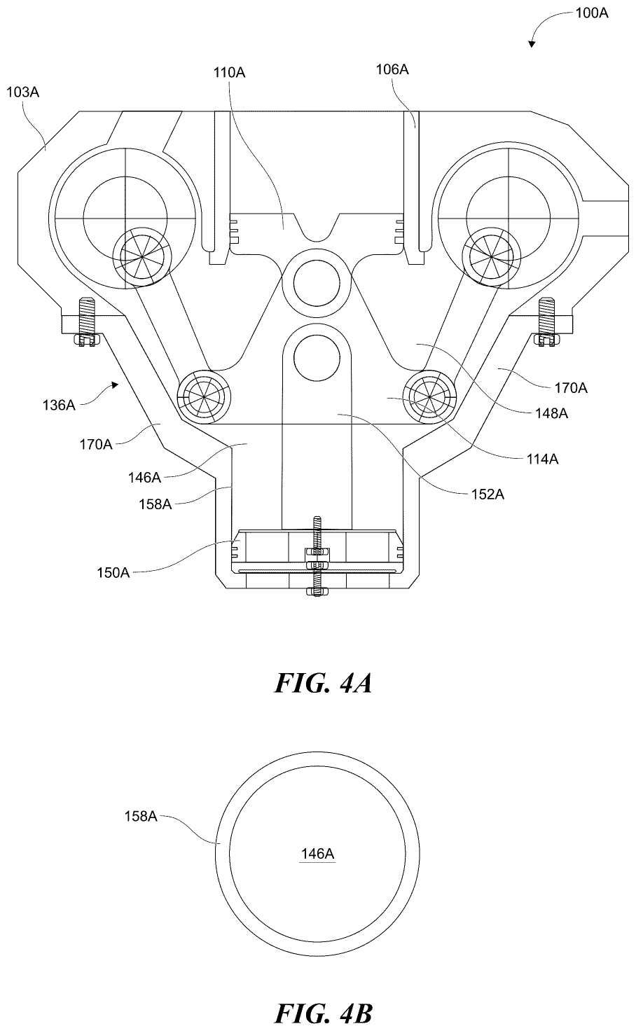

FIGS. 4A-10B illustrate various views of different configurations of the internal combustion engine 100 and components thereof. Some of the features of the internal combustion engines in FIGS. 4A-10B are similar to features of the internal combustion engine 100 in at least FIGS. 1A-2. Thus, reference numerals used to designate the various features or components of the internal combustion engines in FIGS. 4A-10B are identical to those used for identifying the corresponding features or components of the internal combustion engine 100 in at least FIGS. 1A-2, except that an additional letter (e.g., “A,” “B,” “C,” etc.) has been added to the numerical identifier for the internal combustion engines in FIGS. 4A-10B. Therefore, the structure and description for the various features of the internal combustion engine 100 and how it's operated in at least FIGS. 1A-2 are understood to also apply to the corresponding features of the internal combustion engines in FIGS. 4A-10B, except as described below.

FIG. 4A illustrates a configuration of an internal combustion engine 100A. The internal combustion engine 100A can include an additional housing 136A that differs from the additional housing 136 of the internal combustion engine 100 of FIGS. 1A-2. Only the crank portion 103A of the block of the internal combustion engine 100A is shown in FIG. 4A for illustrative purposes. The additional housing 136A is shaped to define a single added cylinder 146A. The additional housing 136A differs from the additional housing 136 in that the additional housing 136A is shaped such that the crosshead 114A does not enter the single added cylinder 146A during the power stroke of the piston 110A.

The additional housing 136A can include one or more side wall(s) 170A that extend upwardly from a bottom of the additional housing 136A to define the central recess 148A. The side walls 170A can extend angularly outward from the bottom of the additional housing 136A in at least one plane such that the central recess 148A is larger in a least one dimension that the single added cylinder 146A. For example, the width of the central recess 148A can be greater than a width/diameter of the added cylinder bore 158A. The additional housing 136A can be sized such that the crosshead 114A can be received within the central recess 148 without contacting the additional housing 136A. Because the crosshead 114A does not extend into the single added cylinder 146A, the connecting rod 152A can be longer than the connecting rod 152 of the internal combustion engine 100. In some configurations, the connecting rod 152A may be configured to prevent articulation of the added piston 150A relative to the crosshead 114A. In some configurations, the connecting rod 152A may allow some amount of articulation of the added piston 150A relative to the crosshead 114A. In some configurations, a longer articulating connecting rod 152A can provide a longer pendulum, which can be advantageous in some applications. Generally, the added piston 150A travels along a central axis of the added cylinder 146A that is aligned with the axis of motion of the crosshead 114A. The central axis of the added cylinder 146A can be aligned with the central axis of the cylinder bore 106A.

FIG. 4B shows a top view of the added cylinder 146A of the additional housing 136A. In the illustrated configuration, the added cylinder bore 158A is substantially circular. In some configurations, the added cylinder bore 158A can have the same diameter as the cylinder bore 106A. In other configurations, the added cylinder bore 158A can have a larger or smaller diameter than the cylinder bore 106. In some configurations, the added cylinder bore 158A can be oval or oblong shaped, similar to the added cylinder bore 158 shown in FIG. 3B. In some configurations, the added cylinder bore 158A can be double-c shaped, similar to the added cylinder bore 158 shown in FIG. 3C. In other configurations, any other suitable shape can be used for the added cylinder bore 158A.

The configuration of the single added cylinder 146A in the internal combustion engine 100A can provide certain benefits. For example, in such a configuration, the added cylinder bore 158A can have the same or a smaller volume than the cylinder bore 106 of the combustion chamber 104. Similarly, such a configuration can allow the added piston 150 to be the same size or smaller than the piston 110. The related factors can allow the internal combustion engine 100A to have a smaller stroke volume compared to the internal combustion engine 100, which can be desirable in some cases. For example, a smaller stoke volume can allow for improved fuel efficiency (e.g., less fuel and/or less friction), reduced emissions, lighter and/or more compact engines, reduced heat generation, higher RPMs, smoother operation, reduced manufacturing costs, and/or the like. Additionally, when the single added cylinder 146A has a cylindrical added cylinder bore 158, the manufacturing complexity is reduced compared to the double-c configurations.

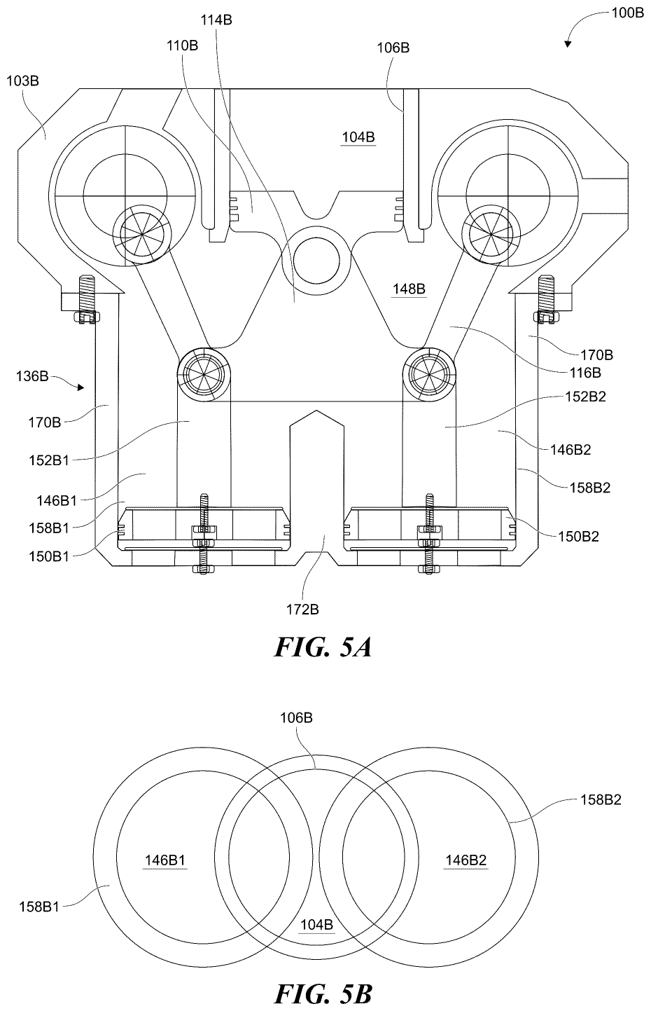

FIG. 5A illustrates a configuration of an internal combustion engine 100B. The internal combustion engine 100B can include an additional housing 136B that differs from the additional housing 136 of the internal combustion engine 100 of FIGS. 1A-2. Only the crank portion 103B of the block of the internal combustion engine 100B is shown in FIG. 5B for illustrative purposes. The additional housing 136B is shaped to define two added cylinders, a first added cylinder 146B1 and a second added cylinder 146B2. Each added cylinder 146B, 146B2 can house an added piston 150B1, 150B2 respectively. The additional housing 136B differs from the additional housing 136 in that the additional housing 136B is shaped to define multiple added cylinders. As such, the crosshead 114B does not enter either added cylinder 146B1, 146B 1 during the power stroke of the piston 110B.

The additional housing 136B can include one or more side walls 170B that extend upwardly from the bottom of the additional housing 136B to define the central recess 148B and the two cylinder bores 158B1, 158B2. The additional housing 136B can further comprise an internal wall or web 172B. The web 172B can extend between the first added cylinder 146B1 and the second added cylinder 146B2 and partially defines the two cylinder bores 158B1, 158B2. The web 172B can serve as a structural partition, providing support and maintaining precise separation between the cylinders 146B1, 146B2.

The central recess 148B is larger in at least one dimension that the dual added cylinders 146B1, 146B1. For example, the width of the central recess 148B can be greater than a width/diameter of each added cylinder bore 158B1, 158B2. The additional housing 136B can be sized such that the crosshead 114B can be received within the central recess 148B without contacting the web 172B of the additional housing 136B. Because of the multiple added pistons 150B1, 150B2, the internal combustion engine 100B can include two connecting rods for connecting to the added pistons 150B1, 150B2. For example, the internal combustion engine 100B can include a first connecting rode 152B1 for the first added piston 150B1 and a second connecting rod 152B2 for the second added piston 150B2. Because the crosshead 114B does not extend into the added cylinders 146B1, 146B2, the connecting rods 152B1, 152B2 can be longer than the connecting rod 152 of the internal combustion engine 100. In some configurations, the connecting rods 152B1, 152B2 may be configured to prevent articulation of the added pistons 150B1, 150B2 relative to the crosshead 114B. In some configurations, the connecting rods 152B1, 152B2 may allow some amount of articulation of the added pistons 150B1, 150B2 relative to the crosshead 114B.

FIG. 5B illustrates a top isolation view of the cylinder bore 106B of the combustion chamber 104B and the two added cylinders 146B1, 146B2 of the additional housing 136B. For illustrative purposes, the lines in FIG. 5B are shown as overlapping. In the illustrated configuration, the added cylinder bores 158B1, 158B2 are substantially circular. In some configurations, the added cylinder bores 158B1, 158B2 can have the same diameter as the cylinder bore 106B. In other configurations, the added cylinder bores 158B1, 158B2 can have a larger or smaller diameter than the cylinder bore 106B. In some configurations, the added cylinder bores 158B1, 158B2 can be oblong shaped, similar to the added cylinder bore 158 shown in FIG. 3B. In some configurations, the added cylinder bores 158B1, 158B2 can be double-c shaped, which can also be described as two overlapping circles, similar to the added cylinder bore 158 shown in FIG. 3C. In other configurations, any other suitable shape (e.g., any shaped described herein or any other shape) can be used for one or both of the added cylinder bores 158B1, 158B2. In some cases, the piston that moves in the added cylinder or cylinders bores 158B1, 158B2 may have shapes the correspond to the shapes of the added cylinder or cylinders bores 158B1, 158B2 (e.g., round pistons in round cylinders, oblong pistons in oblong cylinders, double-c pistons in double-c cylinders, other shaped pistons in other shaped cylinders, etc.).

In some configurations, the internal combustion engine 100B may include more than two added cylinders 146B in each cross-section. For example, in some configurations, the additional housing 136B may include three added cylinders 146B. Other configurations of the internal combustion engine 100B can include more than three added cylinders 146B in each cross-section.

The configuration of the dual added cylinders 146B1, 146B1 can provide certain advantages for the internal combustion engine 100B. For example, the two added pistons 150B1, 150B2 can help balance the forces from the pistons (e.g., each other), the crankshafts 112, and/or the connecting rods 116. In another example, the internal combustion engine 100B may allow for higher offset of piston centerlines to crankshaft centers, thus giving higher stroke lengths for each piston, and giving higher total stroke volumes when all piston strokes are combined compared to other internal combustion engine designs, such as the internal combustion engine 100A, which can provide significant benefits in terms of power, vibration reduction, torque, performance, and/or durability. As such, the internal combustion engine 100B may be ideal for high-performance and heavy-duty applications.

Another advantage, other than using the two added pistons 150B1, 150B2 for benefits in terms of power, torque, performance, and/or durability, is that the two separate added cylinders 146B1, 146B2 can be used for separate purposes. In one configuration, one added cylinder 146B1, 146B2 can be used as a compression cylinder (e.g., in a split cycle) where part of the compression is completed in one added cylinder 146B1, 146B2 and the rest of the compression is completed in the combustion chamber 104. In such a configuration, the other added cylinder 146B1, 146B2 could be used as an expansion chamber (e.g., post expansion or added expansion). For example, the exhaust gas may be directed to one of the added cylinders 146B1, 146B2 to finish its expansion. In these cases of using different added pistons 150B1, 150B2 for different functions, the added cylinders 146B1, 146B2 may have different stroke volumes, or may have differing effective stroke values due to the timing of the valve openings and closings of the valves for these added cylinders 146B1, 146B2. This differing of stroke volumes and/or effective stroke volumes, along with using the different added pistons 150B1, 150B2 for different functions, can allow for different and variable overall compression verses overall expansion, which can be used to improve overall efficiency, reduce emissions, and/or reduce waste heat in the internal combustion engine 100B.

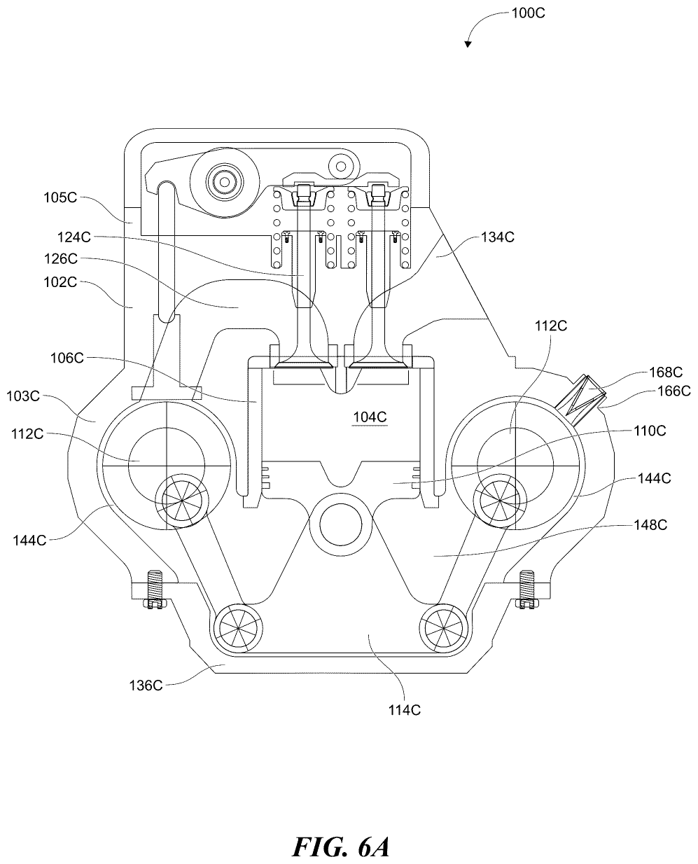

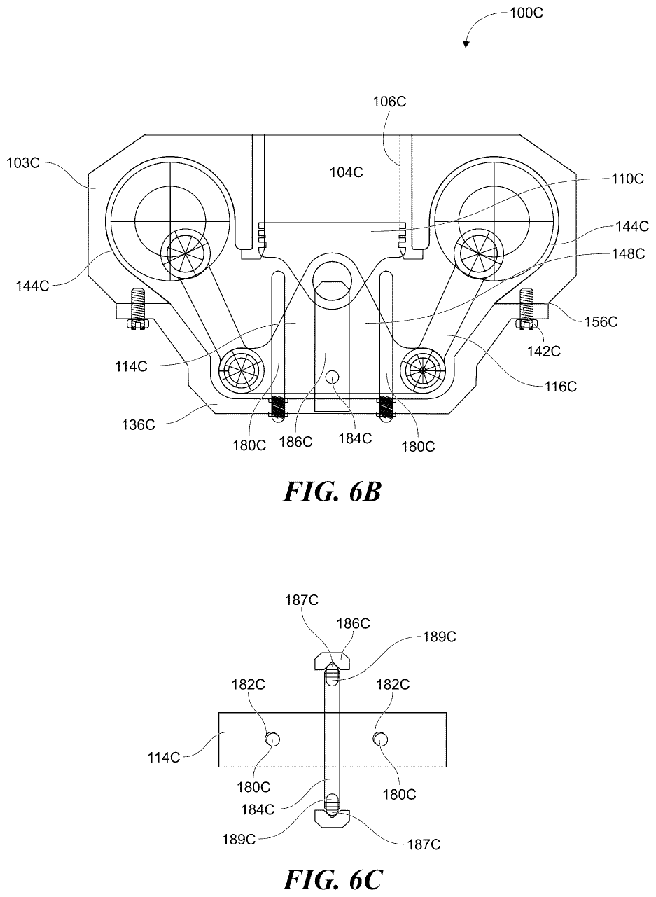

FIG. 6A illustrates a configuration of an internal combustion engine 100C. The internal combustion engine 100C differs from the internal combustion engine 100 of FIGS. 1A-2 in that the internal combustion engine 100C does not include an added piston 150. However, the components of the internal combustion engine 100C can still be configured to generate intake air through the crank portion 103C for the combustion chamber 104C (e.g., to act as a scavenging pump), in some configurations.

The additional housing 136C may be shaped to at least partially define the central recess 148C along with the crank portion 103C of the uniblock 102C. The additional housing 136C may not include added cylinder(s) because there is/are no added piston(s) in the internal combustion engine 100C. Instead, the additional housing 136C can be sized to accommodate or receive the crosshead 114C during the power stroke of the piston 110C.

Like the internal combustion engine 100, the two crankshafts 112C of the internal combustion engine 100C can be disposed on either side of the piston 110C (e.g., the piston 110C can be positioned between the two crankshafts 112C during at least a portion of its reciprocating path). The center axes (i.e., the axes of rotation) of the crankshafts 112C can be disposed below the top of the cylinder bore 106C and/or the piston 110C when the piston 110C is in top dead center. The center axes of the crankshafts 112C can be disposed above the lower end of the cylinder bore 106C and/or the piston 110C when the piston is in bottom dead center.

In some configurations, the crank portion 103C can include an intake port 166C that extends through the crank portion 103C and into one of the crankshaft containing passages 144C (e.g., the crankshaft containing passage 144C below the exhaust passage 134C). Air from outside the internal combustion engine 100C can enter the central recess 148C via the intake port 166C. The intake port 166C can include a one-way valve 168C that allows fluid to flow in one direction through the crank portion 103C and to the combustion chamber 104C via the intake passage 126C, while preventing back flow. In the illustrated configuration, the one-way valve 168C is a reed valve. In other configurations, different check valves can be used, such as a ball check valve, for example.

In the illustrated configuration, the additional housing 136C does not include intake ports (e.g., such as intake ports 142 of the internal combustion engine 100) and all or a majority of the air enters the crank portion 103C via the one-way valve 168C. In other configurations, the additional housing 136C may include intake ports to promote additional airflow into the crank portion 103C. Because the internal combustion engine 100C does not include an added piston, the piston 110C is used to cause air to enter the crank portion 103C via the intake port 166C. As the piston 110C moves from the bottom dead center position of FIG. 6A to a top dead center position, the upward movement of the piston 110 creates a vacuum in the central recess 148C of the crank portion 103C that opens the one-way valve 168C, drawing air into the crank portion 103C. When the intake valve 124C opens, the air in the central recess 148C travels through the crankshaft containing passage 144C connected to the intake passage 126C, through the intake passage 126C, and into the combustion chamber 104C.

In some configurations, the central recess 148C may not be connected to the intake passage 126C. As such, the internal combustion engine 100C may not include the intake port 166C. In such a configuration, the intake passage 126C may extend through one or both of the crank portion 103C or the valve portion 105C to allow air to enter the combustion chamber 104C from an external environment.

As noted, the internal combustion engine 100C does not include an added piston. In such a configuration, the internal combustion engine 100C can optionally include one or more additional components configured to assist with stabilizing the crosshead 114 during the reciprocating motion of the piston 110.

FIG. 6B illustrates a side view of a configuration of the internal combustion engine 100C with many of the components not shown for illustrative purposes. The internal combustion engine 100C can include one or more stabilizing components. The stabilizing components can be configured to interact or engage a portion of the crosshead 114C to restrict the movement of the crosshead 114C to be substantially linear. For example, the one or more stabilizing components can restrict the movement of the crosshead 114C to be substantially aligned with the directions of travel of the piston 110C.

In the illustrated configuration of FIG. 6B, the stabilizing components comprise stabilizing rods 180C. The stabilizing rods 180C may be referred to herein as “stabilizing members.” In the illustrated configuration, the internal combustion engine 100C includes two stabilizing rods 180C. The stabilizing rods 180C can be coupled to the additional housing 136C and can extend upwards into the central recess 148C towards the cylinder bore 106C.

As shown in FIG. 6C, which illustrates a top isolation view of an embodiment of the crosshead 114C, the crosshead 114C can include one or more channels 182C. The channels 182C can extend through the crosshead 114C. The channels 182C can be circular, square, rectangular, oval, oblong, or otherwise shaped, and can be configured to receive stabilizing parts, which can be circular, square, rectangular, oval, oblong, or otherwise shaped. In the illustrated configuration, the channels 182C are configured to receive two stabilizing rods 180C, as shown in FIG. 6B.

While the illustrated configuration of the crosshead 114C includes two channels 182C for receiving two stabilizing rods 180C, in other configurations, the crosshead 114C can include more than two or less than two channels 182C for receiving a same number of stabilizing rods 180C. Further, the stabilizing rods may not be “rods” and may may have any cross-section shapes, including circular cross-sectional shapes as shown in FIG. 6C, or other shapes including square, rectangular, and any other shape. In some configurations, other stabilizing components can be used to constrain the movement of the crosshead 114C. As the crosshead 114C reciprocates, the stabilizing rods 180C can be maintained within the channels 182C to maintain alignment of the crosshead 114C. The stabilizing rods 180C can have a sliding fit with the channels 182C. In some configurations, the channels 182C may include a low-friction material or coating to reduce wear and promote smooth reciprocation of the crosshead 114C.

In addition to or alternatively to the stabilizing rods 180C, the internal combustion engine 100C may optionally include a stabilizing pin 184C and one or more guideposts 186C. While the guideposts 186C are shown as separate from the additional housing 136C, in other configurations, internal combustion engine 100C may not include the guideposts 186C and the stabilizing pin 184C may engage one or more guide grooves or slots in the additional housing 136C. Additionally, in some configurations, more than one stabilizing pin 184C may be utilized.

The one or more stabilizing parts, such as the stabilizing pin 184C, may extend through the crosshead 114C in a direction substantially orthogonal to the axis of the cylinder bore 106C. The stabilizing pin 184C can be fixed relative to the crosshead 114C. In the illustrated configuration, the guideposts 186C can be coupled to or part of the additional housing 136C and can extend upwards into the central recess 148C towards the cylinder bore 106C. The stabilizing pin 184C and/or other stabilizing parts can extend between the guideposts 186C and may be restrained between the guideposts 186C as the crosshead 114C reciprocates within the central recess 148C. For example, the guideposts 186C may include grooves or recesses for receiving the stabilizing pin 184C and guiding the travel of the stabilizing pin 184C. In some configurations, the guideposts 186C may include bushings, bearings, and/or the like to facilitate low-friction translation of the stabilizing pin 184C relative to the guideposts 186C. In some configurations, the stabilizing pin(s) 184C, or other stabilizing parts, may include rollers of various profiles at the ends of the stabilizing pin(s) 184C. The rollers can ride in grooves in the guideposts 186C, the additional housing 136C, and/or in separate parts fixed to the additional housing 136C, depending on the configuration. Such grooves can be V-shaped in some configurations.

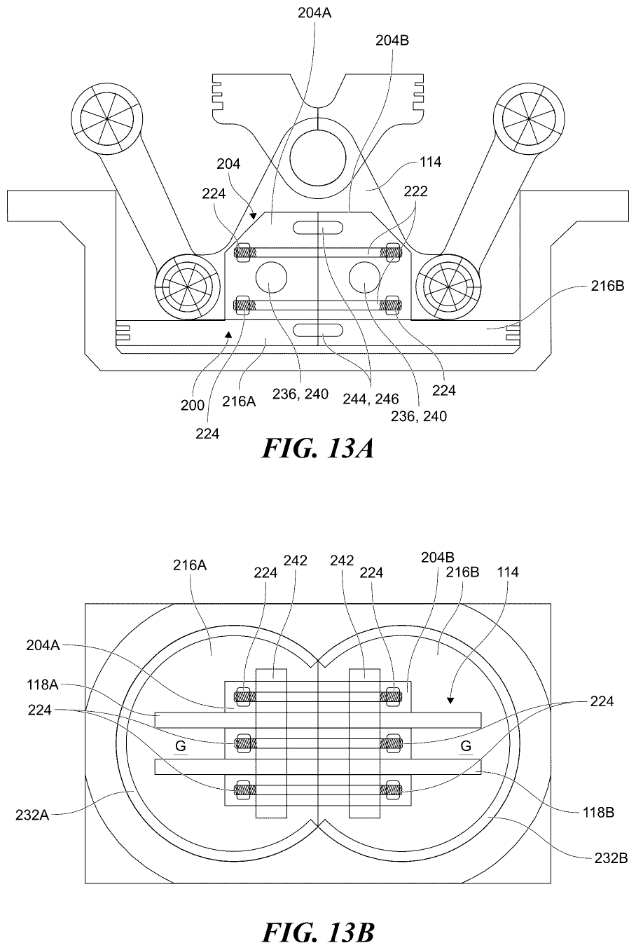

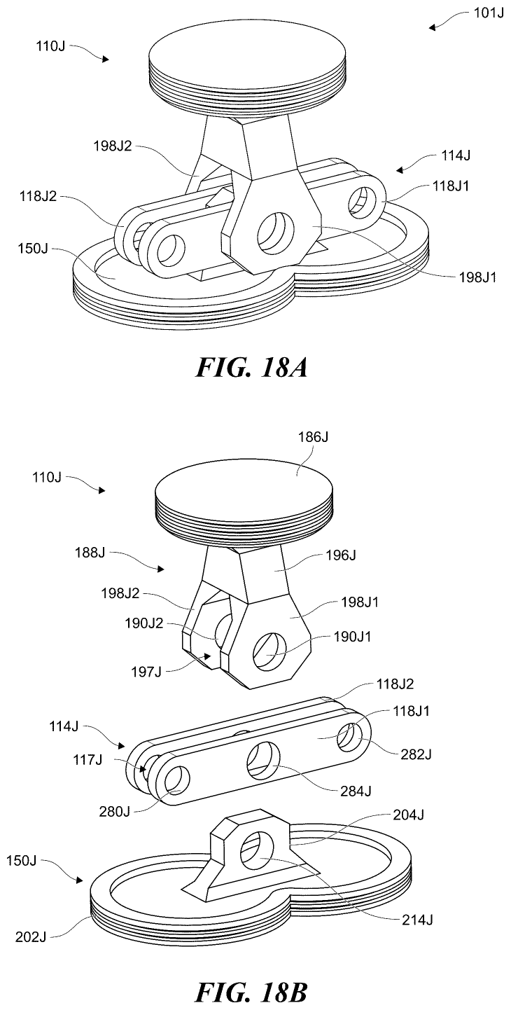

In some configurations, the crosshead 114C can be formed of two or more plates (see e.g., the first plate portion 118A and the second plate portion 118B of FIGS. 13A and 13B, the crosshead 114H of FIGS. 14A and 14B, and/or the 114J of FIGS. 18A and 18B). In such a configuration, there may be a gap between the two plates of the crosshead 114C and a stabilizing component may be configured to extend between the gap during the reciprocating motion of the crosshead 114C. For example, a stabilizing plate or block may extend from, be coupled, or formed from the additional housing 136C and may extend between the gap of the two plated crosshead 114C.

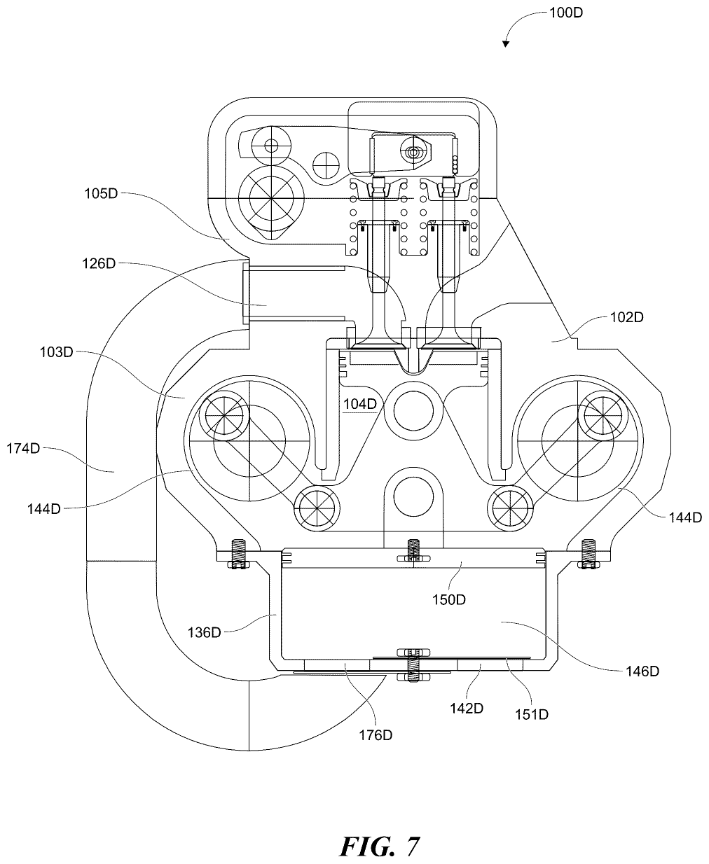

FIG. 7 illustrates a configuration of an internal combustion engine 100D. The internal combustion engine 100D differs from the internal combustion engine 100 of FIGS. 1A-2 in that the intake air does not flow through the crank portion 103D. Instead, intake air flows from the added cylinder 146D to the intake passage 126D via an inlet feed pipe 174D.

Because the internal combustion engine 100D is not configured to direct inlet air through the crank portion 103D, the crankshaft containing passage 144D on the intake side is not connected to the intake passage 126D. Instead, the intake passage 126D is positioned in an upper portion of the uniblock 102D (e.g., the valve portion 105D). The intake passage 126D can extend though a side surface in the valve portion 105D and may be directly adjacent to the top surface of the uniblock 102D. Such a configuration can provide as vertical of an entry into the combustion chamber 104D as possible. Similarly, the crankshaft containing passage 144D on the exhaust side does not include an intake port. Additionally, the added piston 150D does not include any ports (e.g., the ports 160 of the added piston 150 of FIGS. 1A-2).

In the internal combustion engine 100D, air can enter the added cylinder 146D via one or more intake ports 142D in the additional housing 136D. The additional housing 136D can also include at least one outlet port 176D. The outlet port 176D can include a one-way valve (e.g., a reed valve, a poppet valve, a rotary valve, a one-way ball valve, and/or the like) that allows fluid to flow in one direction out of the added cylinder 146D, while preventing back flow.

As the added piston 150D moves from the bottom dead center position to the top dead center position, the upward movement of the added piston 150D creates a vacuum in the added cylinder 146D that opens the one-way valve in the intake port 142D, drawing air into the added cylinder 146D. As the added piston 150D moves from the top dead center position to the bottom dead center position, the downward movement of the added piston 150D compresses the fluid in the added cylinder 146D, which opens the one-way valve in the outlet port 176D, pushing air out of the added cylinder 146D. The inlet feed pipe 174D can be connected at one end to the outlet port 176D and at an opposite end to the intake passage 126D to direct air from the added cylinder 146D to the combustion chamber 104D.

The internal combustion engine 100D with the inlet feed pipe 174D can provide certain advantages over the internal combustion engine 100 of FIGS. 1A-2. For example, because the internal combustion engine 100D does not direct intake air through the crank portion 103D, the internal combustion engine 100D can include wet sump (not shown) in the crank portion 103D. Including a wet sump can provide certain advantages over other lubricating systems (e.g., a dry sump), such as eliminating a need for roller bearings, reducing the level of soot in the engine, etc. Further, a wet sump can provide simpler more cost-effective lubrication for the internal combustion engine 100D in some applications.

FIG. 8 illustrates a configuration of an internal combustion engine 100E. As shown in FIG. 8, two or more uniblocks can be paired in various configurations for the internal combustion engine 100E using the uniblocks 102E. The multiple uniblocks 102E can be positioned side-by-side and/or end-to-end. The modular nature afforded by the uniblock design facilitates engines of a multitude of constructions.

In the configuration illustrated in FIG. 8, the multiple uniblocks 102E can be joined together by an additional housing 136E. As such, the additional housing 136E may be described as an “internal housing”. The additional housing 136E can be used to mount uniblocks side-by-side and/or end-to-end. The additional housing 136E differs from the additional housing 136 of the internal combustion engine 100 of FIGS. 1A-2 in that intake ports 142E are positioned in the side walls of the 136E instead of the bottom of the additional housing 136. Such a configuration allows the multiple uniblocks 102E to be joined end-to-end as shown in FIG. 8. Additionally, such a configuration can allow for improved airflow into the crank portion 103E. In some configurations, the additional housing 136E can include an internal wall to separate the upper added cylinder 146E from the lower upper added cylinder 146E. In other configurations, the upper engine portion can share an upper added cylinder 146E with the lower engine portion.

In some configurations, multiple uniblocks (e.g., the uniblock 102 of the internal combustion engine 100 of FIGS. 1A-2) can be paired in opposed balanced constructions, opposed compact constructions, and/or opposed captive free piston constructions. In some configurations, such as in an inline construction, for example, the uniblock 102 may not be paired with another. The opposed balanced constructions can have the advantage of balancing all piston related forces including primary, secondary, and rocking forces in both two and four-stroke constructions, and can have the advantage of balancing all forces including all piston and valve and valvetrain related forces in two-stroke constructions.

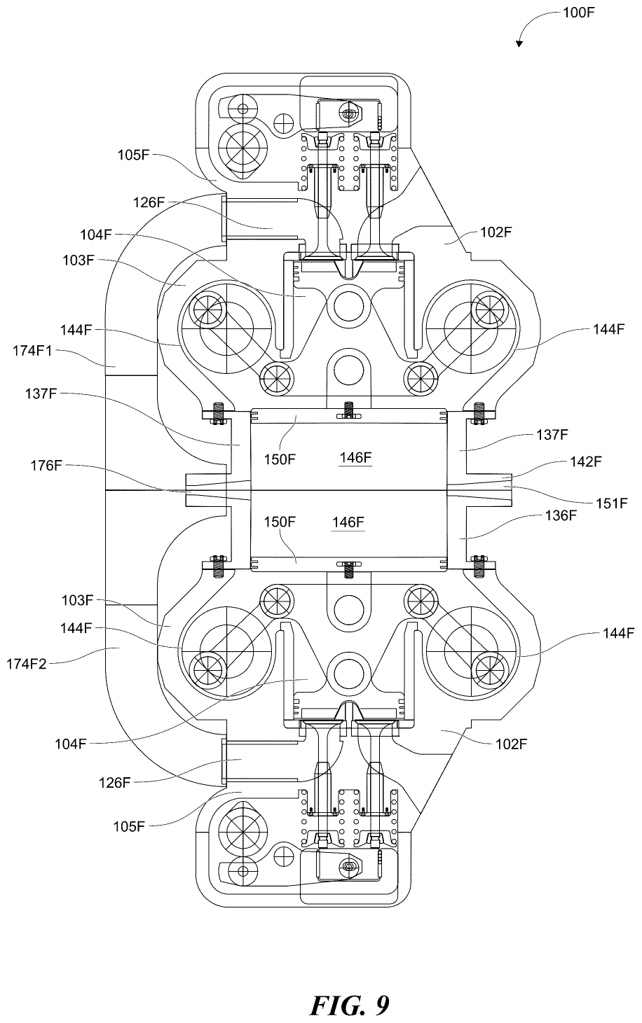

FIG. 9 illustrates a configuration of an internal combustion engine 100F. The internal combustion engine 100F is similar to the internal combustion engine 100E in that multiple uniblocks 102F are joined together by an additional housing 136F. As such, the additional housing 136F can include one or more intake ports 146F in a side wall of the additional housing 136F. Additionally, the internal combustion engine 100F is similar to the internal combustion engine 100D in that the intake air does not flow through the crank portions 103F. Instead, intake air can flow from the added cylinders 146F to the intake passages 126F via a first inlet feed pipe 174F1 and a second inlet feed pipe 174F2.

Like the internal combustion engine 100D, the internal combustion engine 100F is not configured to direct inlet air through the crank portions 103E. As such, the crankshaft containing passages 144F on the intake side are not connected to the intake passages 126F. Instead, the intake passages 126F are positioned in the upper portions of the uniblocks 102F (e.g., the valve portions 105F). The intake passage 126F can extend though side surfaces in the valve portions 105F and may be directly adjacent to the top surfaces of the uniblocks 102F. Such a configuration can provide as vertical of an entry into the combustion chambers 104F as possible. Similarly, the crankshaft containing passages 144F on the exhaust side does not include an intake port. Additionally, the added pistons 150F do not include any ports (e.g., the ports 160 of the added piston 150 of FIGS. 1A-2).

In the internal combustion engine 100F, air can enter the added cylinders 146F via the one or more intake ports 142F in the additional housing 136F. The additional housing 136F can also include at least one outlet port 176F. The outlet port 176F can include one or more valves to limit gas flows out of the added cylinders 146F. The one or more valves of the outlet port 176F may include poppet valves, rotary valves, or any other one-way valves. When the added cylinders 146F are used for compression or scavenging, the one or more valves of the outlet port 176F may include one-way valves also known as check-valves. Any suitable check valves may be utilized in the outlet port 176F such as reed valves, one-way ball valves, and other check valves that allow fluid to flow in one direction out of the added cylinders 146F, while preventing back flow.

As the added piston(s) 150F move away from the top of the additional housing 136F, or in opposed piston designs, away from the other added piston(s) 150F, such movement creates decreased pressure in the added cylinders 146F. The decreased pressure causes the opening of the one-way valve between the intake port(s) 142F and the added cylinder(s) 146F, drawing air into the added cylinder(s) 146F. As the added piston(s) 150F moves towards the head region of the additional housing 136F, or in opposed piston designs, towards the other added piston(s), the added piston(s) 150F movement compresses the fluid in the added cylinder(s) 146F. When the pressure in the added cylinder(s) 146F exceeds the pressure outside the added cylinder(s) 146F, the out-flowing one-way valve in the outlet port 176F opens, and the compressed (and now higher pressure) fluid/gas moves through the one-way valve(s) into the outlet port 176F, with further piston movement pushing air out of the added cylinders 146F. The inlet feed pipes 174F1, 174F2 can be connected at one end to the outlet port 176F and at an opposite end to the intake passages 126F to direct air from the added cylinders 146F to the combustion chambers 104F.

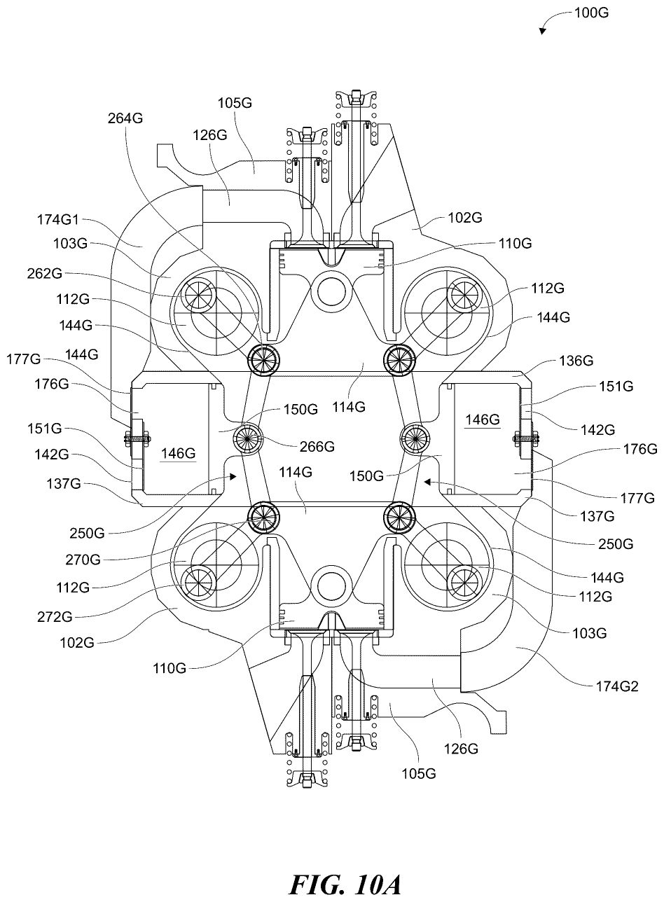

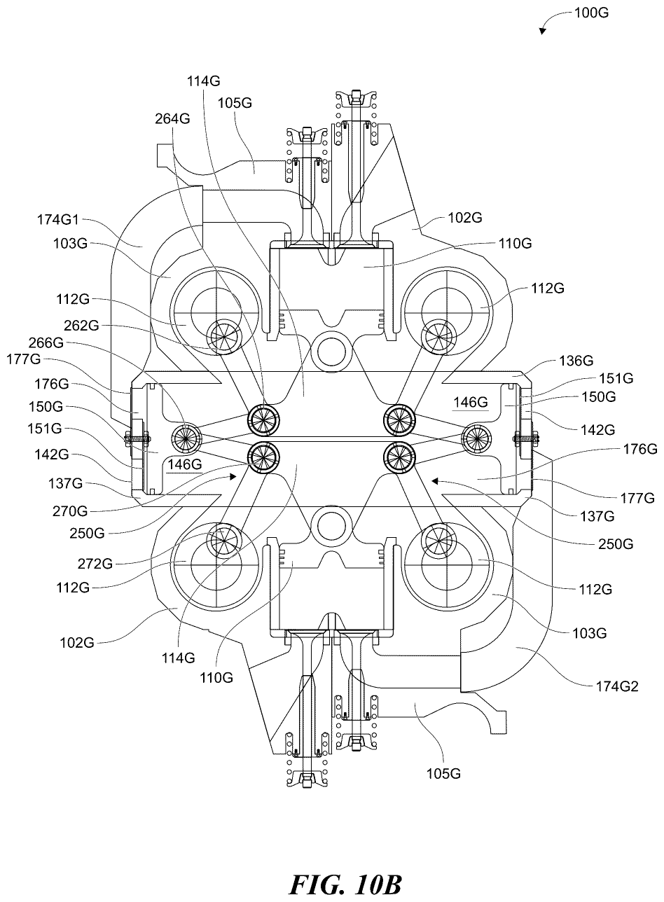

FIGS. 10A and 10B illustrate a configuration of an internal combustion engine 100G. The internal combustion engine 100G includes two uniblocks 102G paired in an end-to end configuration. FIG. 10A shows the internal combustion engine 100G with the pistons 110G in the top dead center position and FIG. 10B shows the internal combustion engine 100G with the pistons 110G in the bottom dead center position. In the configuration illustrated in FIGS. 10A and 10B, the multiple uniblocks 102G are joined together by an additional housing 136G.

The internal combustion engine 100G differs from the internal combustion engine 100 of FIGS. 1A-2 in that the added pistons 150G are configured to travel along an axis that is neither aligned with nor parallel to the axis of travel of the primary pistons 110G. In the illustrated configurations, the axis of travel of the added pistons 150G is approximately 90-degrees offset relative to the axis of travel of the primary pistons 110G. In other configurations, different degrees of offset between the two axes are possible. For example, the axis of travel of the added piston(s) 150G can be between 0-degrees and 180-degrees offset from the axis of travel of the primary piston(s) 110G. Such configurations can provide a benefit of reducing the overall size of the internal combustion engine 100G as the upper two uniblocks 102G can be positioned closer to the lower two uniblocks 102G.

The additional housing 136G differs from the additional housing 136 of the internal combustion engine 100 of FIGS. 1A-2 in that the additional housing 136G defines two added cylinders 146G. The added cylinders 146G are positioned in the side walls of the additional housing 136G instead of the bottom of the additional housing 136 as in FIG. 1A. Similarly, the intake ports 142G and the outlet port 176G are positioned in the side walls of the additional housing 136G. Such a configuration allows the multiple uniblocks 102G to be joined end-to-end as shown in FIGS. 10A and 10B. Additionally, such a configuration can allow for improved airflow into the crank portions 103G.

Like the internal combustion engine 100F, the internal combustion engine 100G is not configured to direct inlet air through the crank portions 103G. As such, the crankshaft containing passages 144G on the intake sides are not connected to the intake passages 126G. Instead, the intake passages 126G are positioned in the upper portions of the uniblocks 102G (e.g., the valve portions 105G). The intake passages 126G can extend though the valve portions 105G of the uniblocks 102G. Similarly, the crankshaft containing passages 144G on the exhaust side does not include an intake port. Additionally, the added pistons 150G do not include any ports (e.g., the ports 160 of the added piston 150 of FIGS. 1A-2).

In the internal combustion engine 100G, air can enter the added cylinders 146G via the one or more intake ports 142G in the additional housing 136G. The additional housing 136G can also include one or more outlet ports 176G. In the illustrated configuration, the additional housing 136G includes at least two outlet ports 176G. The outlet ports 176G can include one-way valves (e.g., reed valves) that allows fluid to flow in one direction out of the added cylinders 146G, while preventing back flow.

As the added pistons 150G move from the bottom dead center position of FIG. 10B to the top dead center position of FIG. 10A, the movement of the added pistons 150G towards each other creates a vacuum in the added cylinders 146G that opens the one-way valves in the intake ports 142G, drawing air into the added cylinders 146G. As the added pistons 150G moves from the top dead center position to the bottom dead center position, the movement of the added pistons 150G away from each other compresses the fluid in the added cylinders 146G, which opens the one-way valve in the outlet ports 176G, pushing air out of the added cylinders 146G. The inlet feed pipes 174G1, 174G2 can be connected at one end to at least one of the outlet ports 176G and at an opposite end to at least one of the intake passages 126G to direct air from the added cylinders 146G to the combustion chambers 104G.

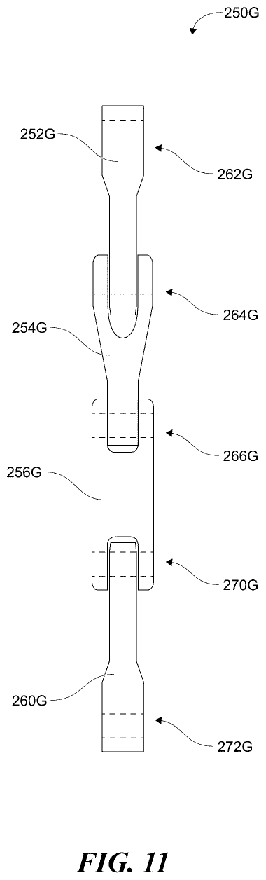

The internal combustion engine 100G also differs from the internal combustion engine 100 of FIGS. 1A-2 in that the internal combustion engine 100G can include one or more connecting rod assemblies/multi-legged connecting rods 250G. In the illustrated configuration, the internal combustion engine 100G includes two multi-legged connecting rods 250G. A side view of a single multi-legged connecting rod 250G is shown in isolation in FIG. 11. In other configurations, other types of connecting rods can be utilized in the internal combustion engine 100G.

As shown in FIG. 10A, each connecting rod 250G can connect an upper and lower crankshaft 112G to both crossheads 114G and to one added piston 150G. For example, the added piston 150G on the left side of FIG. 10A is connected to the upper and lower crankshafts 112G on the left side. Similarly, he added piston 150G on the right side of FIG. 10A is connected to the upper and lower crankshafts 112G on the right side. Each connecting rod 250G can include a first leg 252G, a second leg 254G, a third leg 256G, and a fourth leg 260G. The legs of the connecting rod 250G can be configured to rotate relative to each other. For example, one or more pins (e.g., wrist pins, crank pins, gudgeon pins, and/or the like) or other rotational connectors can be used to connect the legs of the connecting rod 250G to each other. Such pins can also be used to facilitate a rotational connection between the legs of the connecting rod 250G and the other components of the internal combustion engine 100G.

In the illustrated configuration, each first leg 252G is rotationally coupled via a first pin 262G to an upper crankshaft 112G. For example, the first pin 262G can be a crank pin. The first pin 262G can be integral to the crankshaft 112G and configured to rotate with the crankshaft 112G. Each first leg 252G can be connected on an opposite end to the upper crosshead 114G via a second pin 264G. For example, the second pin 264G can be a gudgeon pin. In some configurations, the second pin 264G can be integral with the upper crosshead 114G. In some configurations, the second pin 264G can be rotatably coupled to the upper crosshead 114G. Such connection(s) can allow the reciprocating motion of the piston 100G to be converted into rotational motion, causing the upper crankshafts 112G to spin.

Each second leg 254G can be rotationally connected to the associated first leg 252G by the second pin 264G. For example, an upper end of the second leg 254G can be forked or configured as a clevis that receives a lower end of the first leg 252G, with the second pin 264G extending between both the first leg 252G and the second leg 254G. The second pin 264G can be a wrist pin. Such a connection allows the second leg 254G to rotate relative to the first leg 252G.

Each second leg 254G can be rotationally connected at a lower end to the associated third leg 256G by a third pin 266G. For example, an upper end of the third leg 256G can be forked or configured as a clevis that receives a lower end of the second leg 254G. The third pin 266G can be a wrist pin. Such a connection allows the third leg 256G to rotate relative to the second leg 254G.

The third pin 266G can facilitate a connection between the second leg 254G and the third leg 256G of the connecting rod 250G and the associated added piston 150G. For example, each added piston 150G can be coupled to the associated second leg 254G and third leg 256G via the third pin 266G. In some configurations, the third pin 266G can be a gudgeon pin. In some configurations, the third pin 266G can be integral with the added pistons 150G. Such a connection can allow for a transfer of linear motion from the upper piston 110G to the added pistons 150G, with the added pistons 150G reciprocating at an angle (e.g., 90-degrees) relative to the upper piston 110G.

Each third leg 256G can be rotationally connected to the associated fourth leg 260G by a fourth pin 270G. For example, a lower end of the third leg 256G can be forked or configured as a clevis that receives an upper end of the fourth leg 260G, with the fourth pin 270G extending between both the third leg 256G and the fourth leg 260G. As such, the third leg 256G can be double-forked or can have a clevis on both ends. Such a connection allows the fourth leg 260G to rotate relative to the third leg 256G. The fourth pin 270G can facilitate a connection between each fourth leg 260G and third leg 256G and the associated lower crosshead 114G. For example, each lower crosshead 114G can be coupled to the associated third leg 256G and fourth leg 260G via the fourth pin 270G. In some configurations, the fourth pin 270G can be a gudgeon pin. In some configurations, the fourth pin 270G can be integral with the associated lower crosshead 114G. In some configurations, the fourth pin 270G can be rotatably coupled to the lower crosshead 114G. Such a connection can allow for a transfer of linear motion from the lower piston 110G to the added pistons 150G, with the added pistons 150G reciprocating at an angle (e.g., 90-degrees) relative to the lower piston 110G

Each fourth leg 260G can be rotationally coupled at a lower end to a lower crankshaft 112G via a fifth pin 272G. For example, the fifth pin 272G can be a crank pin. The fifth pin 272G can be integral to the associated lower crankshaft 112G and configured to rotate with the crankshaft 112G. As the fourth leg 260G is connected at its upper end to the lower crosshead 114G, such a connection can allow the reciprocating motion of the lower piston 100G to be converted into rotational motion, causing the lower crankshaft 112G to spin.

The multi-legged connecting rod 250G, which includes at least two legs, can include one or more conventional connecting rods (e.g., having no forked ends), one or more fork and blade connecting rods, and/or one or more dual-forked connecting rods (e.g., being forked at both ends). In the illustrated configuration, the first leg 252G and the fourth leg 260G are configured as conventional connecting rods, the second leg 254G is configured as a fork and blade connecting rod, and the third leg 256G is configured as a dual-forked connecting rod. In other configurations, different combinations of legs with different configurations are possible for the multi-legged connecting rod 250G.

Multi-legged connecting rods 250G can provide certain advantages. For example, the multi-legged connecting rods 250G can provide improved balance due to the self-orientation effects seen in an assembly of rods, much like how a chain will distribute forces across different parts. The multi-legged connecting rods 250G can employ simple and casily reapable connecting rod shapes, which may be easier to manufacture. In another example, using multi-legged connecting rods 250G can provide the ability to make changes in one or more of the connecting rod parts that may alter selected piston strokes, that may in turn give advantages related to balance, power, or efficiency. Because a small change in one or more part(s) can provide significant changes, a multi-legged connecting rod assembly can be desirable to allow for more variations in engines with a small change in one or more parts giving efficiencies in parts production, engine variations, and engine testing.

### Piston and Piston Assemblies

FIGS. 12A and 12B illustrates a cross-section view and a top view of an example piston. The example piston may be used as a primary or added/secondary piston in any engine. The example piston may be a primary piston (e.g., configured to reciprocate in a combustion chamber) or a secondary piston in any of the internal combustion engines described herein. Additionally, the example piston in FIGS. 12A and 12B may be used as an added piston 150 according to some configurations. While the following description references the added piston 150, a similar or identical design can be used for the piston 110 in the internal combustion engine 100. Therefore, the following description is understood to apply to configurations for the piston 110.

The various parts of the added piston 150 can be 3D printed, cast, forged, and/or machined. In some configurations, different parts of the added piston 150 can be formed of different materials to achieve certain thermal and/or mechanical advantages. Generally, the added piston 150 is made from a rigid material.

As shown in FIG. 12A, the added piston 150 can include a piston body 200. The piston body 200 can comprise a lower portion 202 and an upper portion 204. In other configurations, the piston body 200 may only include the lower portion 202.

In the illustrated configuration, the lower portion 202 comprises an outer wall 206. The lower portion 202 can also include a piston top plate 210. In the illustrated configuration, the piston top plate 210 is shown as flat. In other configurations, the outer wall 206 of the lower portion 202 can comprise a recess. For example, the recess could be in the shape of a frustoconical region, a cylindrical region, and/or the like.

When included, the upper portion 204 can comprise an outer wall 212 that at least partially encircles or surrounds an upper recess 214. The outer wall 212 of the upper portion 204 can be generally cylindrical in certain configurations. The upper portion 204 is not shown in FIG. 12B for illustrative purposes.

As shown in FIG. 12B, the outer wall 206 of the lower portion 202 defines a perimeter of the lower portion 202 that is double-c shaped. As such, the added piston 150 can be configured for use with the added cylinder 146 shown in FIG. 3C. For example, the outer wall 206 can have the shape of the perimeter of two overlapping circles when viewed from above. In some configurations, the lower portion 202 may be machined or otherwise manufactured to have this shape. For example, the lower portion 202 can be manufactured using additive manufacturing or subtractive manufacturing to have the double-c shape.

In some configurations, the lower portion 202 may be constructed from a first piston portion 216A and a second portion 216B joined together. For example, the first piston portion 216A and the piston second portion 216B can be cylinders with approximately identical diameters that are cut along a common chord (e.g., an equal distance from the center of each cylinder), leaving a substantial portion (e.g., greater than 50%) of the circumferences intact. The resulting flat side 220A of the first piston portion 216A can then be joined to the flat side 220B of the second piston portion 216B to form the double-c shaped lower portion 202 of the added piston 150.

In the illustrated configuration of FIGS. 12A and 12B, the first piston portion 216A is coupled to the second portion 216B using two double-ended studs 222 (e.g., stud bolts) with nuts 224 on both sides of the double-ended studs 222. However, other conventional joining methods can be used to couple the first piston portion 216A to the second portion 216B.

The flat sides 220A, 220B of the piston portions 216A, 216B can be cut along a chord line anywhere between the center of the circles and the perimeters. For example, each piston portion 216A, 216B can be cut from a cylinder such that between 50% and 100% of the volume remains. In some configurations, it may be preferable that the remaining volume is between 60% and 90%. In some configurations, it may be preferable that the remaining volume is between 65% and 85%.

In some configurations, the first piston portion 216A can be joined or coupled to the second portion 216B via the flat sides 220A, 220B using one or more fasteners, such as studs, nuts, screws, bolts, and/or the like. In some configurations, the first piston portion 216A can be joined to the second portion 216B via the flat sides 220A, 220B using welding, brazing, and/or soldering (e.g., using heat, sound, vibration, friction, etc.). In some configurations, the first piston portion 216A can be joined to the second portion 216B via the flat sides 220A, 220B using an adhesive, such as epoxy, glue, other bonding materials, and/or the like. When joining the first piston portion 216A to the second portion 216B, various alignment tools, such as alignment pins or dowels can be used to facilitate the joining, as described herein.

Referring back to FIG. 12A, at a top end 226 of the outer wall 206 of the lower portion 202 of the added piston 150 are two generally cylindrical regions, formed by the first piston portion 216A and the second portion 216B in the illustrated configurations. Each cylindrical region can comprise one or more grooves 230 formed in the outer wall 206. One or more piston rings 232 can be positioned within the one or more groove 230. As shown in FIG. 12C, the piston rings 232 can be generally c-shaped. For example, the piston rings 232 can have the same shape as the cylindrical portions of the piston portions 216A, 216B and with the same or nearly the same missing porting or arc from the circle as the pistons have. The c-shaped piston rings 232 can be manufactured to have a c-shape or could be circular piston rings that are cut into the c-shape. As such, the piston rings 232 can be partial circle shaped/constant radii arc shaped.

In use, the piston rings 232 can be configured to slide along the wall of the added cylinder bore 158. The piston rings 232 can provide sealing of the added cylinder 146. While three grooves 230 are shown in FIG. 12A to receive three piston rings 232 per piston portion 216A, 216B, the number of grooves 230 and piston rings 232 can be determined based upon the application and construction of the internal combustion engine 100. For example, there can be as few as one or more than five piston rings 232 per piston portion 216A, 216B.

In a double-c shaped added piston 150, generally two c-shaped piston rings 232 are received within grooves 230 on the same plane. For example, a first piston ring 232A can be received within the groove 230 primarily defined in the first piston portion 216A and a second piston ring 232B can be received within the groove 230 primarily defined in the second piston portion 216B. The piston rings 232A, 232B can interact in different ways with each other, depending on the configuration. Each piston ring 232A, 232B of a pair of piston rings 232 may meet in two spots, with several ways of meeting possible. The piston rings 232 can be cut with varying angles relative to the radii of their circles or arcs, and with varying thicknesses of prescribed portions of ends of the arcs, and with varying meeting geometries. In some configurations, the tips of each piston ring 232 can touch the tips of the other piston ring 232. In some configurations, the tips of the two piston rings may be closed together or almost touching, but with prescribed gaps. In some configurations, short faces or facets can be made from the angles of the cut ends of the piston rings 232. In such a configuration, the ends of the piston rings 232 can either touch, be close together with a prescribed gap, or, when the thickness of the ends allow it, the tips of the two piston rings 232 may overlap for some small but prescribed portion of the arcs.

In some configurations, a piston top plate 210 is positioned on a downwardly facing surface of the piston body 200, in the orientation of FIG. 12A. The piston top plate 210 may be a portion of the lower portion 202 or may be a separate component affixed to the piston body 200 in any suitable manner. The piston top plate 210 can be optional. When the double-c piston body 200 is used for the primary piston 110, a piston top plate 210 may be desirable to reduce heat conduction from the combustion gases into the piston body 200. However, when the piston body 200 is used for the added piston 150, a piston top plate 210 may not be required and this portion may be referred to as the piston crown 210.

In some configurations, the upper portion 204 of the piston body 200 can be used to couple the piston body 200 directly or indirectly to the crosshead 114 or a piston rod. For example, the connecting rod 152 may be received within the upper recess 214 and one or more fasteners or pins (e.g., wrist pins) may extend through the outer wall 212 to couple to piston body 200 to the connecting rod 152. In some configurations, the added piston 150 can be configured to articulate relative to the crosshead 114. In such a configuration, the upper portion 204 may not be rotationally fixed to the connecting rod 152. In some configurations, the piston body 200 may not include the outer wall 212, or the outer wall 212 may be configured in another manner, such that the piston body 200 can be coupled to the crosshead 114 directly. In one example, the outer wall 212 may be configured to receive a wrist pin for coupling to the crosshead 114.

The lower portion 202 can optionally include a piston skirt 234, as shown in FIG. 12A. The piston skirt 234 is not required and the added piston 150 may not include a piston skirt 234, as shown at least in FIGS. 1A and 1B. When included, the piston skirt 234 extends upwardly from the bottom of the piston body 200, in the orientation of FIG. 12A. The piston skirt 234 can be in contact with or near the walls of the added cylinder bore 158 when installed in the internal combustion engine 100. The piston skirt 234 can help to prevent or limit motion of the added piston 150 in directions other than along the axis of the added cylinder 146. For example, the piston skirt 234 can limit lateral movement of the added piston 150 and/or limit rotation of the added piston 150. However, the piston body 200 may not include the piston skirt 234 because of several potential drawbacks. For example, contact between the piston skirt 234 and the cylinder wall can increase friction, thereby reducing efficiency. As another example, the piston skirt 234 can add weight to the piston, which can also decrease efficiency. According to at least some of the configurations described herein, the piston body 200 may not include a piston skirt, or may include a short piston skirt. Such configurations can be possible because of the engine designs described herein can ensure little or no side to side or rocking movements of the added piston 150.

As described above, in some configurations the added piston 150 can be fixed directly to the crosshead 114 without the use of the connecting rod 152 or other intermediate components. Such a configuration can provide a benefit of further reducing the overall size of the internal combustion engine 100. FIG. 13A shows a side section view of such a configuration with the most components of the internal combustion engine 100 not shown for illustrative purposes. FIG. 13B shows a top section view of the crosshead 114 and the added piston 150 over the additional housing 136. Other examples of direct connection between the added piston 150 and a crosshead are described with reference to at least FIGS. 19-21.

The added piston 150 shown in FIGS. 13A and 13B can include a different configuration for the upper portion 204 of the piston body 200 than the configuration shown in FIG. 12A. In the configuration of FIG. 13A, the upper portion 204 of the piston body 200 can comprise a first upper block 204A and a second upper block 204B. The first upper block 204A can extend upwardly from the first piston portion 216A. The first upper block 204A may extend from the center of the first piston portion 216A. The first upper block 204A can partially define the flat side 220A of the piston body 200. The second upper block 204B can be similarly configured relative to the second portion 216B.

The first piston portion 216A can be joined to the second portion 216B via any conventional methods. In the illustrated example, the first piston portion 216A is coupled to the second portion 216B using a plurality of double-ended studs 222 and nuts 224. The double-ended studs 222 can extend through the first upper block 204A and the second upper block 204B. In some configurations, the double-ended studs 222 may be recessed within the upper blocks 204A, 204B.

As shown in FIG. 13B, in some configurations, the crosshead 114 can comprise a first plate portion 118A and a second plate portion 118B. The two plate portions 118A, 118B can be substantially triangularly shaped. Each plate portion 118A, 118B can include one or more holes 236. The holes 236 of the first plate portion 118A can be aligned with the holes in the second plate portion 118B in the assembled crosshead 114. Each of the upper blocks 204A, 204B can include a hole 240 that extends horizontally through the upper blocks 204A, 204B. To couple the added piston 150 to the crosshead 114, holes 236 of plate portions 118A, 118B can be aligned with the holes 240 of the added piston 150 and pins 242 can be inserted through the holes 236 and the holes 240. In other configurations, other types of fasteners can be used. In some configurations, the added piston 150 and the crosshead 114 may include additional alignment holes for accurate alignment during assembly. For example, the crosshead 114 may include alignment holes 244 that extend through the plate portions 118A, 118B, and the added piston 150 can include alignment holes 246 that extend through the piston body 200. The alignment holes 244 can be aligned with the alignment holes 246 when joining the added piston 150 to the crosshead 114. However, the alignment holes 244, 246 are not required.

In configurations where the piston 110 has the double-c shape construction, the piston 110 can be coupled to or form part of the crosshead 114 in a similar manner as described with reference to the added piston 150. In some configurations, the double-c shaped piston 110 can be connected one, two, or more than two connecting rods. In some configurations, the double-c shaped piston 110 can be configured to articulate. In some configurations, the double-c shaped piston 110 can include a long-axis that is oriented 90-degrees relative to the longitudinal crank axis (e.g., an axis defined by a center line of one of the crankshafts 112). Such a configuration can be desirable when the internal combustion engine 100 is configured to minimize the crank length/crank radius. In some configurations, the double-c shaped piston 110 can include a long-axis that is oriented in the same direction as the crank axis. Such a configuration can be desirable when the internal combustion engine 100 is in a V configuration (e.g., a V-engine).

FIGS. 14A and 14B illustrate a perspective view and an exploded view respectively of a piston assembly 101H. The piston assembly 101H can be a subassembly of any internal combustion engine and can be included in any of the internal combustion engines described herein. The piston subassembly 101H can include a piston 110H, a crosshead 114H, and/or an added piston 150H. When incorporated into the internal combustion engine 100, for example, the piston 110H can be used as the piston 110, the crosshead 114H can be used as the crosshead 114, and/or the added piston 150H can be used as the added piston 150.

In some configurations, the piston 110H can be used as the added piston 150 and the piston 150H can be used as the primary piston 110. For example, either piston 110H, 150H, can be configured as a primary piston or an added piston. In some configurations, an internal combustion engine can include both a primary piston and an added piston configured as the piston 150H and/or a primary piston and an added piston configured as the piston 110H.

In the piston subassembly 101H, the piston 110H can be coupled to the crosshead 114H at a first end (e.g., a top end) and the added piston 150H can be coupled to the crosshead 114H at a second end (e.g., a bottom end). Accordingly, the piston 110H can be positioned on an opposite side of the crosshead 114H than the added piston 150H.

Having both pistons 110H, 150H separate but connected to the crosshead 114 can provide an advantage of allowing each piston 110H, 150H to pivot with respect to the crosshead 114H. Having separate pistons 110H, 150H and crosshead 115H can also provide an advantage of easier manufacturing because each part can be made separately. Additionally, because the components can be manufactured separately, different materials with different properties can be used for each part. Accordingly, separate but connected pistons 110H, 150H, and crosshead 114 can provide the highest degrees of freedom of movement of each part as the can pivot with respect to each other.

The various components of the piston subassembly 101H can be used together or can be used separately. FIG. 15A shows an isolation side view of the components of the crosshead 114H, FIG. 15B shows an isolation side view of the piston 110H, and FIGS. 15C-15E show an isolation perspective view, a side view, and a top view respectively of the added piston 150H.

Referring first to FIG. 15A, the crosshead 114H can include a first plate portion 118H1 and a second plate portion 118H2. The two plate portions 118H1, 118H2 are shown side by side in FIG. 15A for illustrative purposes. As shown in FIGS. 14A and 14B, in use, the two plate portions 118H1, 118H2 are aligned with each other and can be used to connect the piston 110H to the added piston 150H.

The crosshead 114H can be configured as a floating crosshead. For example, the crosshead 114H can be configured to accommodate minor misalignments or thermal expansion and may not be constrained by a guide structure. In some configurations, the crosshead 114H can be configured to interact with guides or stabilizing components, such as those described herein (see e.g., at least FIGS. 6B and 6C).

The plate portions 118H1, 118H2 of the crosshead 114H can be similar or identical to each other. Each plate portion 118H1, 118H2 can have a substantially triangular shape. In the illustrated configuration, the first plate portion 118H1 includes an upper portion 274H1 and lower portion 276H1. The upper portion 274H1 can extend from the lower portion 276H1 along the same plane. The upper portion 274H1 can be triangularly shaped with a rounded top corner. The lower portion 276H1 can be rectangularly shaped with rounded ends (e.g., obround shaped).

The first plate portion 118H1 can include one or more openings to facilitate connections to the other components of the piston subassembly 101H and/or the internal combustion engine 100. In the illustrated configuration, the first plate portion 118H1 includes a first piston opening 278H1, a first connecting rod opening 280H1, a second connecting rod opening 282H1, and a second piston opening 284H1. In other configurations, more or less openings are possible.

The second plate portion 118H2 can be shaped similarly or identically to the first plate portion 118H1. For example, the second plate portion 118H2 can include an upper portion 274H2 and a lower portion 276H2. The second plate portion 118H2 can include a first piston opening 278H2, a first connecting rod opening 280H2, a second connecting rod opening 282H2, and a second piston opening 284H2. In other configurations, more or less openings are possible.

The first piston openings 278H1, 278H2 of the crosshead 114H can be used to couple the piston 110H to the crosshead 114H. For example, an opening 190H (see e.g., FIG. 15B) in the piston 110H can be aligned with the first piston openings 278H1, 278H2, and a wrist pin can be inserted to facilitate a rotatable connection. In other configurations, different connection means can be used.

The second piston openings 284H1, 284H2 of the crosshead 114H can be used to couple the added piston 150H to the crosshead 114H. For example, an opening 214H (see e.g., FIG. 15D) in the added piston 150H can be aligned with the second piston openings 284H1, 284H2, and a wrist pin can be inserted to facilitate a rotatable connection. In other configurations, different connection means can be used.

In some configurations, the second piston openings 284H1, 284H2 can be aligned (e.g., vertically aligned) along a common axis with the first piston openings 278H1, 278H2. As such, the piston 110H can be axially aligned with the piston 150H.

The connecting rod openings 280H1, 280H2, 282H1, 282H2 of the crosshead 114H can be used to couple connecting rods (e.g., the connecting rods 116 of the internal combustion engine 100 of FIGS. 1A and 1B) to the crosshead 114H. For example, the first connecting rod openings 280H1, 280H2 can facilitate a connection to the connecting rod 116 on a third side (e.g., a left side) of the crosshead 114H via a wrist pin. Similarly, the second connecting rod openings 282H1, 282H2 can facilitate a connection to the connecting rod 116 on a fourth side (e.g., a right side) of the crosshead 114H via a wrist pin. In other configurations, different connection means can be used.

As shown in FIGS. 14A and 14B, the plate portions 118H1, 118H2 can be arranged in the piston subassembly 101H aligned with each other and with a gap 117H defined therebetween. The gap 117H can be configured to receive connection components of the pistons 110H, 150H, and the connecting rods 116. For example, the connecting rods 116 can be positioned with one end in the gap 117H and wrist pins can be used to rotatably connect the crosshead 114H to the connecting rods 116.

In some configurations, the plate portions 118H1, 118H2 can be separated from each other, and the gap 117H can be maintained by connection to the other components of the piston subassembly 101H and/or the connecting rods 116. In other configurations, the plate portions 118H1, 118H2 of the crosshead 114H can be coupled to each other.

Referring now to FIG. 15B, a side view of the piston 110H is shown. The piston 110H may be used as a primary or added/secondary piston in any engine. The piston 110H may be a primary piston (e.g., configured to reciprocate in a combustion chamber) or an added piston (e.g., configured to reciprocate in an added cylinder) in any of the internal combustion engines described herein. While the following description references use of the piston 110H as a combustion piston, a similar or identical design could be used for any of the added pistons in any of the internal combustion engines described herein.

The piston 110H can include a piston body 191H. In the illustrated configurations, the piston body 191H includes an upper portion 186H and a lower portion 188H. In other configurations, the piston body 191H may not include the lower portion 188H (e.g., when different connection structures are utilized).

The upper portion 186H can have an outer wall 193H. In the illustrated configuration, the outer wall 193H is substantially cylindrically shaped. For example, the outer wall 193H defines a circular perimeter for the piston body 191H. In other configurations, the outer wall 193H can define an obround or double-c shaped perimeter for the piston body 191H.

In some configurations, one or more grooves 194H can be defined within the outer wall 193H. The grooves 194H can be configured to receive piston rings. When the outer wall 193H is cylindrical, the piston rings can be circular.

The upper portion 186H can include a piston top plate 192H. In the illustrated configuration, the piston top plate 192H is shown as flat. In other configurations, the upper portion 186H can be configured to include a recess (e.g., a frustoconical region, a cylindrical region, and/or the like) in the piston top plate 192H. When the piston 110H is not used for combustion, the piston top plate 192H may be a piston crown.

The lower portion 188H can be configured to facilitate a connection to another component of the internal combustion engine 100. For example, the lower portion 188H can be used to connect to a connecting rod or the crosshead 114H. Accordingly, the lower portion 188H can be referred to as a “connecting portion” of the piston 110H.

In the illustrated configuration, the lower portion 188H is configured as a projection extending from a lower end of the upper portion 186H (e.g., from an opposite side than the piston top plate 192H). The lower portion 188H can include an opening 190H extending therethrough. The opening 190H can be used to couple the piston 110H to another component, such as the crosshead 114H. In the illustrated configuration, the lower portion 188H has a rounded-triangular shape. In other configurations, different shapes can be used.

When used in the piston subassembly 101H, the piston 110H can be coupled to the crosshead 114H. For example, the lower portion 188H can be positioned within the gap 117H between the plate portion 118H1, 118H2 of the crosshead 114H, the opening 190H can be aligned with the first piston openings 278H1, 278H2 of the crosshead 114H, and a connector can be received therethrough. When the piston 110H is configured to articulate relative to the crosshead 114H, a rotatable coupling can be used, such as a wrist pin. In other configurations, the piston 110H can be coupled to the crosshead 114H in a manner that limits or restricts articulation.

In some configurations, the upper portion 186H can include a piston skirt (not shown). When included, the piston skirt can extend downwardly from the bottom of the upper portion 186H. When included, the piston skirt may partially surround the lower portion 188H.

Referring now to FIGS. 15C-15E, a perspective view, a side view, and a top view of the piston 150H are shown respectively. The piston 150H may be used as a primary or added/secondary piston in any engine. The piston 150H may be a primary piston (e.g., configured to reciprocate in a combustion chamber) or an added piston (e.g., configured to reciprocate in an added cylinder) in any of the internal combustion engines described herein. While the following description references use of the piston 150H as an added piston, a similar or identical design could be used for any of the combustion pistons in any engine, including any of the internal combustion engines described herein.

The piston 150H can include a piston body 200H. In the illustrated configuration, the piston body 200H includes a lower portion 202H and an upper portion 204H. In other configurations, the piston body 200H may not include the upper portion 204H (e.g., when different connection structures are utilized). When included, the upper portion 204H can be configured to couple the piston 150H to another component (e.g., a crosshead, a connecting rod, etc.). As such, the upper portion 204H may be referred to herein as a “connecting portion.”

The lower portion 202H includes an outer wall 206H. The outer wall 206H can be double-c shaped. For example, as shown in FIG. 15E, the outer wall 206H can define a perimeter of the lower portion 202H that is double-c shaped. As such, the piston 150H can be configured for use with a “cylinder” having a corresponding double-c shape (see e.g., the additional housing 136H of FIGS. 15G and 15H). As described herein, a double-c shaped outer wall 206H can have the shape of the perimeter of two overlapping circles when viewed from above.

In some configurations, the lower portion 202H may be machined or otherwise manufactured to have the double-c shape. For example, the lower portion 202H can be machined or otherwise manufactured using additive manufacturing or subtractive manufacturing to have the double-c shape.

In some configurations, the lower portion 202H may be constructed from a first piston portion 216H1 and a second piston portion 216H2 that are joined together. However, such construction is not required to realize the performance benefits of the double-c shaped piston 150H. When constructed in this manner, the first piston portion 216H1 and the second piston portion 216H2 can be cylinders with approximately identical diameters that are cut along a common chord (e.g., an equal distance from the center of each cylinder), leaving a substantial portion (e.g., greater than 50%) of the circumferences intact. The resulting flat side (not shown) of the first piston portion 216H1 can then be joined to the flat side (not shown) of the second piston portion 216H2 to form the double-c shaped lower portion 202H of the piston 150H. Various coupling techniques can be used to join the first piston portion 216H1 and the second piston portion 216H2, as described with reference to at least FIGS. 12A and 12B.

The flat sides of the piston portions 216H1, 216H2 can be cut along a chord line anywhere between the center of the circles and the perimeters. For example, each piston portion 216H1, 216H2 can be cut from a cylinder such that between 50% and 100% of the volume remains. In some configurations, it may be preferable that the remaining volume is between 60% and 90%. In some configurations, it may be preferable that the remaining volume is between 65% and 85%.

As shown in FIG. 15D, the lower portion 202H can include one or more grooves 230H formed in the outer wall 206H. The grooves 230H can be configured to receive piston rings (not shown). The piston rings can be generally c-shaped and configured in the same or a similar manner as the piston rings 232 described with reference to at least FIGS. 12A-12C. For example, the piston 150H can receive one or more piston rings in the grooves 230H that are partial circle shaped/constant radii arc shaped. Generally, two piston rings are received within each groove 230 on the same plane.

In some configurations, a piston top plate 210H is positioned on a downward facing surface of the piston body 200H, in the orientation of FIG. 15D. The piston top plate 210H may be a portion of the lower portion 202H or may be a separate component affixed to the piston body 200H in any suitable manner. The piston top plate 210H can be optional. When the double-c piston body 200H is used for the primary piston 110H, a piston top plate 210H may be desirable to reduce heat conduction from the combustion gases into the piston body 200H. However, when the piston body 200H is used for the added piston 150H, a piston top plate 210H may not be required and this portion may be referred to as the piston crown 210H.

In some configurations, the lower portion 202H of the piston body 200H can include a recessed portion 215H on an upper surface thereof. The recessed portion 215H can be defined by a raised portion 217H of the outer wall 206H. When included, the upper portion 204H can extend from the recessed portion 215H. For example, the upper portion 204H may be partially surrounded by the raised portion 217H of the outer wall 206H.

In some configurations, the lower portion 202H can include a piston skirt. For example, the raised portion 217H of the outer wall 206H can be configured as a piston skirt or an alternative piston skirt can be included. When included, the piston skirt can extend upwardly from the top of the lower portion 202H. When included, the piston skirt may partially surround the upper portion 204H.

The upper portion 204H of the piston 150H, when included, can be configured to facilitate a connection to another component of the internal combustion engine 100. For example, the upper portion 204H can be used to connect to a connecting rod or the crosshead 114H. Accordingly, the upper portion 204H can be referred to as a “connecting portion” of the piston 150H.

In the illustrated configuration, the upper portion 204H is configured as a projection extending from an upper end of the lower portion 202H (e.g., from an opposite side than the piston top plate 210H). The upper portion 204H can include an opening 214H extending therethrough. The opening 214H can be used to couple the piston 150H to another component, such as the crosshead 114H. Any suitable shape can be used for the upper portion 204H.

When used in the piston subassembly 101H, the piston 150H can be coupled to the crosshead 114H. For example, the upper portion 204H can be positioned within the gap 117H between the plate portion 118H1, 118H2 of the crosshead 114H, the opening 214H can be aligned with the second piston openings 284H1, 284H2 of the crosshead 114H, and a connector can be received therethrough. When the piston 150H is configured to articulate relative to the crosshead 114H, a rotatable coupling can be used, such as a wrist pin. In other configurations, the piston 150H can be coupled to the crosshead 114H in a manner that limits or restricts articulation.

When the piston 150H is used as the combustion piston (e.g., the piston 110) in the internal combustion engine 100 of FIGS. 1A and 1B, the origination of the piston 150H may be rotated relative to the crosshead 114H such that the long axis of the piston 150H extends into the page. When configured in this manner, the upper portion 204H may also be rotated relative to the lower portion 202H (e.g., by 90-degrees) to facilitate the connection to the crosshead 114H.

As described herein, in some embodiments, the pistons can include one or more ports extending therethrough. For example, as shown in FIG. 15F, the piston 150H can optionally include one or more ports 160H. The ports 160H can extend through the lower portion 202H from its bottom side to its top side. Each port 160H can include a one-way valve (e.g., a reed valve, a poppet valve, a rotary valve, a one-way ball valve, and/or the like) that allows fluid to flow in one direction through the piston body 200H. For example, when used in the internal combustion engine 100 of FIGS. 1A and 1B, the ports 160H in the piston 150H can allow fluid in the added cylinder 146 to flow through the piston body 200H and into the combustion chamber 104 via the intake passage 126.

In the illustrated configuration of FIG. 15F, the piston 150H includes a first set of ports 161H1 and a second set of ports 161H2. Each set of ports 161H1, 161H2 can include a plurality of ports (e.g., between 1 and 12, between 2 and 10, between 4 and 8, and/or the like). The first set of ports 161H1 can be positioned in the first piston portion 216H1. The second set of ports 161H2 can be positioned in the second piston portion 216H2.

FIGS. 15G and 15H illustrate a top perspective view and a top view respectively of an example additional housing 136H that can be used in any of the internal combustion engines described herein that can include a double-c shaped added piston (e.g., the internal combustion engine 100 of FIGS. 1A and 1B). The additional housing 136H can include an added cylinder 146H having a double-c shape. For example, the perimeter of the added cylinder 146H can be double-c shaped.

As described herein, in some embodiments, the additional housings can include one or more ports extending therethrough. For example, as shown in FIG. 15H, the additional housing 136H can optionally include one or more ports 142H. The ports 142H can extend through a bottom side 145H of the additional housing 136H into the added cylinder 146H. Each port 142H can include a one-way valve (e.g., a reed valve, a poppet valve, a rotary valve, a one-way ball valve, and/or the like) that allows fluid to flow in one direction into or out of the added cylinder 146H, depending on the configuration. For example, when used in the internal combustion engine 100, the ports 142H in the additional housing 136H can allow fluid to flow into the added cylinder 146 from an external environment. In another example, when used in the internal combustion engine 100D of FIG. 7, some of the ports 142H can be configured as outlet ports (e.g., the outlet port(s) 176D) and can allow fluid to flow from the added cylinder 146 and into the combustion chamber 104D via the inlet feed pipe 174D.

In the illustrated configuration of FIG. 15H, the additional housing 136H includes a first set of ports 143H1 and a second set of ports 143H2. Each set of ports 143H1, 143H2 can include a plurality of ports (e.g., between 1 and 12, between 2 and 10, between 4 and 8, and/or the like). The first set of ports 143H1 can be positioned in a first partial cylindrical portion of the added cylinder 146H. The second set of ports 143H2 can be positioned in a second partial cylindrical portion of the added cylinder 146H. In some configurations, the first set of ports 143H1 can include one-way valves configured for outflow and the second set of ports 143H2 can include one-way valves configured for inflow, or vice-versa.

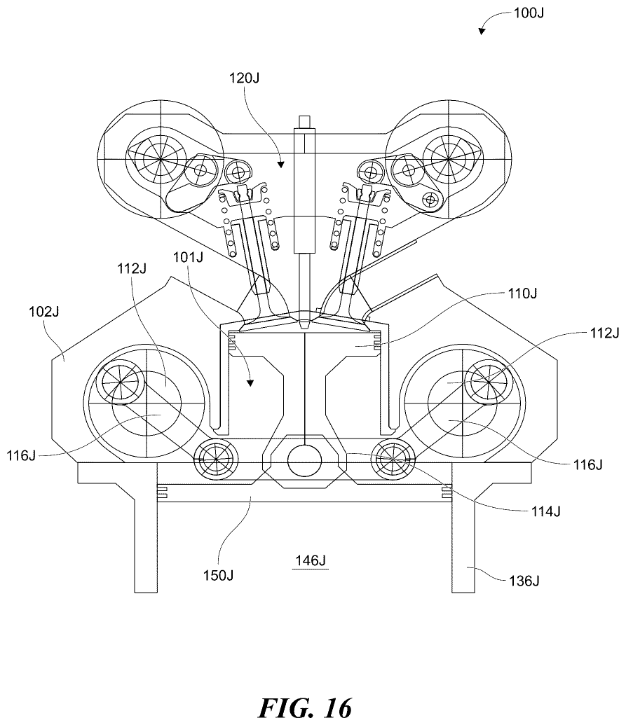

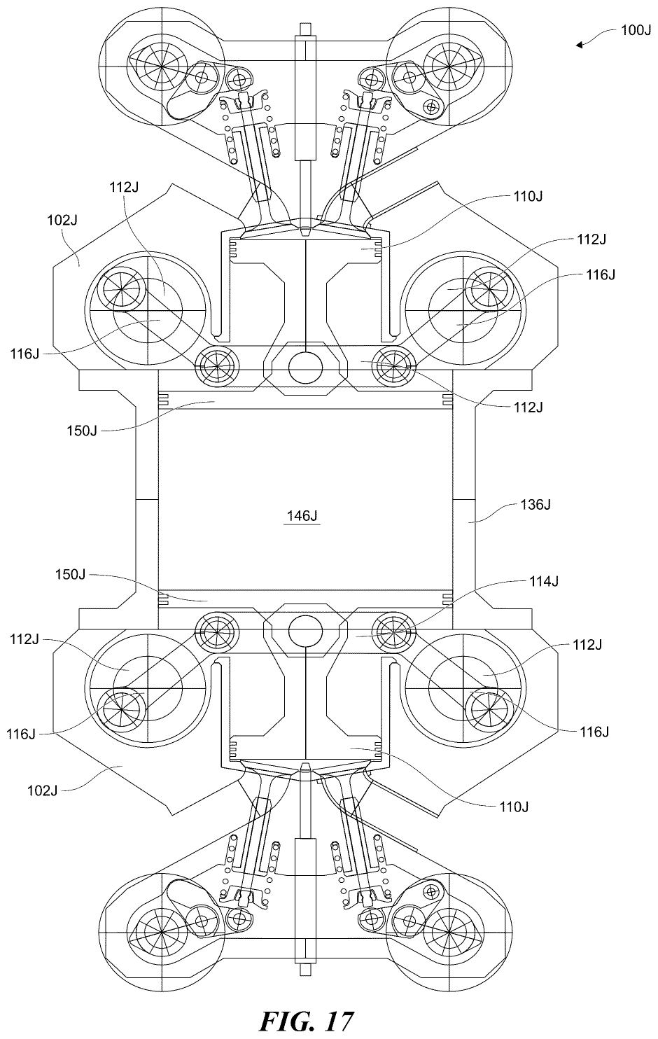

FIGS. 16 and 17 illustrate configurations of an internal combustion engine 100J. Some of the features of the internal combustion engine 100J are similar to features of the internal combustion engine 100 in at least FIGS. 1A-2. Thus, reference numerals used to designate the various features or components of the internal combustion engine 100J are identical to those used for identifying the corresponding features or components of the internal combustion engines 100 in at least FIGS. 1A-2 except that the numerical identifiers for components of the internal combustion engine 100J end with a “J.” Therefore, the structure and description for the various features of the internal combustion engine 100 and how they operate in at least FIGS. 1A-2 are understood to also apply to the corresponding features of the internal combustion engine 100J, except as described below.

The internal combustion engine 100J differs from the internal combustion engine 100 of FIGS. 1A-2 in that the internal combustion engine 100J includes a non-triangularly shaped crosshead 114J. In part due to the different shaped crosshead 114J, the internal combustion engine 100J can optionally include a piston subassembly 101J that differs from the piston subassembly 101H described with reference to at least FIGS. 14A-15F.

The internal combustion engine 100J can include one uniblock 102J, as shown in FIG. 16, or multiple uniblocks 102J, as shown in FIG. 17. In the configuration of FIG. 16, the multiple uniblocks 102J can be joined together by the additional housing 136J. For example, the internal combustion engine 100J of FIG. 17 can be configured in a similar manner as the internal combustion engine 100E of FIG. 8, where the additional housing 136J is used to mount uniblocks 102J side-by-side and/or end-to-end. While not all features and components of the internal combustion engine 100J are shown in FIGS. 16 and 17, it is recognized that the internal combustion engine 100J can include any features of any of the internal combustion engines described herein.

The internal combustion engine 100J may also include one or more valve train(s) 120J that differ from the valve train 120 of the internal combustion engine 100. For example, the valve train(s) 120J of the internal combustion engine 100J can include camshafts for actuating the valves instead of pushrods. Several implementations of valve trains and valve configurations that can be used in the internal combustion engine 100J, or any of the other internal combustion engines described herein, are described in PCT Application No. US2024/054996.

With reference now to FIGS. 18A and 18B, a perspective view and an exploded view are shown respectively of the piston subassembly 101J that can be included in any of the internal combustion engines described herein. Some of the features of the piston subassembly 101J are similar to features of the piston subassembly 101H in at least FIGS. 14A-15F. Thus, reference numerals used to designate the various features or components of the piston subassembly 101J are identical to those used for identifying the corresponding features or components of the piston subassembly 101H in at least FIGS. 14A-15F except that the numerical identifiers for components of the piston subassembly 101J end with a “J” instead of an “H”. Therefore, the structure and description for the various features of the piston subassembly 101H and how they operate in at least FIGS. 14A-15F are understood to also apply to the corresponding features of the piston subassembly 101J, except as described below.

The piston subassembly 101J can include a piston 110J, a crosshead 114J, and/or an added piston 150J. In the piston subassembly 101J, the piston 110J can be coupled to the crosshead 114J at a first end (e.g., a top end) and the added piston 150J can be coupled to the crosshead 114J at a second end (e.g., a bottom end). Accordingly, the piston 110J can be positioned on an opposite side of the crosshead 114J than the added piston 150J.

The crosshead 114J can differ from the crosshead 114H in that each plate portion 118J1, 118J2 of the crosshead 114J can be substantially obround shaped (e.g., rectangularly shaped with rounded sides). For example, each plate portion 118J1, 118J2 can be configured in a similar manner as the lower portion 276H1 of the first plate portion 118H1 of the crosshead 114H. The second plate portion 118J2 can be similar or identical to the first plate portion 118J1; however, for illustrative purposes, some components of the second plate portion 118J2 are not shown/labeled in FIGS. 18A and 18B.

The crosshead 114J can also differ from the crosshead 114H in that each plate portion 118J1, 118J2 can include one piston opening 284J. For example, the piston 110J and the piston 150J can be coupled to the crosshead 114H using the same piston openings 284J. As such, the two pistons 110J, 150J, can share a connector, such as a shared wrist pin.

Each plate portion 118J1, 118J2 can include a first connecting rod opening 280J and a second connecting rod opening 282J. The connecting rod openings 280J1, 282J can be used to couple the crosshead 114J to the crankshafts 112J using the connecting rods 116J.

In the illustrative example, the connecting rod openings 280J1, 282J are aligned along a longitudinal axis of the crosshead 114J with the piston opening 284J. In some configurations, the longitudinal axis can be orthogonal to the reciprocating axis of the piston 110J and/or the added piston 150J.

The piston 150J can be similar or identical to the piston 150H of FIGS. 15C-15E. For example, the piston 150J can include a double-c shaped lower portion 202J and an upper portion 204J with an opening 214J for coupling the piston 150J to the crosshead 114J. In the piston subassembly 101J, the upper portion 204J can be positioned within the gap 117J between the plate portion 118J1, 118J2 of the crosshead 114J, the opening 214J can be aligned with the piston openings 284J of the crosshead 114J, and a connector can be received therethrough. When the piston 150J is configured to articulate relative to the crosshead 114J, a rotatable coupling can be used, such as a wrist pin. In other configurations, the piston 150J can be coupled to the crosshead 114J in a manner that limits or restricts articulation.

The piston 110J can be similar to the piston 110H of FIG. 15B. For example, the piston 110J can include an upper portion 186J and a lower portion 188J. The upper portion 186J of the piston 110J can be similar or identical to the upper portion 186H of the piston 110H. However, the lower portion 188J of the piston 110J can be configured in a manner to allow the piston 110J to be coupled to the crosshead 114J on the outside of the crosshead 114J, instead of in the gap 117J.

In the illustrated configuration, the lower portion 188J includes a central portion 196J, a first forked portion 198J1 and a second forked portion 198J2. The central portion 196J can extend from a bottom of the upper portion 186J. The forked portions 198J1, 198J2 can extend from a bottom of the central portion 196J, with a gap 197J defined therebetween. The forked portions 198J1, 198J2 can extend parallel to each other over at least a portion of their lengths such that the gap 197J has a portion with a constant width.

The first forked portion 198J1 can include a first opening 190J1. The second forked portion 198J2 can include a second opening 190J2. The first opening 190J1 and the second opening 190J2 can be axially aligned with each other. The openings 190J1, 190J2 can be used to couple the piston 110J to the crosshead 114J.

In the piston subassembly 101J, the crosshead 114J can be positioned within the gap 197J between the forked portions 198J1, 198J2. In this position, the piston openings 284J in the crosshead 114J can be aligned with the openings 190J1, 190J2 in the forked portions 198J1, 198J2, and a connector can be received therethrough. When the piston 110J is configured to articulate relative to the crosshead 114J, a rotatable coupling can be used, such as a wrist pin. In other configurations, the piston 110J can be coupled to the crosshead 114J in a manner that limits or restricts articulation.

In the piston subassembly 101J, the piston 110J and the added piston 150J can share the same wristpin or other connector for facilitating the connection to the crosshead 114J. The upper portion 204J of the piston 150J can be positioned in the gap 117J of the crosshead 114J, and the crosshead 114J can be positioned in the gap 197J between the forked portions 198J1, 198J2 of the piston 110J. In this arrangement, the opening 214J of the piston 150J, the openings 284J of the crosshead 114J, and the openings 190J1, 190J2 of the piston 110J can all be axially aligned. When a wrist pin is inserted in these openings, the piston 110J, the piston 150J, and the crosshead 114J can be rotatably coupled together.

In some configurations, one or more components of the piston subassembly 101J can be fixed to each other or integrally formed with each other. For example, FIGS. 19-21 illustrate various configurations of piston subassemblies 101K, 101L, and 101M, or components thereof, that can be included in any of the internal combustion engines described herein.

When the crosshead is fixed or integrally formed with one or both of the pistons, these configuration can provide the advantage of fewer parts and/or fewer degrees of freedom for the subassembly. For example, the subassembly can be easier to manufacture and/or assemble, and/or alignment of components of the subassembly can be easier. In some cases, such arrangements can reduce the rocking that might occur for the piston(s) that is combined with the crosshead and/or reduce the lateral swinging that would be possible for the crosshead, compared to the configurations that allow independent rocking of both pistons. Configurations where both pistons and the crosshead are one piece provides the advantage of the least rocking of any piston, and the least swinging of the crosshead.

Some of the features of the piston subassemblies 101K, 101L, and 101M are similar to features of the piston subassembly 101H in at least FIGS. 14A-15F and/or the piston subassembly 101J in FIGS. 18A-18B. Thus, reference numerals used to designate the various features or components of the piston subassemblies 101K, 101L, and 101M are identical to those used for identifying the corresponding features or components of the piston subassembly 101H in at least FIGS. 14A-15F and/or the piston subassembly 101J in FIGS. 18A-18B except that the numerical identifiers for components of the piston subassemblies 101K, 101L, and 101M end with a “K,” “L,” and “M,” respectively. Therefore, the structure and description for the various features of the piston subassemblies 101H, 101J and how they operate in at least FIGS. 14A-15F and 18A-18B are understood to also apply to the corresponding features of the piston subassemblies 101K, 101L, and 101M, except as described below.

Referring first to FIG. 19, a perspective view of the piston subassembly 101K is shown. The piston subassembly 101K can include an upper piston 110K, a lower piston 150K, and a connector 114K. The pistons 110K, 150K, and the connector 114K can be coupled to each other in a fixed/non-rotatable manner (e.g., without articulation) or integrally formed with each other.

The piston 110K can include an upper portion 186K and a lower portion 188K. The upper portion 186K of the piston 110K can be similar or identical to the upper portion 186H of the piston 110H. The lower portion 188K of the piston 110K can extend downwardly from the upper portion 186K and can be coupled to or integrally formed with a central portion 198K of the connector 114K.

The piston 150K can include a lower portion 202K. The lower portion 202K of the piston 150K can be similar or identical to the lower portion 202H of the piston 110H. The piston 150K may not include an upper portion. Instead, the connector 114K can be coupled to or integrally formed with piston 150K. For example, the connector 114K can extend from a top side of the lower portion 202K.

The connector 114K can be configured to couple the piston subassembly 101K to a pair of connecting rods (e.g., the connecting rods 116J of the internal combustion engine 100J of FIG. 16 or 17). For example, the connector 114K can function as a crosshead, and may be referred to herein as such.

The connector 114K can differ from the crosshead 114J of FIGS. 18A and 18B in that the connector 114K can include a central portion 198K. The plate portions 118K1, 118K2 can extend laterally from the central portion 198K. As such, gaps 117K can be defined between the plate portions 118K1, 118K2 on both sides of the central portion 198K. Each plate portion 118K1, 118K2 can include openings 280K, 282K to facilitate the connection to connecting rods. For example, ends of the connecting rods 116J can be positioned in gaps 117K and rotatably coupled at the openings 280K, 282K via wrist pins.

Referring now to FIG. 20, a perspective view of a portion of the piston subassembly 101L is shown. The piston subassembly 101L can include an upper piston 110L, a lower piston (e.g., the piston 150H of FIGS. 15C-15E), and a connector 114L. The lower piston is not shown in FIG. 20 for illustrative purposes. The upper piston 110L and the connector 114L can be coupled to each other in a fixed manner (e.g., without articulation) or integrally formed with each other.

The piston 110L can include an upper portion 186L and a lower portion 188L. The upper portion 186L of the piston 110L can be similar or identical to the upper portion 186H of the piston 110H. The lower portion 188L of the piston 110L can extend downwardly from the upper portion 186L and can be coupled to or integrally formed with the connector 114L.

The connector 114L can be configured to couple the piston subassembly 101L to a pair of connecting rods (e.g., the connecting rods 116J of the internal combustion engine 100J of FIG. 16 or 17). For example, the connector 114L can function as a crosshead, and may be referred to herein as such. The connector 114L can also be configured to couple to a lower piston, such as the piston 150H.

The connector 114L can differ from the crosshead 114J of FIGS. 18A and 18B in that the connector 114L can be coupled to or integrally formed with the lower portion 188L of the piston 110L. For example, the plate portions 118L1, 118L2 can extend downwardly from a bottom of the lower portion 188L. The gap 117L can be defined between the plate portions 118L1, 118L2.

Each plate portion 118L1, 118L2 can include openings 280L, 282L to facilitate the connection to connecting rods. For example, ends of the connecting rods 116J can be positioned in gap 117L and rotatably coupled at the openings 280L, 282L via wrist pins. The connector 114L can include a piston opening 284L for coupling to the piston 150H in a similar manner as the piston 150H is coupled to the crosshead 114H in the piston subassembly 101H of FIGS. 14A and 14B.

Referring now to FIG. 21, a perspective view of the piston subassembly 101M is shown. The piston subassembly 101M can include an upper piston 110M, a lower piston 150M, and a connector 114M. The lower piston 150M and the connector 114M can be coupled to each other in a fixed manner (e.g., without articulation) or integrally formed with each other.

The piston 110M can include an upper portion 186M and a lower portion 188M. The upper portion 186M of the piston 110M can be similar or identical to the upper portion 186H of the piston 110H.

The lower portion 188M of the piston 110M can extend downwardly from the upper portion 186M. The lower portion 188M can include a central portion 196M and a connecting portion 198M. The connecting portion 198M can extend from the central portion 196M. The connecting portion 198M can include an opening 190M to facilitate a connection to the connector 114M.

The piston 150M can include a lower portion 202M. The lower portion 202M of the piston 150M can be similar or identical to the lower portion 202H of the piston 110H. The piston 150M may not include an upper portion. Instead, the connector 114M can be coupled to or integrally formed with piston 150M. For example, the connector 114M can extend from a top side of the lower portion 202M.

The connector 114M can be configured to couple the piston subassembly 101M to a pair of connecting rods (e.g., the connecting rods 116J of the internal combustion engine 100J of FIG. 16 or 17). For example, the connector 114M can function as a crosshead, and may be referred to herein as such. The connector 114M can also be configured to couple the piston 150M to the piston 110M.

The connector 114M can differ from the crosshead 114J of FIGS. 18A and 18B in that the connector 114M can be coupled to or integrally formed with the lower portion 202M of the piston 150M. For example, the plate portions 118M1, 118M2 can extend upwardly from a top of the lower portion 202M. The gap 117M can be defined between the plate portions 118M1, 118M2.

Each plate portion 118M1, 118M2 can include openings 280M, 282M to facilitate the connection to connecting rods. For example, ends of the connecting rods 116J can be positioned in the gap 117M and rotatably coupled at the openings 280M, 282M via wrist pins. The connector 114M can include a piston opening 284M for coupling to the piston 110H in a similar manner as the piston 110H is coupled to the crosshead 114H in the piston subassembly 101H of FIGS. 14A and 14B. For example, the connecting portion 198M can be positioned in the gap 117M with the opening 190M aligned with the piston openings 284M, and a wrist pin can be received therethrough.

Internal Combustion Engine with Variable Charge Air Intake

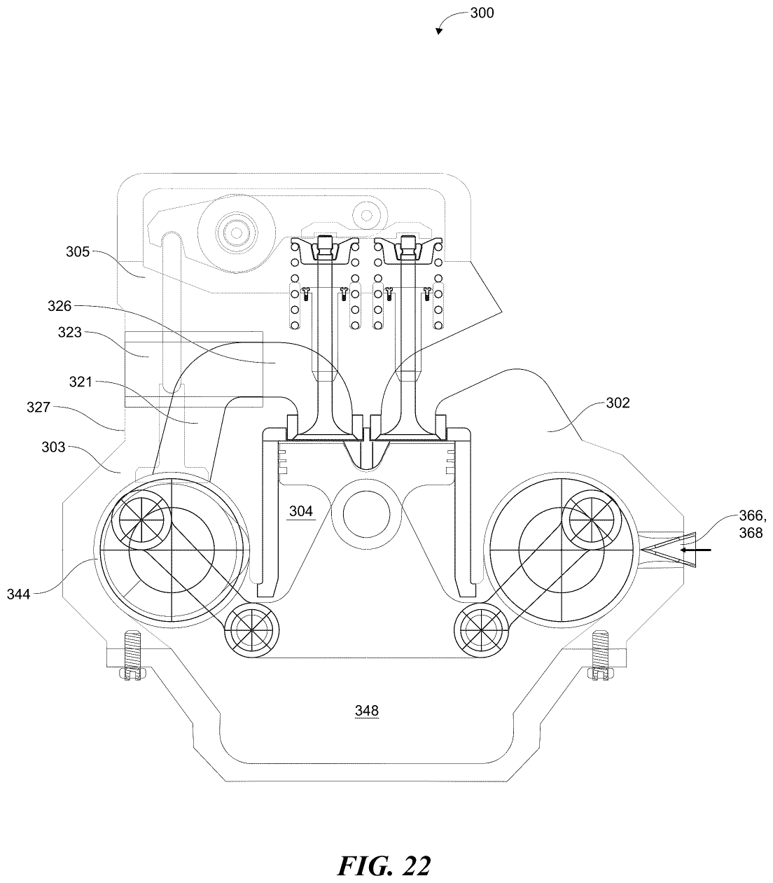

FIG. 22 illustrates a configuration of an internal combustion engine 300. Some of the features of the internal combustion engine 300 are similar to features of the internal combustion engine 100 in at least FIGS. 1A-2 and the internal combustion engine 100C in at least FIGS. 6A-6C. Thus, reference numerals used to designate the various features or components of the internal combustion engine 300 are identical to those used for identifying the corresponding features or components of the internal combustion engines 100 and 100C in at least FIGS. 1A-2 and 6A-6C respectively except that the numerical identifiers for components of the internal combustion engine 300 begin with a “3” instead of a “1”. Therefore, the structure and description for the various features of the internal combustion engine 100 and internal combustion engine 100C and how they operate in at least FIGS. 1A-2 and 6A-6C respectively are understood to also apply to the corresponding features of the internal combustion engine 300, except as described below.

The internal combustion engine 300 differs from the internal combustion engine 100 of FIGS. 1A-2 in that the internal combustion engine 300 can be configured to change whether intake air and/or charge air enters the intake passage 326 from the crank portion 303 or directly from outside the internal combustion engine 300 (e.g., from an environment external to the internal combustion engine 300). For example, the internal combustion engine 300 can be configured to selectively receive intake air through the crank portion 303 or from outside the internal combustion engine 300. For ease of reference, air flowing into the combustion chamber 304 via the intake passage 326 is referred to herein as “intake air” even when such fluid has been compressed to become charge air (e.g., by a turbocharger, supercharger, added piston, etc.).

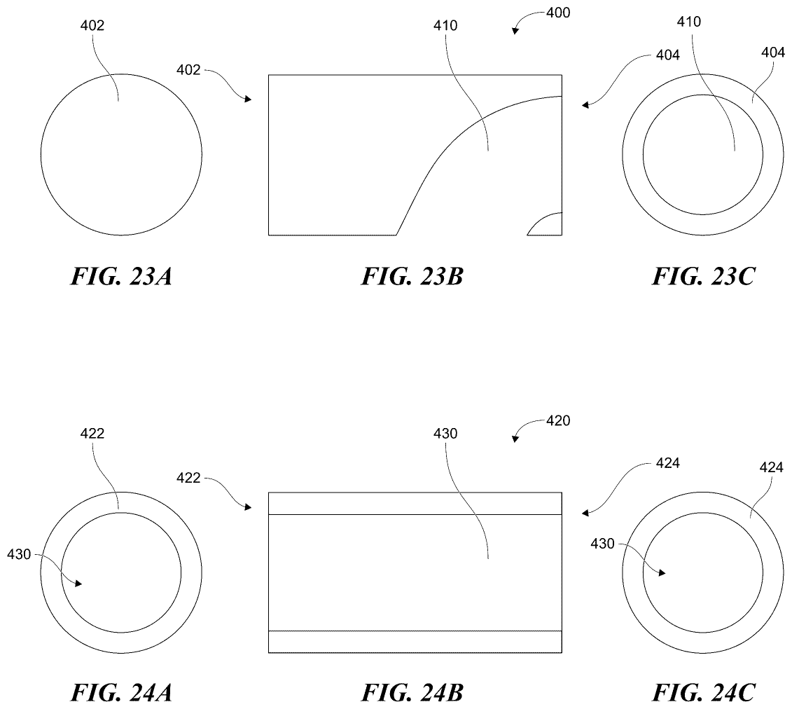

In some configurations, the type of intake air can be selected by an operator of the internal combustion engine 300 based on the type of plug inserted in the internal combustion engine 300, as described further with reference to FIGS. 23A-24C. In the illustrated configuration, the internal combustion engine 300 is similar to the internal combustion engine 100C in that the internal combustion engine 300 does not include an added piston. However, in some configurations, the internal combustion engine 300 may include an added piston that is similar or identical to the one or more added piston 150 configurations of the internal combustion engine 100. For example, any of the piston subassemblies of FIGS. 14A-15H and 18A-21 or individual components thereof can be incorporated into the internal combustion engine 300.

The internal combustion engine 300 can include any of the advantages of the other internal combustion engines configurations described herein. For example, the internal combustion engine 300 can have advantages associated with configurations including each piston being able to pivot with respect to the crosshead, improved case in manufacturing with parts made separately, the ability to use different materials with different properties for each part, and the highest degrees of freedom of movement of each part, which may pivot with respect to other parts. The internal combustion engine 300 can also have certain benefits when the crosshead is combined with one of the pistons. Such arrangements can reduce the rocking that might occur for the piston that is combined with the crosshead and/or reduce the lateral swinging that would be possible for the crosshead, compared to the configurations that allow independent rocking of both pistons. As explained herein, configurations where both pistons and the crosshead are one piece provides the advantage of the least rocking of any piston, and the least swinging of the crosshead.

As shown in FIG. 22, the intake passage 326 can be connected to a first/primary passage 323. The primary passage 323 can extend through a side surface in the valve portion 305 of the uniblock 302 and provides a fluid connection between the intake passage 326 and the environment external to the internal combustion engine 300.

The primary passage 323 can be connected along a lower sidewall to a second/crank passage 321. For example, the crank passage 321 can be in fluid communication with the primary passage 323. As such, the primary passage 323 and the crank passage 321 can form a y-connection to the intake passage 326. The crank passage 321 can extend between the primary passage 323 and one of the crankshaft containing passages 344 (e.g., the left-side crankshaft containing passage 344 in the illustrated configuration) of the uniblock 302.

The crank passage 321 extends between the valve portion 305 and the crank portion 303 in the illustrated configuration. The crank passage 321 can allow the intake passage 326 to be in fluid communication with the central recess 348 of the crank portion 303. Such a configuration of the primary passage 323 and the crank passage 321 allows intake air to selectively enter the intake passage 326 from the external environment or from the crank portion 303 respectively.

Generally, it is desirable for intake air to enter the intake passage 326 from the external environment via the primary passage 323 or from crank portion 303 via the crank passage 321, but not from both. As such, one of more passage plugs can be used to selectively block the primary passage 323 or the crank passage 321, depending on the desired configuration for the internal combustion engine 300. FIGS. 23A-23C illustrate various views of a first passage plug 400 and FIGS. 16A-16C illustrate various views of a second passage plug 420 that can be used to define the intake air configuration for the internal combustion engine 300.

Referring first to FIG. 23B, an implementation of the first passage plug 400 is shown. The first passage plug 400 is configured to be inserted in the primary passage 323. The first passage plug 400 is configured to block intake air flow from outside the internal combustion engine 300 and allow intake air to flow through the crank passage 321 to the intake passage 326.

The first passage plug 400 includes a blocked first end 402, shown in FIG. 23A, and an open second end 404, shown in FIG. 23C. The first passage plug 400 can include a channel 410 that extends from the open second end 404 towards and through a lower surface of the first passage plug 400. The channel 410 is configured to fluidly connect the crank passage 321 and the intake passage 326 when inserted in the primary passage 323.

To configure the internal combustion engine 300 for intake air flow through the crank portion 303, the first passage plug 400 can be inserted in the primary passage 323. The first passage plug 400 can be inserted with the open second end 404 extending first into the primary passage 323 such that the open second end 404 is in close proximity to or engages the intake passage 326 and the blocked first end 402 prevents fluid entry from the external environment through the primary passage 323. In such a configuration, the channel 410 can be aligned with the crank passage 321, allowing air to flow from the central recess 348 to the intake passage 326. In such as configuration, a one-way valve 368 may be inserted into the intake port 366 so that air can enter the central recess 348 via the intake port 366.

Referring now to FIG. 24B, the second passage plug 420 is shown. The second passage plug 420 is configured to be inserted in the primary passage 323. The second passage plug 420 is configured to block intake air flow from the crank passage 321 to the intake passage 326 and to allow intake air to flow from outside the internal combustion engine 300 to the intake passage 326 via the primary passage 323.

The second passage plug 420 includes an open first end 422, shown in FIG. 24A, and an open second end 424, shown in FIG. 16C. The second passage plug 420 includes a channel 430 that extends from the open first end 422 to the open second end 424. The channel 430 is configured to allow air to flow through the second passage plug 420. The channel 430 is configured to fluidly connect the intake passage 326 with the external environment when inserted in the primary passage 323.

To configure the internal combustion engine 300 for intake air flow through primary passage 323 from the outside environment, the second passage plug 420 can be inserted in the primary passage 323. This arrangement is shown in FIG. 25. The first passage plug 400 can be inserted with one end 422, 424 in close proximity to or engaged with the intake passage 326. In such a configuration, the second passage plug 420 can obstruct fluid communication between the crank passage 321 and the primary passage 323 and allow fluid communication between the intake passage 326 and the external environment via the channel 430. In such a configuration, fluid does not flow through the crank portion 303 and an additional plug 440 may be inserted in the intake port 366 so that air cannot enter the central recess 348 via the intake port 366.

As shown in FIG. 25, the internal combustion engine 300 can optionally include a scavenging pump/supercharger 490. When included, the scavenging pump/supercharger 490 can improve the efficiency and/or power output of the internal combustion engine 300. For example, the scavenging pump 490 can assist in removing exhaust gases from the combustion chamber 304 and/or inducing air into the combustion chamber 304 via the primary passage 323. In some configurations, the internal combustion engine 300 may utilize the scavenging pump/supercharger 490 even when the first passage plug 400 is inserted in the primary passage 323 and intake air flows through the crank portion 303. In such a configuration, the scavenging pump/supercharger 490 can induce air flow through the intake port 366.

### Uniblock

The various internal combustion engines shown and described with reference to FIGS. 1A-26 can utilize one or more uniblocks. Using one or more uniblocks can provide the internal combustion engines with certain advantages over traditional internal combustion engine configurations, as described further below. While the following description references the internal combustion engine 100 and the uniblock 102, it is understood that such advantages and configurations can apply to any of the other internal combustion engines utilizing uniblock(s) described herein.

The uniblock 102 provides the internal combustion engine 100 using the uniblock 102 with some distinct advantages over traditional internal combustion engine configurations. For example, defining the combustion chamber 104 within the uniblock 102 enables the internal combustion engine 100 to withstand extremely high compression pressures. This results because there no longer is a gasketed junction between the cylinder head and the cylinder block, which is a location for high compression pressure failures. For example, in the illustrated internal combustion engine 100 that employes the uniblock 102, the compression ratio can be about 10:1, about 20:1, about 30:1, about 40:1, about 50:1, about 75:1, about 100:1, any value between these values, or more or less depending upon the particular engine design. In other words, depending upon the desired compression ratio, the illustrated internal combustion engine 100 can be modified to obtain that desired compression ratio.

By contrast, conventional internal combustion engines have compression ratios between about 6:1 to about 10:1 for engines that burn gasoline and between about 12:1 and 20:1 for engines that burn diesel fuel. Thus, the internal combustion engines 100 using the uniblock 102 can have higher final compression ratios than typically found in engines for many use cases.

In some configurations, an engine according to the present disclosure can have a final compression ratio that can exceed 50:1. In some configurations, an engine according to the present disclosure can have a final compression ratio of 200:1 or higher. Such high compression ratios can result from the constructions that generally reduce the regions most likely to fail under the high pressures that result from the high compression ratios.

These higher than standard compression ratios can be more simply achieved in the internal combustion engine 100 that uses the uniblock 102. The benefits of the configurations of the internal combustion engine 100 employing the uniblock 102 can be scaled in size. The ability to scale in size results in engines with maximum power outputs from one horsepower to one million horsepower, for example.

The internal combustion engine 100 using the uniblock 102 can be flexible regarding the type of fuel at least in part because of the high compression pressures that can be generated within the combustion chamber 104. For example, certain features, aspects, and advantages of the internal combustion engine 100 with the uniblock 102 can be used with compression ignition fuels, while others can be used with spark ignition fuels, and still others can be used with any fuel, including spark ignition and/or compression ignition fuels.

The uniblock 102 construction also enables the internal combustion engine 100 using the uniblock 102 to be lighter than a conventional reciprocating internal combustion engine of equivalent power. The internal combustion engine 100 using the uniblock 102 also can achieve other advantages. For example, some of the other advantages can include, but are not limited to, reduced fuel energy going to waste heat, increased and more efficient cooling, increased charge air compression, reduced parts counts, reduced production costs, reduced stress risers in high temperature and high pressure areas of the uniblock, improved metal grain structure in high pressure and high temperature uniblock regions, increased engine longevity, increased engine working environments, increased service intervals, and/or elimination of engine and engine parts failures due to engine block to engine head failures.

By combining the cylinder head and the cylinder block into a uniblock 102, issues like stress on head gaskets used to seal the connection between the cylinder block and the cylinder head can be avoided. In some configurations, the uniblock 102 facilitates constructions of the internal combustion engine 100 that can have reduced waste heat production, improved heat dissipation, or both. In some configurations, the uniblock 102 facilitates constructions of the internal combustion engine 100 that can make more efficient use of space and volume. For example, according to some configurations, the internal combustion engine 100 using the uniblock 102 can have reduced size for a given horsepower when compared with conventional reciprocating engine designs.

In some configurations, the internal combustion engine 100 using the uniblock 102 can have reduced volume and/or weight per maximum horsepower output when compared to conventional inline, “V”, “VR”, “W”, “X”, opposed, boxer, flat, and/or radial piston constructions. The internal combustion engines 100 using the uniblock 102 can have reduced volume and/or weight per maximum horsepower output compared to radial engine constructions, including older engine constructions, such as Wankel engines, and newer engine constructions, including liquid piston and related constructions. The internal combustion engine 100 using the uniblock 102 can have reduced volume and/or weight per maximum horsepower output compared to the majority of gas turbine engines.

This consistently reduced volume and/or weight per maximum horsepower outputs means that some configurations of the internal combustion engine 100 using the uniblock 102 are well suited for applications where small size and/or weight for given power outputs are desirable, such as, in air transportation vehicles. In another example, the internal combustion engine 100 using the uniblock 102 can be paired with an electric motor in a hybrid drive vehicle (e.g., which can include use as a range extender in an electric vehicle), including in air transportation vehicles. In yet another example, the internal combustion engine 100 using the uniblock 102 can provide benefits in engine retrofit applications where reduced size and/or weight provides case of use and flexibility in retrofit applications, such as when owners of existing vehicles desire increased efficiency, reduced emissions, and/or increased power.

In some configurations, the internal combustion engine 100 using the uniblock 102 can have reduced piston speed for a given horsepower as compared with some other reciprocating engines, which can offer several benefits. For example, reduced piston speeds in the internal combustion engine 100 using the uniblock 102 can help reduce engine failures, increase durability, and/or increase maintenance intervals, which may make such engines more suitable for continuous use or for use in aircrafts.

While increased compression ratios can be one advantage of the internal combustion engines 100 using the uniblock 102, there can also be other advantages in addition or alternatively to achieving higher compression ratios. For example, in some configurations, the uniblock 102 provides more flexibility in the placement of fuel injectors, spark plugs, and the like because there is no seam between a cylinder head and a cylinder block. For example, in an engine design with a separable cylinder head and cylinder block, it can be important to avoid the seam between the cylinder head and the cylinder block because interfering with the seam could compromise sealing, structural integrity, or both. The internal combustion engine 100 that uses the uniblock 102, as compared to conventional engines, allows for many additional advantages, including better lubrication, better balance, better heat management, and/or smaller and lighter engines for any given power input.

The uniblock 102 can be formed using any suitable technique and using any suitable materials. For example, materials can be chosen for particular use cases. In some configurations, the uniblock 102 can be manufactured from various metals and/or alloys, including but not limited to aluminum or aluminum alloys, which can reduce weight of the internal combustion engine 100 using the uniblock 102 relative to conventional engines having similar horsepower output. As another example, the uniblock 102 can be manufactured from iron, for example, but without limitation, which can offer increased strength, reduced cost, or both.

When viewed in a cross-section taken normal to the axis of rotation of the two crankshafts 112, the uniblock 102 can have a generally triangular shape in some configurations. For example, the portion of the uniblock 102 housing the two crankshafts 112 (e.g., the crank portion 103) can be larger than the portion of the uniblock 102 housing the valve train 120 (e.g., the valve portion 105), and the uniblock 102 can taper between the crank portion 103 and the valve portion 105. As a result of this generally triangular construction, forces can be directed toward the center of the uniblock 102. The generally triangular shape of the uniblock 102 also provides suitable strength and/or enables case of production. Advantageously, the generally triangular shape of the uniblock 102 can provide an advantage in the relationship between the stroke volume and the engine volume.

The geometry of the uniblock 102 can enable multiple ways of implementing constructions featuring two pistons 110 that are arranged in opposed relationships. Such opposed relationships are described further in PCT Application No. US2024/015639.

In the illustrated configurations, the axis along which the pistons 110 reciprocate does not intersect with the either of the two crankshafts 112. In an “opposed balanced” construction (see e.g., internal combustion engine 100E in FIG. 8), both of the two pistons 110 can be at top dead center at the same time. In such a construction, because the pistons 110 move along the same central axis, forces are better balanced. In an “opposed compact” construction, the pistons 110 can offset each other with one piston 110 being at top dead center when the other piston 110 is at bottom dead center. In both cases, and depending on the number of pistons, primary, secondary, and/or rocking forces may be substantially or completely canceled, which can improve the overall balance of the internal combustion engine 100 using the uniblock 102. According to some configurations, in the opposed balanced constructions, the primary, secondary, and/or rocking forces can be canceled with any even number of the pistons 110, including two pistons 110, while the opposed pistons 110 operate in a synchronized manner such that they are at the same point in the cycle at the same time. According to some configurations, an “opposed compact” construction can provide a significant space advantage.

In some configurations, an “opposed compact” construction can utilize captive free pistons, which may offer improved space and/or weight savings as compared to an opposed compact construction that is not using the captive free piston construction for a given engine stroke volume. In some configurations, the captive free piston may provide benefits such as, for example, reducing forces that go into connecting rods and/or crankshafts. For example, during an expansion stage of a cycle of one piston, forces can be transmitted to the opposing piston, which is in a compression stage of a cycle. In some configurations, the captive free piston engine according to some configurations herein can have improved balance as compared to some other engines.

In some configurations (e.g., dual crankshafts or quad crankshafts in the case of a captured free piston design), the internal combustion engines can result in a highly balanced configuration due to, not only the counterrotating nature of the dual crankshafts, but also the balanced motions of pairs of connecting rods.

Inline constructions also are contemplated. According to some configurations, an inline construction can have a downward stroke (e.g., from top dead center to bottom dead center) that is a greater percentage of a cycle than an upward stroke (e.g., from bottom dead center to top dead center). Such an approach can result in a power stroke that is more than half of the cycle, which can occur in both two-stroke and four-stroke engine constructions. For example, there can be more degrees of power per cycle. In the two-stroke engine variant, this arrangement can enable continuous power and/or substantial power overlap, even if only two cylinders are used.

Preferably, if there are multiple cylinder bores 106, which may be positioned side-by-side, then center to center spacing between the cylinder bores 106 can be between about 10% and about 20% (e.g., from 10% to 20%) of the diameter of the cylinder bores 106. In some configurations, the center to center spacing of the cylinder bores 106 can be greater than 20%. In some configurations, the spacing between the cylinder bores 106 can be less than 10%. In some configurations, the spacing can be between about 5% to about 10%. The spacing between the cylinder bores 106 can provide space between cylinder bores 106 for cylinder liners, crank bearings, cam bearings, and so forth. When calculating the percentage of the diameter of the cylinder bore 106, the diameter is calculated as narrowed by any cylinder liner.

### Internal Combustion Engine Construction

As described above, the internal combustion engine 100 and the other internal combustion engines described with reference to FIGS. 1A-25 can include a uniblock construction (e.g., the uniblock 102 of the internal combustion engine 100), which can provide numerous advantages. In some configurations, it may be desirable to have modified engine constructions that can include additional components forming part of the uniblock or to not include the uniblock at all. For example, the various benefits of the configurations described herein can be achieved when incorporated into conventional engine designs that do not include a uniblock.

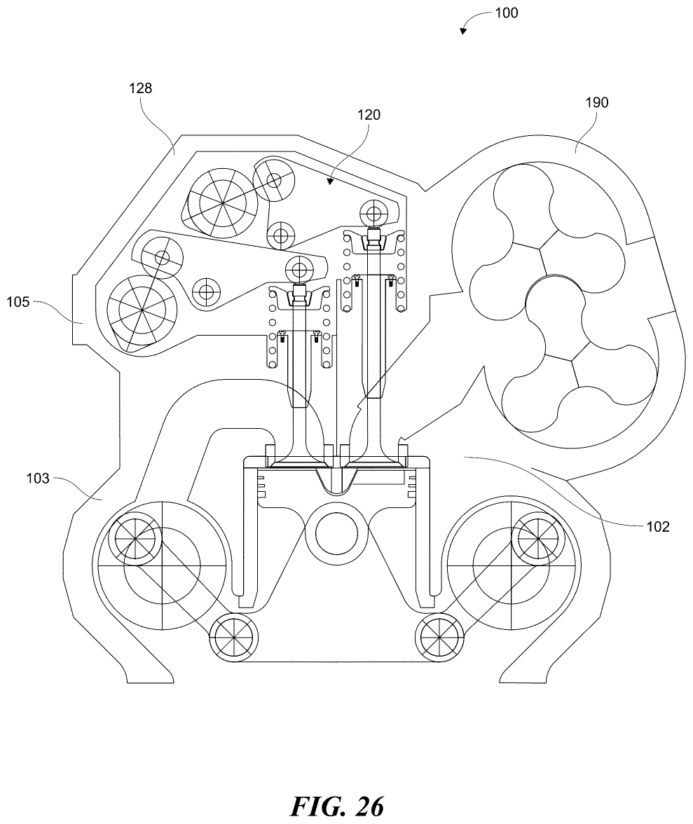

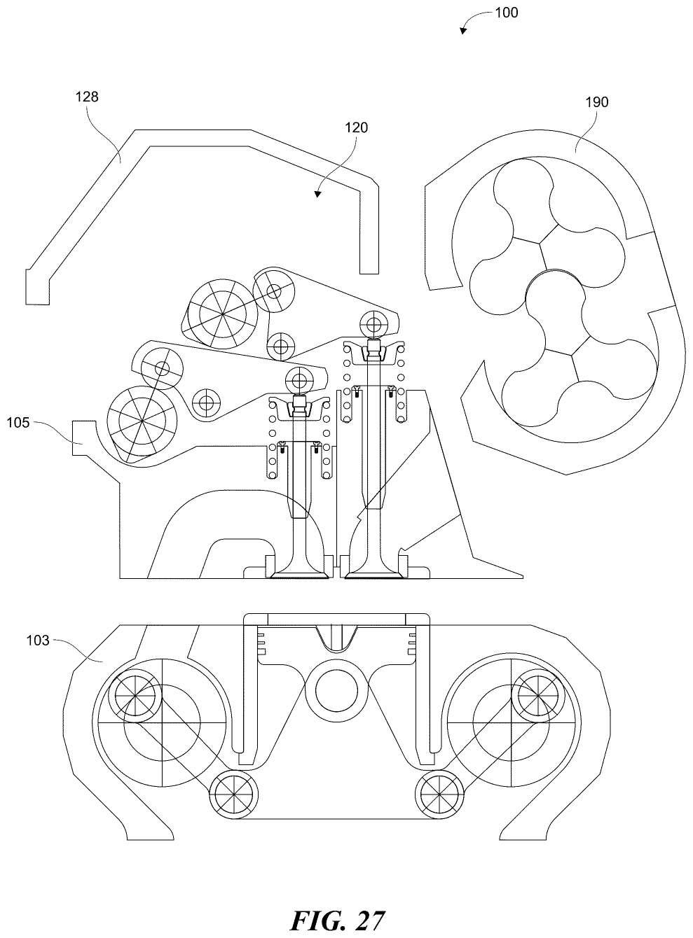

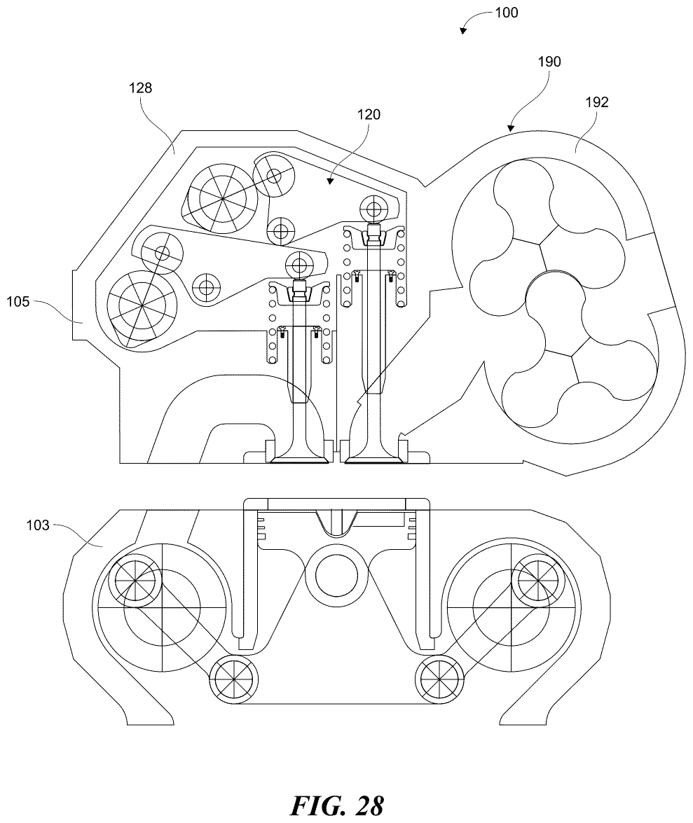

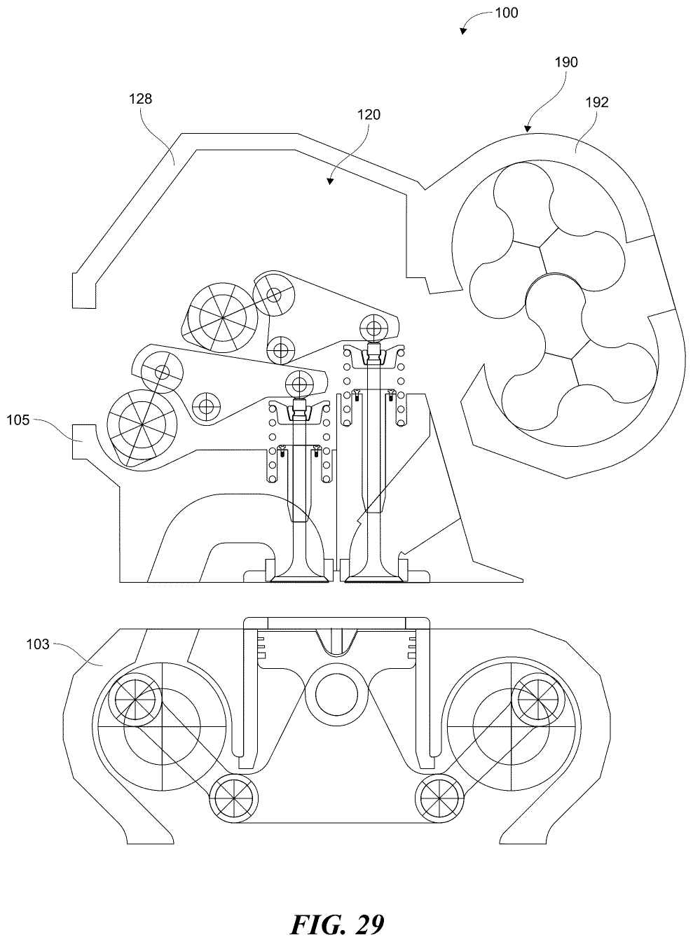

FIGS. 26-32 illustrate alternative engine constructions that can be used in the internal combustion engine 100. While particular reference is made to the internal combustion engine 100, it is understood the following configurations in FIGS. 26-32 can be implemented in other internal combustion engines described with reference to FIG. 1A-25. Further, the configurations in FIGS. 26-32 can be implemented in any of the internal combustion engines described in PCT Application No. US2024/015639. The added piston 150 and associated components are not shown in FIGS. 26-32 for illustrative purposes but may be included in some configurations of the internal combustion engine 100.

FIG. 26 shows one configuration of the internal combustion engine 100. As shown, the internal combustion engine 100 can include a scavenging pump 190. The scavenging pump 190 can be a scavenging blower, supercharger, turbocharger, and/or the like in other configurations. The scavenging pump 190 can be housed in a pump housing 192. The pump housing 192 is configured to contain the scavenging pump 190 and direct the air flow generated by the scavenging pump 190.

In the configuration of FIG. 26, the internal combustion engine 100 can include the uniblock 102 that includes the valve train cover 128 and the pump housing 192. For example, what would be considered the valve train cover and the pump housing in conventional reciprocating internal combustion engines are integrated into a single component to define at least a portion of the uniblock 102. The uniblock 102 in FIG. 26 also includes the crank portion 103 and the valve portion 105, as described herein. In such a configuration, the uniblock 102 can define locations for the components of the valve train 120, and/or enclose, envelop, and/or surround the valve train 120. Similarly, the uniblock 102 can form the pump housing 192 and can enclose, envelop, and/or surround the scavenging pump 190.

As shown in FIGS. 27-29, in some configurations, the internal combustion engine 100 may not include the uniblock 102. For example, the crank portion 103 may define the cylinder block and the valve portion 105 may define cylinder head of the internal combustion engine 100. In the configuration of FIG. 27, the valve train cover 128 and the pump housing 192 can also be separate from the valve portion 105. For example, the valve portion 105 can be mounted to the crank portion 103 and the valve train cover 128 and pump housing 192 can be mounted to the 105.

As shown in FIG. 28, in some configurations, the valve train cover 128 and the pump housing 192 can form part of the valve portion 105.

As shown in FIG. 29, in some configurations the valve train cover 128 and pump housing 192 can form one component that can be mounted to the valve portion 105.

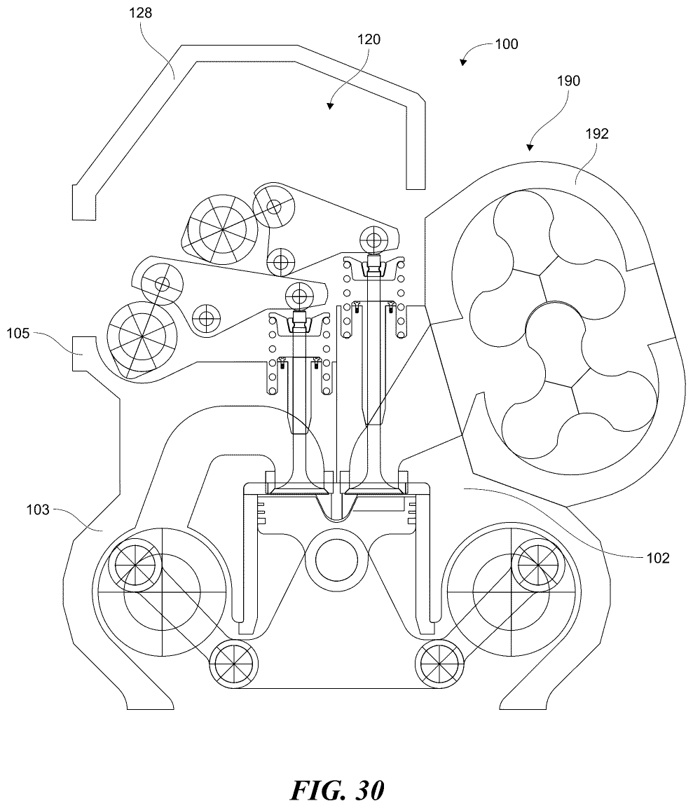

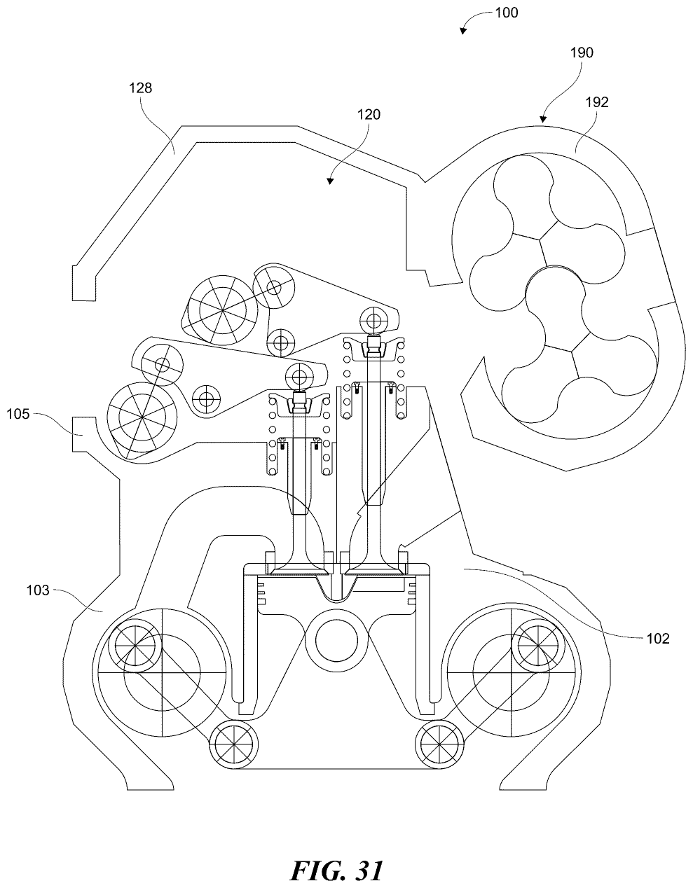

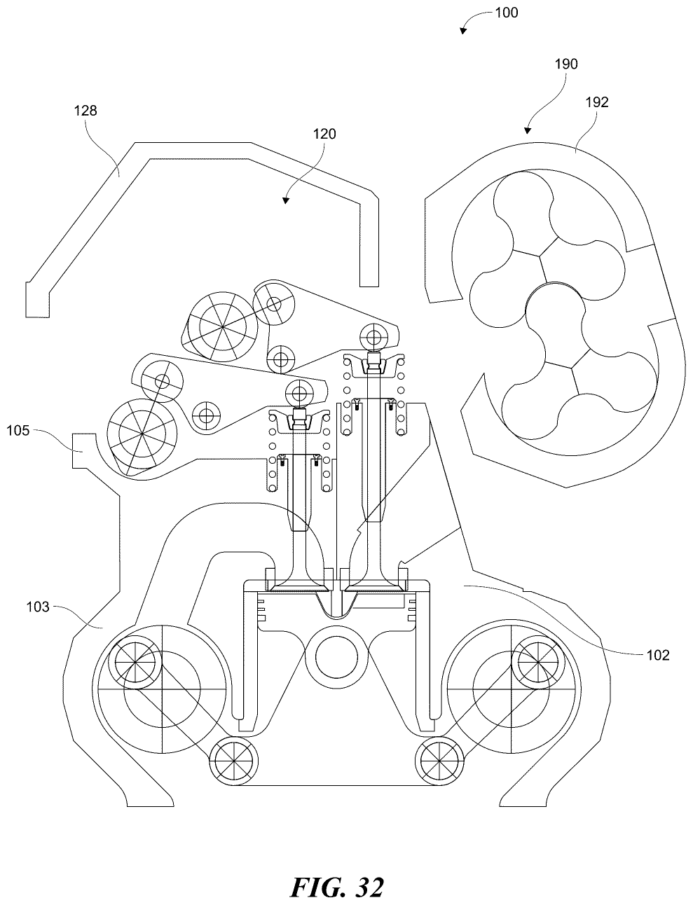

As shown in FIGS. 30-32, in configurations of the internal combustion engine 100 that include the uniblock 102, the uniblock 102 can define one, both, or neither of the valve train cover 128 and the pump housing 192. For example, in the configuration of FIG. 30, the uniblock 102 defines the pump housing 192. In such a configuration, the valve train cover 128 can be coupled to the valve portion 105. In the configuration of FIG. 31, the valve train cover 128 and the pump housing 192 may comprise a single component that can be mounted to the uniblock 102. In the configuration of FIG. 32, both the valve train cover 128 and the pump housing 192 are separate from each other and the uniblock 102 and can be individually mounted to the uniblock 102.

### Additional Embodiments

Clause 1. A piston comprising: a piston body formed of a first portion and a second portion, the second portion comprising: a crown; and an outer wall, the outer wall having a perimeter defined by a first circle overlapping with a second circle.

Clause 2. The piston of clause 1, wherein the first circle and the second circle have a same radius.

Clause 3. The piston of clause 1 or clause 2, wherein the first circle has a first radius and the second circle has a second radius, the first radius different than the second radius.

Clause 4. The piston of any of clauses 1 to 3, further comprising a top plate, the top plate coupled to the crown.

Clause 5. The piston of any of clauses 1 to 4, wherein the first portion is configured to allow the piston to be coupled to a crosshead or one or more connecting rods.

Clause 6. The piston of any of clauses 1 to 5, wherein the piston body comprises a rigid material.

Clause 7. The piston of any of clauses 1 to 6, wherein the piston body is manufactured by at least one of casting, additive manufacturing, or subtractive manufacturing.

Clause 8. The piston of any of clauses 1 to 7, wherein the second portion of the piston body comprises: a first partial cylinder portion comprising: a first outer side; and a first inner side; and a second partial cylinder portion comprising: a second outer side; and a second inner side, the first outer side and the second outer side defining the perimeter of the outer wall.

Clause 9. The piston of clause 8, wherein the first inner side is in contact with the second inner side.

Clause 10. The piston of clause 8 or clause 9, wherein the first inner side is flat and the second inner side is flat.

Clause 11. The piston of any of clauses 8 to 10, wherein the first partial cylinder portion is coupled to the second partial cylinder portion using one or more fasteners, using welding, brazing, or soldering, or using an adhesive.

Clause 12. The piston of any of clauses 8 to 11, wherein the first partial cylinder portion is coupled to the second partial cylinder portion using one or more alignment pins and/or dowels.

Clause 13. The piston of any of clauses 8 to 12, wherein the outer wall comprises one or more grooves extending around its perimeter, each groove of the one or more grooves configured to receive two piston rings that are partial-circle shaped.

Clause 14. The piston of any of clauses 1 to 13, wherein the piston is configured to reciprocate in a combustion chamber of an internal combustion chamber.

Clause 15. The piston of any of clauses 1 to 13, wherein the piston is configured to act as a scavenging pump in an internal combustion chamber.

Clause 16. The piston of any of clauses 1 to 15, wherein the second portion further comprises one or more one-way valves configured to allow fluid to flow in one direction through the piston while preventing back flow.

Clause 17. The piston of clause 16, wherein the one or more one-way valves are aligned with a reciprocating axis of the piston.

Clause 18. The piston of clause 16 or clause 17, wherein the one or more one-way valves comprise poppet valves, rotary valves, one-way ball valves, or reed valves.

Clause 19. The piston of any of clauses 16 to 18, wherein the one or more one-way valves comprises a first set of one-way valves and a second set of one-way valves, the first set of one-way valves disposed on a first side of the piston, the second set of one-way valves disposed on a second side of the piston.

Clause 20. The piston of clause 19, wherein the first set of one-way valves comprises nine one-way valves and/or the second set of one-way valves comprises nine one-way valves.

Clause 21. An internal combustion engine comprising: a block, the block defining a bore comprising: a first partial cylinder bore portion; and a second partial cylinder bore portion; and a piston capable of reciprocating within the bore between top dead and bottom dead center, the piston comprising: a piston body comprising: a piston head having a perimeter defined by a first circle overlapping with a second circle; and a piston wall extending from the perimeter of the piston head.

Clause 22. The internal combustion engine of clause 21, wherein the piston body comprises a rigid material.

Clause 23. The internal combustion engine of clause 21 or clause 22, wherein the piston is manufactured by at least one of casting, additive manufacturing, or subtractive manufacturing.

Clause 24. The internal combustion engine of any of clauses 21 to 23, wherein the piston body comprises: a first partial cylinder portion comprising: a first round side; and a first flat side; and a second partial cylinder portion comprising: a second round side, the second round side and the first round side defining a perimeter of the piston wall; and a second flat side, the second flat side aligned with the first flat side.

Clause 25. The internal combustion engine of clause 24, wherein the first partial cylinder portion is coupled to the second partial cylinder portion using one or more fasteners.

Clause 26. The internal combustion engine of clause 24, wherein the first partial cylinder portion is coupled to the second partial cylinder portion using welding, brazing, or soldering.

Clause 27. The internal combustion engine of clause 24, wherein the first partial cylinder portion is bonded to the second partial cylinder portion by using an adhesive.

Clause 28. The internal combustion engine of any of clauses 24 to 27, wherein the first partial cylinder portion is coupled to the second partial cylinder portion using one or more alignment pins and/or dowels.

Clause 29. The internal combustion engine of any of clauses 21 to 28, wherein the piston body comprises one or more grooves extending into the piston wall around its perimeter, each groove of the one or more grooves configured to receive two piston rings that are partial-circle shaped.

Clause 30. The internal combustion engine of any of clauses 21 to 29, further comprising: a first crankshaft, the first crankshaft configured to rotate within a first passage at least partially defined within the block.

Clause 31. The internal combustion engine of clause 30, wherein the piston is connected to the first crankshaft by a first connecting rod.

Clause 32. The internal combustion engine of clause 30 or clause 31, further comprising: a second crankshaft, the second crankshaft configured to rotate within a second passage at least partially defined within the block; and a second connecting rod, the second connecting rod connecting the second crankshaft to the piston.

Clause 33. The internal combustion engine of clause 30, further comprising: a crosshead, the first crankshaft connected to the crosshead by a first connecting rod.

Clause 34. The internal combustion engine of clause 33, wherein the piston is coupled to the crosshead.

Clause 35. The internal combustion engine of clause 33, wherein the piston is connected to the crosshead by a second connecting rod, the piston configured to articulate relative to the crosshead.

Clause 36. The internal combustion engine of any of clauses 30 to 35, wherein a first crank axis is defined by a central axis of the first crankshaft and wherein a long axis of the piston head is at a 90-degree angle relative to the first crank axis.

Clause 37. The internal combustion engine of any of clauses 30 to 35, wherein a first crank axis is defined by a central axis of the first crankshaft and wherein a long axis of the piston head is parallel to the first crank axis.

Clause 38. An internal combustion engine comprising: a block, the block defining a primary bore; an additional housing, the additional housing defining a first added bore, the additional housing coupled to the block; a crankshaft, the crankshaft configured to rotate within a passage at least partially defined within the block; a crosshead, the crosshead connected to the crankshaft by a first connecting rod; a primary piston capable of reciprocating within the primary bore between top dead and bottom dead center, the primary piston coupled to the crosshead and positioned on a first side of the crosshead; and a first added piston capable of reciprocating within the first added bore between top dead and bottom dead center, the first added piston comprising a first added piston body and a first added piston head, the first added piston coupled to the crosshead and positioned on a second side of the crosshead, the second side opposite the first side.

Clause 39. The internal combustion engine of clause 38, wherein the primary bore is cylindrical.

Clause 40. The internal combustion engine of clause 38, wherein the primary bore is oval, and wherein a perimeter of a primary piston head of the primary piston is oval.

Clause 41. The internal combustion engine of clause 38, wherein the primary bore is oblong-shaped, and wherein a perimeter of a primary piston head of the primary piston is oblong-shaped.

Clause 42. The internal combustion engine of clause 38, wherein the primary bore comprises a first partial cylinder bore portion and a second partial cylinder bore portion, and wherein a primary piston head of the primary piston has a perimeter defined by a first circle overlapping with a second circle.

Clause 43. The internal combustion engine of any of clauses 38 to 42, wherein the first added bore is cylindrical and wherein a perimeter of the first added piston head is circular.

Clause 44. The internal combustion engine of any of clauses 38 to 42, wherein a first perimeter of the first added bore is oblong-shaped and wherein a second perimeter of the first added piston head is oblong-shaped.

Clause 45. The internal combustion engine of any of clauses 38 to 42, wherein a first perimeter of the first added bore is oval and wherein a second perimeter of the first added piston head is oval.

Clause 46. The internal combustion engine of any of clauses 38 to 42, wherein the first added bore comprises a third partial cylinder bore portion and a fourth partial cylinder bore portion, and wherein the first added piston head has a perimeter defined by a third circle overlapping with a fourth circle.

Clause 47. The internal combustion engine of any of clauses 38 to 46, further comprising: a second added piston capable of reciprocating within a second added bore defined within the additional housing between top dead and bottom dead center, the second added piston coupled or connected to the crosshead and positioned on the second side of the crosshead.

Clause 48. The internal combustion engine of clause 47, wherein the second added bore is adjacent and parallel to the first added bore, wherein a first web separates the first added bore from the second added bore.

Clause 49. The internal combustion engine of clause 47 or clause 48, further comprising: a third added piston capable of reciprocating within a third added bore defined within the additional housing between top dead and bottom dead center, the third added piston coupled or connected to the crosshead and positioned on the second side of the crosshead.

Clause 50. The internal combustion engine of clause 49, wherein the third added bore is adjacent and parallel to the second added bore, wherein a second web separates the third added bore from the second added bore.

Clause 51. The internal combustion engine of any of clauses 38 to 50, wherein the first added piston is coupled to the crosshead by a second connecting rod, the second connecting rod configured to allow the first added piston to articulate relative to the crosshead.

Clause 52. The internal combustion engine of any of clauses 38 to 50, wherein the first added piston is coupled to the crosshead by one or more fasteners such that the first added piston does not articulate relative to the crosshead.

Clause 53. The internal combustion engine of any of clauses 38 to 50, wherein the first added piston and the crosshead are formed of a single component.

Clause 54. An internal combustion engine comprising: a block comprising: an upper bore; a first crankshaft containing passage; a second crankshaft containing passage; and a central recess, the first crankshaft containing passage and second crankshaft containing passage in fluid communication with the central recess; a lower housing, the lower housing coupled to the block below the central recess; a first crankshaft, the first crankshaft configured to rotate within the first crankshaft containing passage; a second crankshaft, the second crankshaft configured to rotate within the second crankshaft containing passage; a crosshead, the crosshead connected to the first crankshaft by a first connecting rod, the crosshead connected to the second crankshaft by a second connecting rod, at least a portion of the crosshead positioned within the central recess; and an upper piston capable of reciprocating within the upper bore between top dead and bottom dead center, the upper piston coupled to the crosshead and positioned above the crosshead.

Clause 55. The internal combustion engine of clause 54, wherein the crosshead extends at least partially into the lower housing when the upper piston is at bottom dead center.

Clause 56. The internal combustion engine of clause 54 or clause 55, further comprising: at least one stabilizing member, the at least one stabilizing member extending from the lower housing towards the upper bore, wherein the crosshead further comprises at least one channel configured to receive the at least one stabilizing member, wherein the at least one stabilizing member remains at least partially within the at least one channel as the upper piston moves between top dead center and bottom dead center.

Clause 57. The internal combustion engine of clause 56, wherein the at least one stabilizing member is coupled to the lower housing.

Clause 58. The internal combustion engine of clause 56, wherein the at least one stabilizing member is integrally formed with the lower housing.

Clause 59. The internal combustion engine of any of clauses 56 to 58, wherein the at least one stabilizing member has a cross section that is circular, square, or rectangular.

Clause 60. The internal combustion engine of clause 54 or clause 55, wherein the crosshead further comprises a first crosshead portion and a second crosshead portion, the first crosshead portion coupled to the second crosshead portion with a gap therebetween.

Clause 61. The internal combustion engine of clause 60, further comprising: a stabilizing plate, the stabilizing plate extending from the lower housing towards the upper bore, the stabilizing plate extending through the gap between the first crosshead portion and the second crosshead portion as the upper piston moves between top dead center and bottom dead center.

Clause 62. The internal combustion engine of clause 61, wherein the stabilizing plate is coupled to the lower housing.

Clause 63. The internal combustion engine of clause 61, wherein the stabilizing plate is integrally formed with the lower housing.

Clause 64. The internal combustion engine of clause 54 or clause 55, further comprising: a stabilizing pin, the stabilizing pin extending through the crosshead; and a first guide and a second guide, the stabilizing pin extending between the first guide and the second guide.

Clause 65. The internal combustion engine of clause 64, wherein the first guide comprises a first groove configured to receive a first end of the stabilizing pin, and the second guide comprises a second groove configured to receive a second end of the stabilizing pin.

Clause 66. The internal combustion engine of clause 65, wherein a first roller is coupled to the first end of the stabilizing pin and a second roller is coupled to the second end of the stabilizing pin.

Clause 67. The internal combustion engine of any of clauses 64 to 66, wherein the first guide comprises a first guidepost and the second guide comprises a second guidepost, the first guidepost and the second guidepost coupled to the lower housing.

Clause 68. The internal combustion engine of any of clauses 64 to 66, wherein the first guide is formed in a first side of the lower housing and the second guide is formed in a second side of the lower housing, the first side opposite the second side.

Clause 69. The internal combustion engine of any of clauses 54 to 68, wherein the block further comprises an intake passage, the intake passage extending from the first crankshaft containing passage to a combustion chamber defined by the upper bore.

Clause 70. The internal combustion engine of any of clauses 54 to 69, wherein the block further comprises a block intake port, the block intake port extending from the second crankshaft containing passage through the block.

Clause 71. The internal combustion engine of clause 70, further comprising a one-way valve, the one-way valve positioned in the block intake port, the one-way valve configured to allow fluid to flow in one direction into the second crankshaft containing passage while preventing backflow.

Clause 72. The internal combustion engine of clause 71, wherein the one-way valve comprises a poppet valve, a rotary valve, a one-way ball valve, or a reed valve.

Clause 73. The internal combustion engine of any of clauses 69 to 72, wherein the block further comprises an exhaust passage, the exhaust passage extending from the combustion chamber through the block, the exhaust passage configured to direct exhaust gases away from the combustion chamber.

Clause 74. The internal combustion engine of any of clause 73, further comprising a turbocharger, the turbocharger configured to receive exhaust gases from the combustion chamber.

Clause 75. The internal combustion engine of any of clauses 54 to 74, further comprising a lower piston, the lower piston comprising a lower piston head, the lower piston capable of reciprocating within a lower chamber defined by a lower bore defined within the lower housing.

Clause 76. The internal combustion engine of clause 75, wherein the lower piston is coupled to the crosshead and positioned below the crosshead.

Clause 77. The internal combustion engine of clause 75, wherein the lower piston is connected to the crosshead by a third connecting rod, the lower piston configured to articulate relative to the crosshead.

Clause 78. The internal combustion engine of any of clauses 75 to 77, wherein the lower housing further comprises a housing intake port, the housing intake port extending through the lower housing into the lower chamber.

Clause 79. The internal combustion engine of clause 78, further comprising a one-way valve positioned in the housing intake port, the one-way valve configured to allow fluid to flow in one direction into the lower chamber while preventing backflow.

Clause 80. The internal combustion engine of clause 79, wherein the one-way valve comprises a poppet valve, a rotary valve, a one-way ball valve, or a reed valve.

Clause 81. The internal combustion engine of any of clauses 75 to 80, wherein the lower piston further comprises a piston port, the piston port extending through the lower piston head.

Clause 82. The internal combustion engine of clause 81, wherein the lower piston further comprises a one-way valve positioned in the piston port, the one-way valve configured to allow fluid to flow in one direction from the lower chamber into the central recess while preventing backflow.

Clause 83. The internal combustion engine of clause 82, wherein the one-way valve comprises a poppet valve, a rotary valve, a one-way ball valve, or a reed valve.

Clause 84. The internal combustion engine of any of clauses 54 to 68 or clauses 75 to 81, wherein the block further comprises an intake passage, the intake passage extending through the block to a combustion chamber defined by the upper bore.

Clause 85. The internal combustion engine of clause 84, wherein the lower housing further comprises a housing outlet port, the housing outlet port extending through the lower housing into the lower chamber.

Clause 86. The internal combustion engine of clause 85, further comprising a one-way valve positioned in the housing outlet port, the one-way valve configured to allow fluid to flow in one direction out of the lower chamber while preventing backflow.

Clause 87. The internal combustion engine of clause 86, wherein the one-way valve comprises a poppet valve, a rotary valve, a one-way ball valve, or a reed valve.

Clause 88. The internal combustion engine of clause 85, further comprising an inlet feed pipe, the inlet feed pipe extending from the housing outlet port to the intake passage, the inlet feed pipe configured to allow fluid flow from the lower chamber to the combustion chamber.

Clause 89. The internal combustion engine of any of clauses 54 to 88, wherein the upper bore is cylindrical.

Clause 90. The internal combustion engine of any of clauses 54 to 88, wherein the upper bore is oval, and wherein a perimeter of an upper piston head of the upper piston is oval.

Clause 91. The internal combustion engine of any of clauses 54 to 88, wherein the upper bore is oblong-shaped, and wherein a perimeter of an upper piston head of the upper piston is oblong-shaped.

Clause 92. The internal combustion engine of any of clauses 54 to 88, wherein the upper bore comprises a first partial cylinder bore portion and a second partial cylinder bore portion, and wherein an upper piston head of the upper piston has a perimeter defined by a first circle overlapping with a second circle.

Clause 93. The internal combustion engine of any of clauses 75 to 92, wherein the lower bore is cylindrical and wherein a perimeter of the lower piston head is circular.

Clause 94. The internal combustion engine of any of clauses 75 to 92, wherein a first perimeter of the lower bore is oblong-shaped and wherein a second perimeter of the lower piston head is oblong-shaped.

Clause 95. The internal combustion engine of any of clauses 75 to 92, wherein a first perimeter of the lower bore is oval and wherein a second perimeter of the lower piston head is oval.

Clause 96. The internal combustion engine of any of clauses 75 to 92, wherein the lower bore comprises a third partial cylinder bore portion and a fourth partial cylinder bore portion, and wherein the lower piston head has a perimeter defined by a third circle overlapping with a fourth circle.

Clause 97. The internal combustion engine of any of clauses 84 to 96, wherein the lower piston is configured to compress fluid within the lower chamber, the combustion chamber configured to receive the compressed fluid.

Clause 98. The internal combustion engine of any of clauses 54 to 97, wherein the block comprises a crank portion and a valve portion, the valve portion positioned above the crank portion, the valve portion at least partially housing a valve train, the crank portion at least partially housing a combustion chamber defined by the upper bore.

Clause 99. The internal combustion engine of clause 98, wherein the valve portion is coupled to the crank portion.

Clause 100. The internal combustion engine of clause 98, wherein the valve portion and the crank portion are integrally formed.

Clause 101. The internal combustion engine of any of clauses 98-100, further comprising a valve train cover, wherein one or more components of the valve train are positioned below the valve train cover.

Clause 102. The internal combustion engine of clause 101, wherein the valve train cover is coupled to the valve portion.

Clause 103. The internal combustion engine of clause 101, wherein the valve train cover and the valve portion are integrally formed.

Clause 104. The internal combustion engine of any of clauses 98-103, further comprising a scavenging pump and a pump housing, the scavenging pump configured to receive exhaust fluid from the combustion chamber, the scavenging pump at least partially housed within the pump housing.

Clause 105. The internal combustion engine of clause 104, wherein the pump housing is integrally formed with the valve portion.

Clause 106. The internal combustion engine of clause 104 or clause 105, wherein the pump housing is integrally formed with the valve train cover.

Clause 107. The internal combustion engine of any of clauses 54 to 68 or clauses 75 to 83 or clauses 89 to 106, further comprising: an intake passage configured to direct fluid to the combustion chamber, the intake passage comprising: a main branch extending from the combustion chamber; a first intake branch extending at least partially through the block, the first intake branch in fluid communication with the main branch, the first intake branch configured to direct fluid from outside the block to the main branch; and a second intake branch extending from the first crankshaft containing passage to at least one of the first intake branch and the main branch, the second intake branch configured to direct fluid from the first crankshaft containing passage to the main branch.

Clause 108. The internal combustion engine of clause 107, wherein the first intake branch is configured to receive a first passage plug, the first passage plug comprising: a blocked first end; an open second end; and a channel extending between the open second end and a wall of the first passage plug, wherein the channel is aligned with the second intake branch when the first passage plug is inserted in the first intake branch, the first passage plug configured to prevent fluid from entering the main branch through the first intake branch.

Clause 109. The internal combustion engine of clause 107, wherein the first intake branch is configured to receive a second passage plug, the second passage plug comprising: an open first end; an open second end; and a channel extending between the open first end and the open second end, wherein the channel is axially aligned with the first intake branch when the second passage plug is inserted in the first intake branch, the second passage plug configured to prevent fluid from entering the main branch through the second intake branch.

Clause 110. An internal combustion engine comprising: a first block comprising: a first primary bore; a first passage; and a first central recess, the first passage in fluid communication with the first central recess; a first crankshaft, the first crankshaft configured to rotate within the first passage; a first crosshead, the first crosshead connected to the first crankshaft by a first connecting rod, at least a portion of the first crosshead positioned within the first central recess; a first primary piston capable of reciprocating within the first primary bore between top dead and bottom dead center, the first primary piston coupled to the first crosshead; a second block comprising: a second primary bore; a second passage; and a second central recess, the second passage in fluid communication with the second central recess; a second crankshaft, the second crankshaft configured to rotate within the second passage; a second crosshead, the second crosshead connected to the second crankshaft by a second connecting rod, at least a portion of the second crosshead positioned within the second central recess; a second primary piston capable of reciprocating within the second primary bore between top dead and bottom dead center, the second primary piston coupled to the second crosshead; and a central housing, the central housing positioned between the first block and the second block.

Clause 111. The internal combustion engine of clause 110, further comprising: a first auxiliary piston, the first auxiliary piston coupled to or connected via a third connecting rod to the first crosshead, the first auxiliary piston on an opposite side of the first crosshead than the first primary piston.

Clause 112. The internal combustion engine of clause 111, wherein the central housing further comprises a first auxiliary chamber, the first auxiliary piston capable of reciprocating within the first auxiliary chamber.

Clause 113. The internal combustion engine of any of clauses 110 to 112, further comprising: a second auxiliary piston, the second auxiliary piston coupled to or connected via a fourth connecting rod to the second crosshead, the second auxiliary piston on an opposite side of the second crosshead that the second primary piston.

Clause 114. The internal combustion engine of clause 113, wherein the central housing further comprises a second auxiliary chamber, the second auxiliary piston capable of reciprocating within the second auxiliary chamber.

Clause 115. The internal combustion engine of clause 114, wherein the central housing further comprises an internal wall, the internal wall separating the first auxiliary chamber and the second auxiliary chamber.

Clause 116. The internal combustion engine of clause 114 or clause 115, wherein the central housing further comprises an intake port, the intake port extending into at least one of the first auxiliary chamber and the second auxiliary chamber.

Clause 117. The internal combustion engine of clause 116, further comprising a first one-way valve, the first one-way valve positioned in the intake port, the first one-way valve configured to allow fluid to flow in one direction into at least one of the first auxiliary chamber and the second auxiliary chamber while preventing backflow.

Clause 118. The internal combustion engine of clause 116 or clause 117, wherein the central housing further comprises an outlet port, the outlet port extending into at least one of the first auxiliary chamber and the second auxiliary chamber.

Clause 119. The internal combustion engine of clause 118, further comprising a second one-way valve, the second one-way valve positioned in the outlet port, the second one-way valve configured to allow fluid to flow in one direction out of at least one of the first auxiliary chamber and the second auxiliary chamber while preventing backflow.

Clause 120. The internal combustion engine of clause 118 or clause 119, further comprising a conduit, the conduit connected at a first end to the outlet port and at a second end to an intake passage in the first block, the intake passage extending through the first block to a first combustion chamber defined by the first primary bore.

Clause 121. The internal combustion engine of clause 118 or clause 119, further comprising a conduit comprising: a first end connected to the outlet port; a second end connected to a first intake passage in the first block, a first branch extending between the first end and the second end; and a third end connected to a second intake passage in the second block, a second branch extending between the first end and the second end.

Clause 122. The internal combustion engine of clause 121, wherein the first branch is in fluid communication with the second branch.

Clause 123. The internal combustion engine of clause 121, wherein the first branch is not in fluid communication with the second branch.

Clause 124. The internal combustion engine of any of clauses 110 to 117, wherein the first block further comprises a first intake passage, the first intake passage extending from the first passage to a first combustion chamber defined by the first primary bore.

Clause 125. The internal combustion engine of clause 124, wherein the first auxiliary piston further comprises a first piston port, the first piston port extending through at least a portion of the first auxiliary piston.

Clause 126. The internal combustion engine of clause 124, further comprises a first piston valve positioned in the first piston port, the first piston valve configured to allow fluid to flow in one direction from the first auxiliary chamber into the first central recess as the first primary piston moves from top dead center to bottom dead center.

Clause 127. The internal combustion engine of any of clauses 110 to 116 or clauses 124 to 126, wherein the second block further comprises a second intake passage, the second intake passage extending from the second passage to a second combustion chamber defined by the second primary bore.

Clause 128. The internal combustion engine of clause 127, wherein the second auxiliary piston further comprises a second piston port, the second piston port extending through at least a portion of the second auxiliary piston.

Clause 129. The internal combustion engine of clause 128, further comprises a second piston valve positioned in the second piston port, the second piston valve configured to allow fluid to flow in one direction from the second auxiliary chamber into the second central recess as the second primary piston moves from top dead center to bottom dead center.

Clause 130. The internal combustion engine of any of clauses 110 to 129, wherein the first primary piston comprises a first primary piston head, and wherein: the first primary bore is cylindrical, and the first primary piston head is cylindrical; or the first primary bore is oval, and the first primary piston head is oval; or the first primary bore is oblong-shaped, and the first primary piston head is oblong-shaped; or the first primary bore comprises a first partial cylinder bore portion and a second partial cylinder bore portion, and the first primary piston head has a perimeter defined by a first circle overlapping with a second circle.

Clause 131. The internal combustion engine of any of clauses 110 to 130, wherein the second primary piston comprises a second primary piston head, and wherein: the second primary bore is cylindrical, and the second primary piston head is cylindrical; or the second primary bore is oval, and the second primary piston head is oval; or the second primary bore is oblong-shaped, and the second primary piston head is oblong-shaped; or the second primary bore comprises a third partial cylinder bore portion and a fourth partial cylinder bore portion, and the second primary piston head has a perimeter defined by a third circle overlapping with a fourth circle.

Clause 132. The internal combustion engine of any of clauses 112 to 131, wherein the first auxiliary piston comprises a first auxiliary piston head, and wherein: the first auxiliary bore is cylindrical, and the first auxiliary piston head is cylindrical; or the first auxiliary bore is oval, and the first auxiliary piston head is oval; or the first auxiliary bore is oblong-shaped, and the first auxiliary piston head is oblong-shaped; or the first auxiliary bore comprises a fifth partial cylinder bore portion and a sixth partial cylinder bore portion, and the first auxiliary piston head has a perimeter defined by a fifth circle overlapping with a sixth circle.

Clause 133. The internal combustion engine of any of clauses 114 to 132, wherein the second auxiliary piston comprises a second auxiliary piston head, and wherein: the second auxiliary bore is cylindrical, and the second auxiliary piston head is cylindrical; or the second auxiliary bore is oval, and the second auxiliary piston head is oval; or the second auxiliary bore is oblong-shaped, and the second auxiliary piston head is oblong-shaped; or the second auxiliary bore comprises a seventh partial cylinder bore portion and an eighth partial cylinder bore portion, and the second auxiliary piston head has a perimeter defined by a seventh circle overlapping with an eighth circle.

Clause 134. The internal combustion engine of clause 110, wherein the central housing further comprises: a first auxiliary cylinder, wherein a first cylinder axis of the first auxiliary cylinder is at a 90-degree angle relative to a first bore axis of the first primary bore; and a second auxiliary cylinder, wherein a second cylinder axis of the second auxiliary cylinder is at a 90-degree angle relative to a second bore axis of the second primary bore, the first auxiliary cylinder opposite the second auxiliary cylinder.

Clause 135. The internal combustion engine of clause 134, further comprising: a first auxiliary piston, the first auxiliary piston connected to the first crosshead by a third connecting rod, the first auxiliary piston capable of reciprocating within the first auxiliary cylinder.

Clause 136. The internal combustion engine of clause 135, wherein the first auxiliary piston is connected to the second crosshead by a fourth connecting rod.

Clause 137. The internal combustion engine of any of clauses 134 to 136, further comprising: a second auxiliary piston, the second auxiliary piston connected to the second crosshead by a fifth connecting rod, the second auxiliary piston capable of reciprocating within the second auxiliary cylinder.

Clause 138. The internal combustion engine of clause 137, wherein the second auxiliary piston is connected to the first crosshead by a sixth connecting rod.

Clause 139. The internal combustion engine of any of clauses 134 to 138, wherein the first crosshead is configured to extend at least partially into the central housing when the first primary piston is at bottom dead center, and wherein the second crosshead is configured to extend at least partially into the central housing when the second primary piston is at bottom dead center.

Clause 140. The internal combustion engine of any of clauses 134 to 139, wherein the central housing further comprises: a first intake port, the first intake port extending into the first auxiliary cylinder; and a first outlet port, the first outlet port extending into the first auxiliary cylinder.

Clause 141. The internal combustion engine of clause 140, further comprising a first intake pipe, the first intake pipe connected at a first end to the first outlet port and at a second end to a first intake passage in the first block, the first intake passage extending through the first block to a first combustion chamber defined by the first primary bore, the first intake pipe configured to direct fluid from the first auxiliary cylinder to the first combustion chamber.

Clause 142. The internal combustion engine of any of clauses 134 to 141, wherein the central housing further comprises: a second intake port, the second intake port extending into the second auxiliary cylinder; and a second outlet port, the second outlet port extending into the second auxiliary cylinder.

Clause 143. The internal combustion engine of clause 142, further comprising a second intake pipe, the second intake pipe connected at a first end to the second outlet port and at a second end to a second intake passage in the second block, the second intake passage extending through the second block to a second combustion chamber defined by the second primary bore, the second intake pipe configured to direct fluid from the second auxiliary cylinder to the second combustion chamber.

Clause 144. A piston comprising: a piston body comprising: a first portion having a partial cylinder shape and comprising a first rounded surface; and a second portion having a partial cylinder shape and comprising a second rounded surface, the first rounded surface and the second rounded surface defining a perimeter of a wall of the piston body.

Clause 145. The piston of clause 144, wherein the first rounded surface spans a first major arc of the first portion's circumference, and wherein the second rounded surface spans a second major arc of the second portion's circumference.

Clause 146. The piston of clause 144, wherein the piston body further comprises: a piston crown at a first end of the piston body; and a connecting portion at a second end of the piston body, the first end opposite the second end.

Clause 147. The piston of clause 146, wherein the connecting portion comprises a projection extending from the first portion and the second portion of the piston body, the projection including an opening extending therethrough.

Clause 148. The piston of clause 147, wherein the opening is configured to receive a wrist pin to rotatably couple the piston to a crosshead or a connecting rod.

Clause 149. The piston of clause 144, wherein the first portion comprises a first flat side and the second portion comprises a second flat side, and wherein the first flat side is coupled to the second flat side.

Clause 150. A piston assembly comprising: a crosshead; a first piston directly or indirectly coupled to the crosshead and positioned on a first side of the crosshead; and a second piston directly or indirectly coupled to the crosshead and positioned on a second side of the crosshead.

Clause 151. The piston assembly of clause 150, wherein the crosshead and at least one of the first piston or the second piston are integrally formed with each other.

Clause 152. The piston assembly of clause 150 or clause 151, wherein the first piston comprises a body having a double-c shaped outer wall.

Clause 153. The piston assembly of clause 150 or clause 151, wherein the first piston comprises a body having a cylindrically shaped outer wall.

Clause 154. The piston assembly of any of clauses 150 to 153, wherein the second piston comprises a body having a cylindrically shaped outer wall.

Clause 155. The piston assembly of any of clauses 150 to 153, wherein the second piston comprises a body having a double-c shaped outer wall.

Clause 156. The piston assembly of any of clauses 150 to 155, wherein the crosshead comprises a first crosshead portion and a second crosshead portion, the first crosshead portion spaced apart from the second crosshead portion to define a gap therebetween.

Clause 157. The piston assembly of clause 156, wherein the first crosshead portion comprises a first portion having a triangular shape and a second portion extending from a lower end of the first portion, the second portion having an obround shape.

Clause 158. The piston assembly of clause 156 or clause 157, wherein each of the first crosshead portion and the second crosshead portion comprises a first piston opening, wherein the first piston is configured to be coupled to the crosshead via the first piston openings.

Clause 159. The piston assembly of clause 158, wherein the second piston is configured to be coupled to the crosshead via the first piston openings.

Clause 160. The piston assembly of clause 159, wherein a portion of the second piston is positioned within the gap between the first crosshead portion and the second crosshead portion, and wherein a portion of the first piston extends around both the first crosshead portion and the second crosshead portion.

Clause 161. The piston assembly of any of clauses 156 to 158, wherein each of the first crosshead portion and the second crosshead portion comprises a second piston opening, wherein the second piston is configured to be coupled to the crosshead via the second piston openings.

Clause 162. The piston assembly of clause 161, wherein the first piston openings and the second piston openings are aligned along an axis of the crosshead.

Clause 163. The piston assembly of any of clauses 156 to 162, wherein each of the first crosshead portion and the second crosshead portion comprises a first connecting rod opening and a second connecting rod opening, wherein the crosshead is configured to be coupled to a first connecting rod at the first connecting rod openings and to a second connecting rod at the second connecting rod openings.

Clause 164. The piston assembly of clause 163, wherein the first connecting rod and the second connecting rod are positioned within the gap between the first crosshead portion and the second crosshead portion when coupled to the crosshead.

Clause 165. The piston assembly of any of clauses 150 to 164, wherein the first piston is rotatably coupled to the crosshead and/or wherein the second piston is rotatably coupled to the crosshead.

Clause 166. A connecting rod assembly comprising: a first connecting rod extending between a first end and a second end; and a second connecting rod extending between a first end and a second end, the second connecting rod rotatably coupled at its first end to the second end of the first connecting rod.

Clause 167. The connecting rod assembly of clause 166, wherein the first end of the first connecting rod comprises an opening.

Clause 168. The connecting rod assembly of clause 166 or clause 167, wherein the first end of the second connecting rod is forked.

Clause 169. The connecting rod assembly of any of clauses 166 to 168, further comprising a third connecting rod extending between a first end and a second end, the third connecting rod rotatably coupled at its first end to the second end of the second connecting rod.

Clause 170. The connecting rod assembly of clause 169, wherein at least one of the first end or the second end of the second connecting rod is forked.

Clause 171. The connecting rod assembly of clause 169, wherein the first end and the second end of the second connecting rod are forked.

Clause 172. The connecting rod assembly of any of clauses 169 to 171, further comprising a fourth connecting rod extending between a first end and a second end, the fourth connecting rod rotatably coupled at its first end to the second end of the third connecting rod.

Clause 173. The connecting rod assembly of clause 172, wherein the second end of the fourth connecting rod comprises an opening.

Clause 174. The connecting rod assembly of clause 172 or clause 173, wherein the first connecting rod and the second connecting rod are rotatably coupled to each other by a first pin, wherein the second connecting rod and the third connecting rod are rotatably coupled to each other by a second pin, and wherein the third connecting rod and the fourth connecting rod are rotatably coupled to each other by a third pin.

Clause 175. The connecting rod assembly of any of clauses 172 to 174, wherein the connecting rod assembly is configured to couple a piston to a first crosshead and a second crosshead of an internal combustion engine and to couple the piston to a first crankshaft and a second crankshaft of the internal combustion engine.

Clause 176. The connecting rod assembly of any of clauses 172 to 174, wherein the connecting rod assembly is configured to be coupled to a first crankshaft at the first end of the first connecting rod.

Clause 177. The connecting rod assembly of clause 176, wherein the connecting rod assembly is configured to be coupled to a first crosshead at the second end of the first connecting rod and at the first end of the second connecting rod.

Clause 178. The connecting rod assembly of clause 176 or clause 177, wherein the connecting rod assembly is configured to be coupled to a piston at the second end of the second connecting rod and at the first end of the third connecting rod.

Clause 179. The connecting rod assembly of any of clauses 176 to 178, wherein the connecting rod assembly is configured to be coupled to a second crosshead at the second end of the third connecting rod and at the first end of the fourth connecting rod.

Clause 180. The connecting rod assembly of any of clauses 176 to 179, wherein the connecting rod assembly is configured to be coupled to a second crankshaft at the second end of the fourth connecting rod.

Clause 181. A piston subassembly for an internal combustion engine, the piston subassembly comprising: a first piston configured to reciprocate within a first bore along a first axis; a second piston configured to reciprocate within a second bore along a second axis; a crosshead extending between the first piston and the second piston, the crosshead coupling the first piston to the second piston such that the first piston and the second piston reciprocate together; a first crankshaft and a first connecting rod coupling a first portion of the crosshead to the first crankshaft; and a second crankshaft and a second connecting rod coupling a second portion of the crosshead to the second crankshaft, wherein as the first piston and the second piston reciprocate, the connecting rods cause rotation of the first crankshaft and the second crankshaft.

Clause 182. The piston subassembly of clause 181, wherein a piston body of the first piston comprises a cylindrical body.

Clause 183. The piston subassembly of clause 181, wherein a piston body of the first piston comprises a double-c shaped body.

Clause 184. The piston subassembly of any of clauses 181 to 183, wherein a piston body of the second piston comprises a cylindrical body.

Clause 185. The piston subassembly of any of clauses 181 to 183, wherein a piston body of the second piston comprises a double-c shaped body.

Clause 186. The piston subassembly of any of clauses 181 to 185, wherein the first piston comprises a combustion piston.

Clause 187. The piston subassembly of any of clauses 181 to 185, wherein the second piston comprises a combustion piston.

Clause 188. The piston subassembly of any of clauses 181 to 187, wherein the first axis is parallel to the second axis.

Clause 189. The piston subassembly of any of clauses 181 to 187, wherein the first axis is coaxial with the second axis.

Clause 190. The piston subassembly of any of clauses 181 to 189, wherein the first connecting rod is coupled to the first portion of the crosshead by a first connecting rod wrist pin, and the second connecting rod is coupled to the second portion of the crosshead by a second connecting rod wrist pin.

Clause 191. The piston subassembly of any of clauses 181 to 190, wherein the crosshead is coupled to the first piston by a first piston wrist pin.

Clause 192. The piston subassembly of clause 191, wherein the crosshead is coupled to the second piston by a second piston wrist pin.

Clause 193. The piston subassembly of clause 192, wherein the first axis intersects the first piston wrist pin and the second piston wrist pin.

Clause 194. The piston subassembly of clause 192 or clause 193, wherein the first connecting rod wrist pin, the second piston wrist pin, and the second connecting rod piston are each positioned along an axis that is perpendicular to the first axis.

Clause 195. The piston subassembly of any of clauses 191 to 194, wherein: the crosshead comprises a first plate and a second plate, and a projection of the first piston through which the first piston wrist pin extends is positioned between the first plate and the second plate; a projection of the second piston through which the second piston wrist pin extends is positioned between the first plate and the second plate; an end of the first connecting rod that is coupled to the first portion of the first connecting rod by the first connecting rod wrist pin is positioned between the first plate and the second plate; and an end of the second connecting rod that is coupled to the second portion of the second connecting rod by the second connecting rod wrist pin is positioned between the first plate and the second plate.

Clause 196. The piston subassembly of any of clauses 181 to 190, wherein the crosshead is coupled to the first piston and the second piston by a first piston wrist pin.

Clause 197. The piston subassembly of clause 191 or clause 192, wherein the first axis intersects the first piston wrist pin.

Clause 198. The piston subassembly of clause 192 or clause 193, wherein the first connecting rod wrist pin, the first piston wrist pin, and the second connecting rod piston are each positioned along an axis that is perpendicular to the first axis.

Clause 199. The piston subassembly of any of clauses 196 to 198, wherein: the crosshead comprises a first plate and a second plate, and a projection of the first piston through which the first piston wrist pin extends comprises a forked end; a projection of the second piston through which the first piston wrist pin extends is positioned between the first plate and the second plate; an end of the first connecting rod that is coupled to the first portion of the first connecting rod by the first connecting rod wrist pin is positioned between the first plate and the second plate; an end of the second connecting rod that is coupled to the second portion of the second connecting rod by the second connecting rod wrist pin is positioned between the first plate and the second plate; and the first plate, the projection of the second piston, and the second plate are positioned within the forked end of the projection of the first piston.

Clause 200. The piston subassembly of any of clauses 181 to 190, wherein the crosshead is integrally coupled of formed with the first piston and the second piston.

Clause 201. The piston subassembly of clause 200, wherein: the first portion of the crosshead comprises a first gap; an end of the first connecting rod that is coupled to the first portion of the first connecting rod by the first connecting rod wrist pin is positioned within the first gap; the second portion of the crosshead comprises a second gap; and an end of the second connecting rod that is coupled to the second portion of the second connecting rod by the second connecting rod wrist pin is positioned within the second gap.

Clause 202. The piston subassembly of any of clauses 181 to 190, wherein: the crosshead is integrally coupled of formed with the first piston; and the second piston is coupled to the crosshead by a piston wrist pin.

Clause 203. The piston subassembly of clause 202, wherein the first connecting rod wrist pin, the piston wrist pin, and the second connecting rod piston are each positioned along an axis that is perpendicular to the first axis.

Clause 204. The piston subassembly of clause 202 or clause 203, wherein: the crosshead comprises a forked end; a projection of the second piston through which the piston wrist pin extends is positioned between the forked end of the crosshead; an end of the first connecting rod that is coupled to the first portion of the first connecting rod by the first connecting rod wrist pin is positioned between the forked end of the crosshead; and an end of the second connecting rod that is coupled to the second portion of the second connecting rod by the second connecting rod wrist pin is positioned between the forked end of the crosshead.

Clause 205. The piston subassembly of any of clauses 181 to 190, wherein the crosshead is integrally coupled to or integrally formed with the second piston.

Clause 206. The piston subassembly of clause 205, wherein the first piston is coupled to the crosshead by a first piston wrist pin.

Clause 207. The piston subassembly of clause 206, wherein the first axis intersects the first piston wrist pin.

Clause 208. The piston subassembly of clause 206 or clause 207, wherein the first connecting rod wrist pin, the first piston wrist pin, and the second connecting rod piston are each positioned along an axis that is perpendicular to the first axis.

Clause 209. The piston subassembly of any of clauses 205 to 208, wherein: the crosshead comprises a first plate and a second plate, and a projection of the first piston through which the first piston wrist pin extends is positioned between the first plate and the second plate; an end of the first connecting rod that is coupled to the first portion of the first connecting rod by the first connecting rod wrist pin is positioned between the first plate and the second plate; and an end of the second connecting rod that is coupled to the second portion of the second connecting rod by the second connecting rod wrist pin is positioned between the first plate and the second plate.

Clause 210. An internal combustion engine comprising the piston subassembly of any of clauses 181 to 209, further comprising: a block, the first bore formed within the block; a first passage formed within the block, the first crankshaft configured to rotate within the first passage; and a second passage formed within the block, the second crankshaft configured to rotate within the second passage.

Clause 211. The internal combustion engine of clause 210, wherein the first bore is positioned between the first crankshaft and the second crankshaft.

Clause 212. The internal combustion engine of clause 210 or clause 211, further comprising a housing coupled to the block, the second bore formed within the housing.

### Additional Considerations and Terminology

Conditional language used herein, such as, among others, “can,” “could,” “might,” “may,” “e.g.,” and the like, unless specifically stated otherwise, or otherwise understood within the context as used, is generally intended to convey that certain configurations include, while other configurations do not include, certain features, elements and/or states. Thus, such conditional language is not generally intended to imply that features, elements and/or states are in any way required for one or more configurations or that one or more configurations necessarily include these features, elements and/or states.

Conjunctive language, such as the phrase “at least one of X, Y, and Z,” unless specifically stated otherwise, or otherwise understood within the context as used, is generally intended to convey that an item, term, etc. may be either X, Y, or Z. Thus, such conjunctive language is not generally intended to imply that certain configurations require the presence of at least one of X, at least one of Y, and at least one of Z.

While the above detailed description may have shown, described, and pointed out novel features as applied to various configurations, it may be understood that various omissions, substitutions, and/or changes in the form and details of any particular configuration may be made without departing from the spirit of the disclosure. As may be recognized, certain configurations may be embodied within a form that does not provide all of the features and benefits set forth herein, because some features may be used or practiced separately from others.

Additionally, features described in connection with one configuration can be incorporated into another of the disclosed configurations, even if not expressly discussed herein, and configurations having the combination of features still fall within the scope of the disclosure. For example, features described above in connection with one configuration can be used with a different configuration described herein and the combination still fall within the scope of the disclosure.

It should be understood that various features and aspects of the disclosed configurations can be combined with, or substituted for, one another in order to form varying modes of the configurations of the disclosure. Thus, it is intended that the scope of the disclosure herein should not be limited by the particular configurations described above. Accordingly, unless otherwise stated, or unless clearly incompatible, each configuration of this disclosure may comprise, additional to or in place of its features described herein, one or more features as described herein from each other configuration disclosed herein.

Features, materials, characteristics, or groups described in conjunction with a particular aspect, configuration, or example are to be understood to be applicable to any other aspect, configuration, or example described in this section or elsewhere in this specification unless incompatible therewith. All of the features disclosed in this specification (including any accompanying claims, abstract, and drawings), and/or any or all of the steps of any method or process so disclosed, may be combined in any combination, except combinations where at least some of such features and/or steps are mutually exclusive. The protection is not restricted to the details of any foregoing configurations. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some configurations, the actual steps taken in the processes illustrated and/or disclosed may differ from those shown in the figures. Depending on the configuration, certain of the steps described above may be removed, others may be added.

Furthermore, the features and attributes of the specific configurations disclosed above may be combined in different ways to form additional configurations, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular configuration. Thus, for example, those skilled in the art will recognize that the disclosure may be embodied or carried out in a manner that achieves one advantage or a group of advantages as taught herein without necessarily achieving other advantages as may be taught or suggested herein.

Language of degree, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain configurations, the terms “generally parallel” and “substantially parallel” refer to a value, amount, or characteristic that departs from exactly parallel by less than or equal to 15 degrees, 10 degrees, 5 degrees, 3 degrees, 1 degree, 0.1 degree, or otherwise.

The scope of the present disclosure is not intended to be limited by the specific disclosures of preferred configurations in this specification and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

Unless the context clearly requires otherwise, throughout the description and the claims, the words “comprise,” “comprising,” and the like are to be construed in an inclusive sense as opposed to an exclusive or exhaustive sense, that is to say, in the sense of “including, but not limited to.”

Reference to any prior art in this description is not, and should not be taken as, an acknowledgement or any form of suggestion that that prior art forms part of the common general knowledge in the field of endeavor in any country in the world.

The invention may also be said broadly to consist in the parts, elements, and features referred to or indicated in the description of the application, individually or collectively, in any or all combinations of two or more of those parts, elements, or features.

Where, in the foregoing description, reference has been made to integers or components having known equivalents, those integers or components are herein incorporated as if individually set forth. In addition, where the term “substantially” or any of its variants have been used as a word of approximation adjacent to a numerical value or range, it is intended to provide sufficient flexibility in the adjacent numerical value or range that encompasses standard manufacturing tolerances and/or rounding to the next significant figure, whichever is greater.

It should be noted that various changes and modifications to the presently preferred configurations described herein will be apparent to those skilled in the art. Such changes and modifications may be made without departing from the spirit and scope of the invention and without diminishing its attendant advantages. For instance, various components may be repositioned as desired. It is therefore intended that such changes and modifications be included within the scope of the invention. Moreover, not all of the features, aspects and advantages are necessarily required to practice the present configurations. Accordingly, the scope of protection is intended to be defined only by the claims.

1-28. (canceled)

29. A piston comprising:
a piston body formed of a first portion and a second portion, the second portion comprising:
a crown; and
an outer wall, the outer wall having a perimeter defined by a first circle overlapping with a second circle.

30. The piston of claim 29, wherein the first circle and the second circle have a same radius.

31. The piston of claim 29, wherein the first circle has a first radius and the second circle has a second radius, the first radius different than the second radius.

32. The piston of claim 29, further comprising a top plate, the top plate coupled to the crown.

33. The piston of claim 29, wherein the first portion is configured to allow the piston to be coupled to a crosshead or one or more connecting rods.

34. The piston of claim 29, wherein the piston body is manufactured by at least one of casting, additive manufacturing, or subtractive manufacturing.

35. The piston of claim 29, wherein the second portion of the piston body further comprises:
a first partial cylinder portion comprising:
a first outer side; and
a first inner side; and
a second partial cylinder portion comprising:
a second outer side; and
a second inner side, the first outer side and the second outer side defining the perimeter of the outer wall.

36. The piston of claim 35, wherein the first partial cylinder portion is coupled to the second partial cylinder portion using one or more fasteners, using welding, brazing, or soldering, or using an adhesive.

37. The piston of claim 29, wherein the outer wall comprises one or more grooves extending around its perimeter, each groove of the one or more grooves configured to receive two piston rings that are partial-circle shaped.

38. The piston of claim 29, wherein the piston is configured to reciprocate in a combustion chamber of an internal combustion chamber.

39. The piston of claim 29, wherein the piston is configured to act as a scavenging pump in an internal combustion chamber.

40. The piston of claim 29, wherein one or more one-way valves are positioned in the second portion and configured to allow fluid to flow in one direction through the piston while preventing back flow.

41. The piston of claim 40, wherein the one or more one-way valves comprises a first set of one-way valves and a second set of one-way valves, the first set of one-way valves disposed on a first side of the piston, the second set of one-way valves disposed on a second side of the piston.

42. A piston comprising:
a piston body comprising:
a first portion having a partial cylinder shape and comprising a first rounded surface; and
a second portion having a partial cylinder shape and comprising a second rounded surface, the first rounded surface and the second rounded surface defining a perimeter of a wall of the piston body.

43. The piston of claim 42, wherein the first rounded surface spans a first major arc of the first portion's circumference, and wherein the second rounded surface spans a second major arc of the second portion's circumference.

44. The piston of claim 42, wherein the first portion comprises a first flat side and the second portion comprises a second flat side, and wherein the first flat side is coupled to the second flat side.

45. The piston of claim 42, wherein the piston body further comprises:
a piston crown at a first end of the piston body; and
a connecting portion at a second end of the piston body, the first end opposite the second end.

46. The piston of claim 45, wherein the connecting portion comprises a projection extending from the first portion and the second portion of the piston body, the projection including an opening extending therethrough.

47. The piston of claim 46, wherein the opening is configured to receive a wrist pin to rotatably couple the piston to a crosshead or a connecting rod.

48. A piston assembly comprising:
a crosshead;
a first piston directly or indirectly coupled to the crosshead and positioned on a first side of the crosshead; and
a second piston directly or indirectly coupled to the crosshead and positioned on a second side of the crosshead.
